(19) United States
(12) Patent Application Publication
(10) Pub. No.: US 2011/0286777 A1
(43) Pub. Date: Nov. 24, 2011

(54) LUBRICANT AND IMAGE FORMING APPARATUS AND PROCESS CARTRIDGE USING SAME

(76) Inventors: Akihiro SUGINO, Shizuoka (JP); Takaaki Ikegami, Shizuoka (JP); Keisuke Shimoyama, Shizuoka (JP); Tomoharu Asano, Shizuoka (JP); Hiroshi Ikuno, Kanagawa (JP); Mitsuaki Hirose, Shizuoka (JP)

(21) Appl. No.: 13/107,248

(22) Filed: May 13, 2011

(30) Foreign Application Priority Data
May 19, 2010 (JP) 2010-115529
Jul. 26, 2010 (JP) 2010-167533

(51) Int. Cl. G03G 21/00; G03G 21/18; C10L 1/18

(52) U.S. Cl. 399/346; 399/111; 508/539

(57) ABSTRACT

A lubricant for use in an image forming apparatus, which contains a lubricant material and at least one of diamine compounds represented by chemical structure 1, 2, and 3,

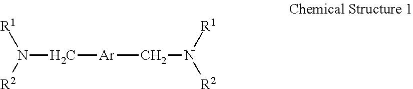

where R¹ and R² independently represent an alkyl group optionally having a substitution group and an aromatic hydrocarbon group optionally having a substitution group, one of R¹ and R² is an aromatic hydrocarbon group optionally having a substitution group, R¹ and R² optionally share bond connectivity to form a heterocyclic ring containing a nitrogen atom, and Ar represents an aromatic hydrocarbon group optionally having a substitution group,

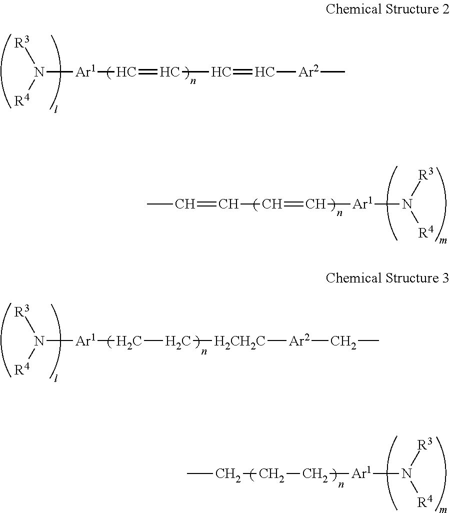

where R³ and R⁴ independently represent an alkyl group having one to four carbon atoms optionally substituted by an aromatic hydrocarbon group, R³ and R⁴ optionally share bond connectivity to form a heterocyclic ring containing a nitrogen atom, Ar¹ and Ar² independently represent a substituted or a non-substituted aromatic ring group, l and m each, independently, represent an integer of from 0 to 3 except that both l and m are zero at the same time, and n represents 1 or 2.

### BACKGROUND OF THE INVENTION

1. Field of the Invention

The present invention relates to a lubricant and an image forming apparatus and a process cartridge using the lubricant.

2. Discussion of the Background

In image forming apparatuses using electrophotography, images are formed through processes of charging, irradiation, development, transfer etc. applied to an image bearing member (e.g., photoreceptor, photoconductor). Ordinarily, corona products produced in the charging process that remain on the surface of the image bearing member, and toner or its components remaining on the surface of the image bearing member after the transfer process, are removed by a cleaning process. Therefore, the image bearing member is subjected to cleaning after the transfer process to remove the corona product and the residual toner.

A cleaning system having a rubber blade is typically used because such a cleaning blade has a simple and cost-saving mechanism with a good cleaning property. However, the rubber blade is pressed against the surface of the image bearing member to remove the residuals thereon, which causes a great friction stress between the surface of the image bearing member and the cleaning rubber blade. Therefore, the rubber blade and the surface layer of the image bearing member, particularly in the case of an organic photoconductor, are abraded, which shortens the actual working life of the rubber blade and the organic photoconductor.

In addition, toner having a small particle diameter has come to be widely used for image formation to respond to the demand for improvement in image quality. In an image forming apparatus using a toner having a small particle diameter, the proportion of un-transferred residual toner that slips through the cleaning blade significantly increases, particularly when the dimensional accuracy and assembly accuracy of the cleaning blade are low, and/or when the cleaning blade partially vibrates, thereby degrading the image quality. Therefore, improvement of the cleaning property by reducing the deterioration of members due to abrasion is required to make the actual working life of an organic photoconductor longer and output quality images for an extended period of time.

Friction between the blade and the photoconductor is typically reduced by supplying and applying a lubricant to the surface of the organic photoconductor followed by even application of the supplied lubricant to the surface with the cleaning blade or brush to form a lubricant film. Refer to unexamined published Japanese patent application publication No. (hereinafter referred to as JP-A) 2000-162881-A, etc.

Although successful, with this approach it is necessary to determine in advance the precise amount of lubricant to be applied. An excessively small amount of the lubricant leaves such problems unsolved that the organic photoconductor is not protected from abrasion or damage, or the blade is still easily degraded. By contrast, when an excessively large amount of the lubricant is supplied, excess lubricant accumulates on the surface of the organic photoconductor, which leads to image flow, or mixes with a development agent, resulting in degradation of the performance of the development agent. Therefore, the amount of lubricant applied is necessary to be pre-determined.

On the other hand, in a typical method of improving the cleaning property, a lubricant is externally added to the toner for use in development and supplied to the latent image bearing member only when developing an image with the toner. JP 2002-229241-A describes a method in which friction between the latent electrostatic image and the cleaning blade is reduced by the supply of a lubricant and the cleaning ability for the residual toner is secured.

However, as described in JP 2002-229241-A, when a lubricant is externally added to a toner, the lubricant is applied only to the toner image formed portion on the surface of a latent image bearing member.

When a large quantity of data of, for example, an estimate, or a project protocol having an image portion clearly distinct from a non-image portion in a single image, or data having large image density differences depending on which portion of one image are printed on recording media such as sheets, the lubricant is not supplied to the portion where no toner image is formed on the latent image bearing member. That is, lubricant application is localized.

Consequently, the latent image bearing member tends to be locally abraded and the cleaning blade easily vibrates at the border between the portion where the lubricant is applied and the portion where the lubricant is not applied. In addition, this leads to problems such as poor cleaning performance and squeaky noise disturbance.

Furthermore, the amount of the lubricant, which is externally added to toner (for use in a development agent), applied to a latent image bearing member varies depending on the image density. As a result, the amount of lubricant applied decreases with regard to a portion having a thin image density so that abrasion or damage on the latent image bearing member or deterioration of the cleaning blade is not sufficiently prevented. When the image density is thick or the ratio of the lubricant externally added to toner is too high, the amount of the lubricant applied to the latent image bearing member easily increases to a degree that excessive lubricant thereon causes image blur due to image flow on the end portion of the image portion, or lubricant transfers to the charging roller, resulting in variation of the resistance of the charging roller, which leads to a problem of insufficient charging, depending on the image formation conditions. Therefore, the lubricant applied to a latent image bearing member is required to keep an optimal amount.

As the method of using toner to which a lubricant is externally added as described in JP 2002-229241-A, for example, JP 2003-241570-A describes a method in which a solid toner image is formed on the entire surface of a latent image bearing member before image formation starts so as to supply a lubricant.

Although lubricant is supplied to the entire surface of a latent image bearing member by using the method described in JP 2003-241570-A, a great amount of the development agent is used, thereby increasing the amount of toner waste, which is a heavy burden on the environment. In addition, outputting a solid image is not limited to the timing before image formation starts. Such a solid image is periodically output over time in order to prevent local uneven abrasion of the latent image bearing member. As described above, a great amount of toner waste is typically discharged in exchange for prevention of uneven local abrasion of a latent image bearing member.

In addition, abrasion and image blur can be caused not just by too much lubricant or too little, but also by the interaction between the lubricant and the latent image bearing member onto which the lubricant is applied. For example, a lubricant such as metal soap covers all over the surface of a latent image bearing member, meaning that the lubricant has a function of protecting the surface from the discharging energy of a charger. However, protecting the surface of a latent image bearing member from the discharging energy means that the lubricant absorbs the energy, thereby degrading the lubricant film. JP 2008-139804-A attempts to solve this problem, and describes a method in which a lubricant functions as the protection film by regulating the application amount of the lubricant while reducing unwanted side effects.

However, when degraded lubricant is left on the surface of a latent image bearing member under high-temperature, high-humidity conditions, significant image blur tends to occur particularly immediately below the charger. This image blur is particularly noticeable when a latent image bearing member having a cross-linked surface structured by cross-linking a radical polymerizable compound is used. Although the mechanism of this phenomenon is not clear, one possible reason is that degraded lubricant, moisture in the atmosphere, and corona products produced by a charger bond together, thereby reducing the resistance of the surface, resulting in image flow of a latent electrostatic image. In addition, another possible reason why this phenomenon occurs particularly to a latent image bearing member having a cross-linked surface structured by cross-linking a radical polymerizable compound is that degraded lubricant is hardly removed from the surface, and so is hardly replaced with fresh lubricant. It is possible to increase the amount of the lubricant supplied. However, fresh lubricant is just applied onto the degraded lubricant attached to the surface of the latent image bearing member. Therefore, increasing the amount of lubricant does not contribute to replacement of the degraded lubricant and is actually not effective to solve the image blur problem. On the other hand, when the amount of lubricant applied to the surface of a latent image bearing member is reduced, the lubricant on the surface is slightly easier to remove, although at the cost of increased abrasion of the surface of the latent image bearing member.

For example, JP2004-258177-A describes a method of containing an antioxidant such as a hindered phenol and a hindered amine in lubricant to prevent deterioration of the lubricant.

Although successful to prevent deterioration of lubricant over time, this is not actually effective to prevent occurrence of image blur in a high temperature/high humidity environment.

This occurs possibly because the anti-oxidant easily reacts with a discharging energy, thereby degrading (i.e., oxidizing or decomposing) the antioxidant itself, which leads to easy bonding with a corona product, resulting in image blur.

In addition, this anti-oxidant is gradually oxidized over time so that such degraded anti-oxidant is thought to hardly demonstrate its effect to reduce the degradation due to the discharging when applied to the surface of an image bearing member.

Furthermore, both the lubricant degraded by discharging and the lubricant degraded over time may cause image blur.

Anti-oxidants such as a hindered phenol and a hindered amine that are typically used to prevent deterioration of rubber and plastic materials prevent such degradation by oxidizing the anti-oxidants themselves. Therefore, an anti-oxidant having a strong power to prevent deterioration tends to be oxidized sooner so that the power of preventing the degradation does not last long. Therefore, it is necessary to use an anti-oxidant having a strong power and another having a lasting power in combination.

As described above, when an image forming apparatus having a lubricant applicator produces images repeatedly, image blur occurs. This image blur particularly occurs to a highly durable latent image bearing member having a cross-linked surface layer structure in which a radical polymerizable compound is cross-linked.

### SUMMARY OF THE INVENTION

In view of the foregoing, the present invention provides a lubricant that contains a lubricant material and at least one of diamine compounds represented by chemical structure 1, 2, and 3.

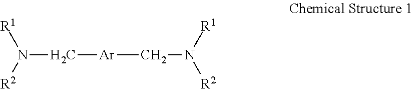

where R¹ and R² independently represent an alkyl group optionally having a substitution group and an aromatic hydrocarbon group optionally having a substitution group, one of R¹ and R² is an aromatic hydrocarbon group optionally having a substitution group, R¹ and R² optionally share bond connectivity to form a heterocyclic ring containing a nitrogen atom, and Ar represents an aromatic hydrocarbon group optionally having a substitution group,

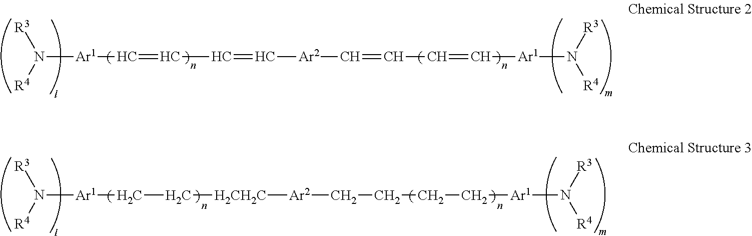

where R³ and R⁴ independently represent an alkyl group having one to four carbon atoms optionally substituted by an aromatic hydrocarbon group, R³ and R⁴ optionally share bond connectivity to form a heterocyclic ring containing a nitrogen atom, Ar¹ and Ar² independently represent a substituted or a non-substituted aromatic ring group, l and m each, independently, represent an integer of from 0 to 3 except that both l and m are zero at the same time, and n represents 1 or 2. The lubricant is used in an image forming apparatus containing a latent image bearing member to bear a latent electrostatic image, a charger to charge the surface of the latent image bearing member, a development device to develop the latent electrostatic image with toner to form a toner image, a transfer device to transfer the toner image formed on the latent image bearing member to a transfer body, and a lubricant applicator to apply the lubricant to the surface of the latent image bearing member.

It is preferred that, in the lubricant mentioned above, the lubricant material contains an aliphatic acid metal salt.

It is still further preferred that, in the lubricant mentioned above, the aliphatic acid metal salt is formed of at least one aliphatic acid selected from the group consisting of stearic acid, palmitic acid, myristic acid, and oleic acid and at least one metal selected from the group consisting of zinc, aluminum, calcium, magnesium, iron, and lithium.

It is still further preferred that, in the lubricant mentioned above, the content ratio of the diamine compound is from 0.1% by weight to 40% by weight.

As another aspect of the present invention, an image forming apparatus is provided which includes a latent image bearing member to bear a latent electrostatic image, a charger to charge the surface of the latent image bearing member, a development device to develop the latent electrostatic image with toner to form a toner image, a transfer device to transfer the toner image formed on the latent image bearing member to a transfer body, and a lubricant applicator to accommodate and apply the lubricant mentioned above to the surface of the latent image bearing member.

It is still further preferred that, in the image forming apparatus mentioned above, the lubricant is in a solid state.

It is still further preferred that, in the image forming apparatus mentioned above, the latent image bearing member contains an electroconductive substrate, a photosensitive layer overlying the electroconductive substrate, and a cross-linked surface layer formed by curing a polymerizable compound having a charge transport structure.

It is still further preferred that, in the image forming apparatus mentioned above, the cross-linked surface layer is formed by curing a radical polymerizable compound having one functional group with a charge transport structure and a radical polymerizable monomer having three functional groups without a charge transport structure.

It is still further preferred that, in the image forming apparatus mentioned above, the ratio (molecular weight/number of functional groups) of a molecular weight to a number of functional groups of the radical polymerizable monomer having three functional groups without a charge transport structure is 250 or less.

It is still further preferred that, in the image forming apparatus mentioned above, the radical polymerizable compound having one functional group with a charge transport structure has a triaryl amine structure.

It is still further preferred that, in the image forming apparatus mentioned above, the radical polymerizable compound having one functional group with a charge transport structure comprises a compound represented by the chemical structure I or II,

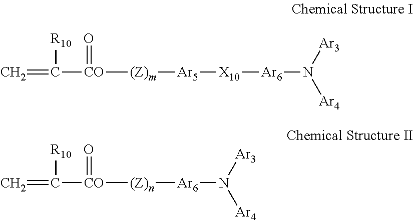

where R¹⁰ represents a hydrogen atom, a halogen atom, an alkyl group optionally having a substitution group, an aralkyl group optionally having a substitution group, an aryl group optionally having a substitution group, a cyano group, a nitro group, an alkoxy group, and —COOR¹¹ group, where R¹¹ represents a hydrogen atom, an alkyl group optionally having a substitution group, an aralkyl group optionally having a substitution group, an aryl group optionally having a substitution group, and —CONR¹²R¹³, where R¹² and R¹³ independently represent a hydrogen atom, a halogen atom, an alkyl group optionally having a substitution group, an aralkyl group optionally having a substitution group, and an aryl group optionally having a substitution group, Ar⁵ and Ar⁶ independently represent an arylene group optionally having a substitution group, Ar³ and Ar⁴ independently represent an aryl group optionally having a substitution group, X¹⁰ represents a single bond, an alkylene group optionally having a substitution group, a cycloalkylene group optionally having a substitution group, an alkylene ether group optionally having a substitution group, an oxygen atom, a sulfur atom, and a vinylene group, Z represents an alkylene group optionally having a substitution group, an alkylene ether group optionally having a substitution group, and an alkyleneoxy carbonyl group, and m and n independently represent an integer of from 0 to 3.

It is still further preferred that, in the image forming apparatus mentioned above, the radical polymerizable compound having one functional group with a charge transport structure comprises a compound represented by the chemical structure III,

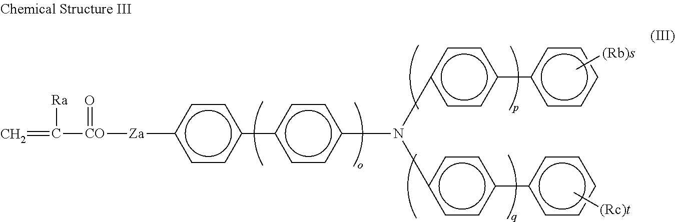

wherein “o”, “p”, “q”, each, independently, represent 0 or 1, Ra represents a hydrogen atom or a methyl group, and Rb and Rc, each, independently, represent an alkyl group (excluding hydrogen atom) having one to six carbon atoms, s and t independently represent 0 or an integer of from 1 to 3, and Za represents a single bond, a methylene group, an ethylene group, or a divalent group represented by the following Chemical structures a, b, and c.

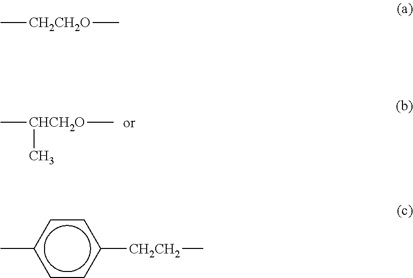

It is still further preferred that, in the image forming apparatus mentioned above, the cross-linked surface layer contains filler particulates.

It is still further preferred that, in the image forming apparatus mentioned above, the filler particulates are inorganic particulates.

It is still further preferred that, in the image forming apparatus mentioned above, the charger is a corona charger.

It is still further preferred that, in the image forming apparatus mentioned above, which forms color images by sequentially overlapping multiple color toner images.

It is still further preferred that, in the image forming apparatus mentioned above, wherein the transfer body includes an intermediate transfer body to which multiple color toner images are primarily and sequentially transferred from the latent image bearing member to form an overlapped color toner image and from which the overlapped color toner image is secondarily transferred to a recording medium at once.

As another aspect of the present invention, a process cartridge is provided which includes a latent image bearing member to bear a latent electrostatic image, at least one of a charger to charge the surface of the latent image bearing member and a development device to develop the latent electrostatic image with toner to form a toner image, and a lubricant applicator to accommodate and apply the lubricant mentioned above to the surface of the latent image bearing member.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an example of a layer structure of the latent image bearing member of the present disclosure;

FIG. 2 is a diagram illustrating another example of a layer structure of the latent image bearing member of the present disclosure;

FIG. 3 is a diagram illustrating another example of a layer structure of the latent image bearing member of the present disclosure;

FIG. 4 is a diagram illustrating another example of a layer structure of the latent image bearing member of the present disclosure;

FIG. 5 is a graph illustrating an IR measured data of a charge transport polyol (D3-2) which is an synthesis example of a charge transport material having a hydroxyl group;

FIG. 6 is a schematic diagram illustrating an example of the image forming apparatus of the present disclosure;

FIG. 7 is a schematic diagram illustrating an example of the lubricant applicator mechanism for use in the image forming apparatus of the present disclosure;

FIG. 8 is a schematic diagram illustrating another example of the image forming apparatus of the present disclosure;

FIG. 9 is a schematic diagram illustrating another example of the image forming apparatus of the present disclosure;

FIG. 10 is a schematic diagram illustrating an example of an image forming apparatus (tandem system, color printing) of the present disclosure;

FIG. 11 is an enlarged schematic diagram illustrating a portion of the image forming apparatus illustrated in FIG. 10; and

FIG. 12 is a schematic diagram illustrating an example of the process cartridge for use in the image forming apparatus of the present disclosure.

### DETAILED DESCRIPTION OF THE INVENTION

The lubricant for use in the present disclosure is used in an image forming apparatus having a latent image bearing member to bear a latent electrostatic image, a charger to charge the surface of the latent image bearing member, a development device to develop the latent electrostatic image with toner to obtain a toner image, a transfer device to transfer the toner image formed on the latent image bearing member to a transfer body, and a lubricant applicator to accommodate and apply the lubricant to the surface of the latent image bearing member. The lubricant contains a lubricant material and at least one of diamine compounds represented by the following chemical structures 1, 2, and 3.

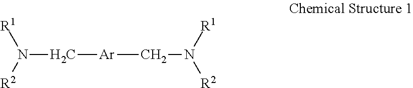

In the Chemical structure 1, R¹ and R² independently represent an alkyl group optionally having a substitution group and an aromatic hydrocarbon group optionally having a substitution group. One of R¹ and R² is an aromatic hydrocarbon group optionally having a substitution group. R¹ and R² optionally share bond connectivity to form a heterocyclic ring containing a nitrogen atom. “Ar” represents an aromatic hydrocarbon group optionally having a substitution group.

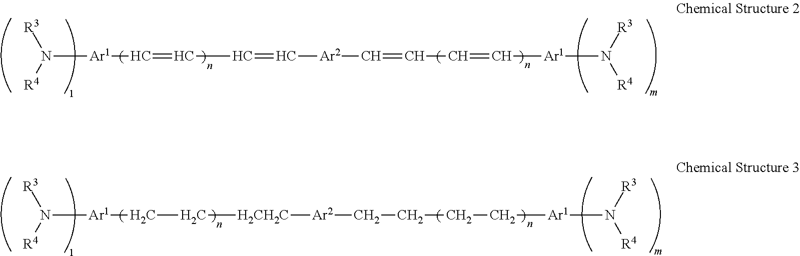

In the Chemical structures 2 and 3, R³ and R⁴ independently represent an alkyl group having one to four carbon atoms optionally substituted by an aromatic hydrocarbon group. R³ and R⁴ optionally share bond connectivity to form a heterocyclic ring containing a nitrogen atom. Ar¹ and Ar² independently represent a substituted or a non-substituted aromatic ring group. The symbols “l” and “m” each, independently, represent an integer of from 0 to 3 except that both 1 and m are zero at the same time. n represents an integer of 1 or 2.

The lubricant of the present disclosure is accommodated in the lubricant applicator and applied to the surface of the latent image bearing member. That is, the lubricant is supplied and applied to the latent image bearing member by using the lubricant applicator to reduce the friction coefficient of the surface of the latent image bearing member against the cleaning blade for a long time so that the latent image bearing member maintains excellent durability (abrasion resistance and damage resistance) to prevent occurrence of deficient images with hollow spots and/or image blur particularly in an high temperature and high humidity environment to stably output quality images.

Furthermore, due to the lubricant of the present disclosure being applied to the surface of the latent image bearing member, the releasing property of the toner ameliorate, thereby facilitating removing spherical toner which is difficult to remove and dissolving problems such as squeaky noise of a blade and abrasion of a blade edge that tend to occur when the latent image bearing member frictionally slides with the cleaning blade.

The lubricant is not necessarily a solid. Powder, liquid, half-kneaded or other lubricant that satisfies electrophotographic properties can be suitably used as long as it can be applied to the surface of the latent image bearing member.

Specific examples of the lubricant materials include, but are not limited to, an aliphatic acid metal salt, a natural wax such as carnauba wax, a fluorine-containing resin such as polytetrafluoroethylene, melamine cyanurate, and boron nitride. Among these, solid lubricant materials are preferably in terms of stable supply and easy handling.

It is preferable to contain at least an aliphatic acid metal salt in the lubricant.

Aliphatic acid metal salts formed of at least one aliphatic acid selected from the group consisting of stearic acid, palmitic acid, myristic acid, and oleic acid and at least one metal selected from the group consisting of zinc, aluminum, calcium, magnesium, iron, and lithium are particularly preferable because they have a structure of a straight chain hydrocarbons so that the layers easily slip, resulting in good lubricity.

In addition, in the case of the aliphatic acid metal salt having a straight chain, the aliphatic acid metal salt formed by selecting the metal from the group specified above has a good weatherability. A solid lubricant is obtained by melting these aliphatic acid metal salts in a temperature range of from 70° C. to 150° C. and molding the resultant into an arbitrary followed by cooling down for solidification. Therefore, the diamine compound mentioned above is easily contained in the lubricant by mixing with the aliphatic acid metal salt beforehand at a high temperature for dissolution and dispersion followed by cooling down and solidification. As described above, since the aliphatic acid metal salt is of a high lubricity and an excellent weatherability and easy to handle a mixture thereof with a diamine compound, the aliphatic acid metal salt is preferably used as the lubricant material of the present disclosure.

Next, the diamine compound represented by the following chemical structure 1 which is contained in a lubricant is described below.

The diamine compound represented by the chemical structure 1 is known as a dye intermediate body or a precursor of a polymer (refer to JP S62-13382-A, U.S. Pat. No. 4,223,144, Japanese patent No. (hereinafter referred to as JP-B) 371383, and JP 3291788-B) and can be easily synthesized by a known method {(refer to E. Elce and A. S. Hay, Polymer, Vol. 37 No. 9, 1745 (1996)}. That is, such a compound is obtained by reacting dihalogen compound represented by the following chemical structure 4 and a secondary amine compound represented by the following chemical structure 5 under the presence of an basic compound in a temperature range of from room temperature to around 100° C.

XH₂C—Ar—CH₂X Chemical Structure 4

In the Chemical structure 4, Ar represents the same as those defined in the Chemical structure 1 and X represents a halogen atom.

That is, Ar represents an aromatic hydrocarbon group optionally having a substitution group.

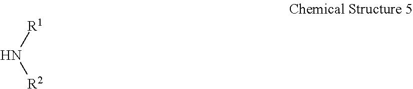

In the chemical structure 5, R¹ and R² are the same as those defined in the Chemical structure 1.

That is, R¹ and R² independently represent an alkyl group optionally having a substitution group and an aromatic hydrocarbon group optionally having a substitution group.

One of R¹ and R² is an aromatic hydrocarbon group optionally having a substitution group. R¹ and R² optionally share bond connectivity to form a heterocyclic ring containing a nitrogen atom.

Specific examples of the basic compounds for use in reaction between the dihalogen compound and the secondary amine compound include, but are not limited to, potassium carbonate, sodium carbonate, potassium hydroxide, sodium hydroxide, sodium hydride, sodium methlate, and potassium-t-butoxide. Specific examples of the reaction solvents include, but are not limited to, dioxane, tetrahydrofuran, toluene, xylene, dimethylsulfoxide, N,N-dimethylformamide, N-methyle pyrollidone, 1,3-dimethyl-2-imidazolidinone, and acetonitrile.

Specific examples of the alkyl groups in the Chemical structure 5 include, but are not limited to, methyl group, ethyl group, propyl group, butyl group, hexyl group, and undecanyl group. Specific examples of the aromatic hydrocarbons include, but are not limited to, aromatic ring groups such as benzene, biphenyl, naphthalene, anthracene, fluorene, and pyrene and aromatic heterocyclic ring groups such as pyridine, quinoline, thiophene, furan, oxazole, oxadiazole, and carbazole. Specific examples of halogen atoms include, but are not limited to, fluorine atom, chlorine atom, bromine atom, and iodine atom.

In addition, specific examples of these substitution groups include, but are not limited to, the alkyl groups specified above, alkoxy groups such as a methoxy group, an ethoxy group, a propoxy group, and a butoxy group, halogen atoms such as a fluorine atom, a chlorine atom, a bromine atom, and an iodine atom, the aromatic hydrocarbons specified above, pyrrolidine, piperidine, and piperazine. Furthermore, when R¹ and R² share bond connectivity to form a heterocyclic ring having a nitrogen atom, a specific example of the heterocyclic rings is a condensed heterocyclic ring group in which an aromatic hydrocarbon group is condensed to a pyrrolidino group, a piperidino group, or a piperazino group.

Preferred specific examples of the diamine compounds shown in Tables 1 to 4.

However, the diamine compounds of the present disclosure are not limited to those.

TABLE 1

| Compound | | | |
|---|---|---|---|
| No. | Ar | R¹ | R [symbol] |
| A-1 | 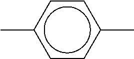 | —CH₃ | 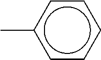 |
| A-2 | 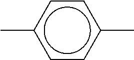 | —CH₂CH₃ | 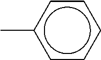 |
| A-3 | 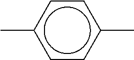 | —CH₃ | 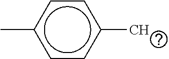 |
| A-4 | 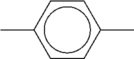 | —CH₂CH₃ | 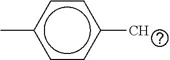 |
| A-5 | 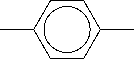 | —CH₂CH₂CH₃ | 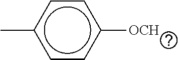 |
| A-6 | 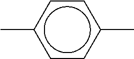 | —CH₂CH₃ | 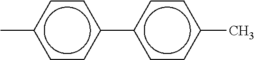 |
| A-7 | 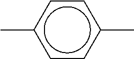 | 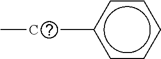 | 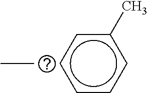 |
| A-8 | 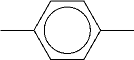 | 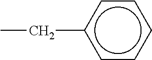 | 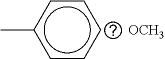 |
| A-9 | 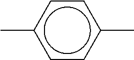 | CH₂CH₂ | 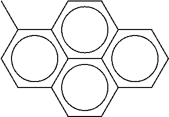 |
| A-10 | 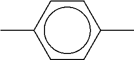 | 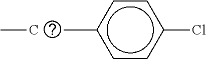 | 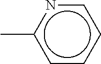 |

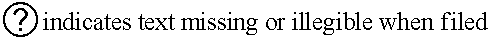

[symbol]

indicates data missing or illegible when filed

TABLE 2

| Compound | | | |
|---|---|---|---|
| No. | Ar | R¹ | R² |
| A-11 | 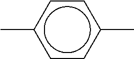 | —CH₂CH₃ | 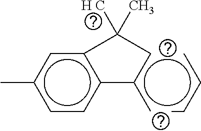 |
| A-12 | 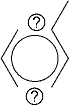 | —CH₂CH₃ | 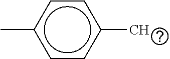 |
| A-13 | 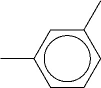 | | 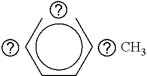 |
| A-14 | 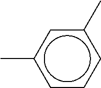 | | 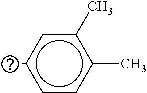 |
| A-15 | 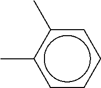 | —CH₂CH₃ | 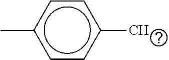 |
| A-16 | 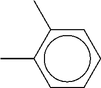 | —CH₃ | 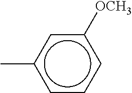 |
| A-17 | 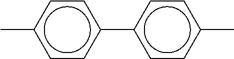 | —CH₂CH [symbol] | 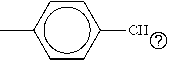 |
| A-18 | 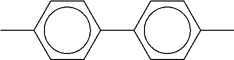 | 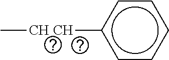 | 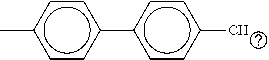 |
| A-19 | 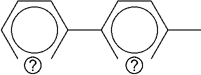 | —CH₃ | 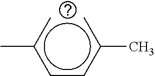 |
| A-20 | 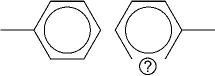 | —CH₂CH₃ | 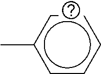 |

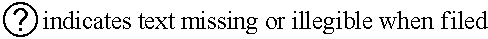

[symbol]

indicates data missing or illegible when filed

TABLE 3

| Compound | | | |
|---|---|---|---|
| No. | Ar | R¹ | R² |
| A-21 | 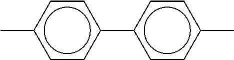 | 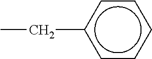 | 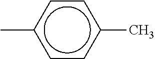 |
| A-22 | 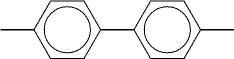 | 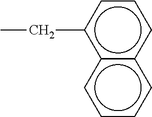 | 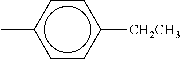 |
| A-23 | 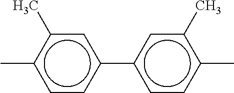 | —CH₂CH₃ | 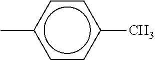 |
| A-24 | 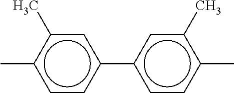 | 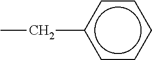 | 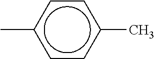 |
| A-25 | 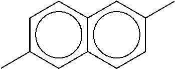 | —CH₂CH₃ | 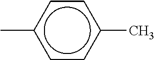 |
| A-26 | 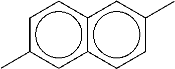 | —CH₃ | 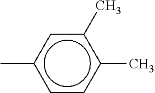 |
| A-27 | 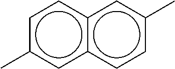 | 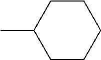 | 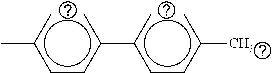 |
| A-28 | 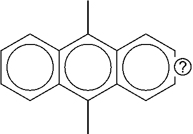 | —CH₂CH₃ | 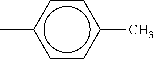 |
| A-29 | 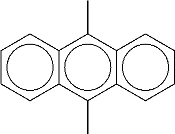 | —CH₃ | 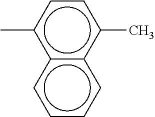 |
| A-30 | 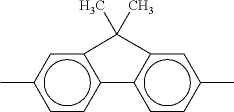 | —CH₂CH₃ | 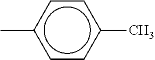 |

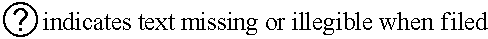

TABLE 4

| Compound | | | |
|---|---|---|---|
| No. | Ar | R¹ | R² |
| A-31 | 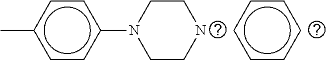 | —CH₂CH₃ | 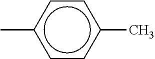 |
| A-32 | 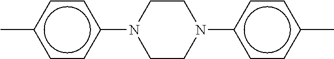 | —CH₂CH₃ | 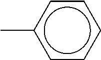 |
| A-33 | 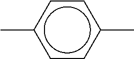 | —CH₂CH₃ | 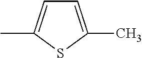 |
| A -34 | 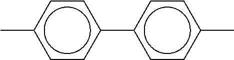 | 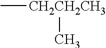 | 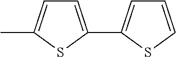 |

| | | |
|---|---|---|
| A -35 | 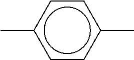 | 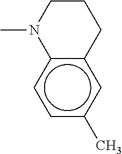 |
| A-36 | 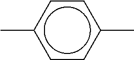 | 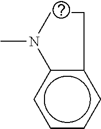 |
| A-37 | 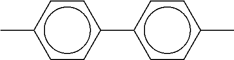 | 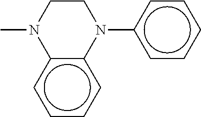 |

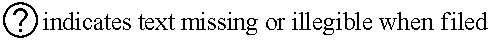

Next, the diamine compounds represented by the following chemical structures 2 and 3 are described below.

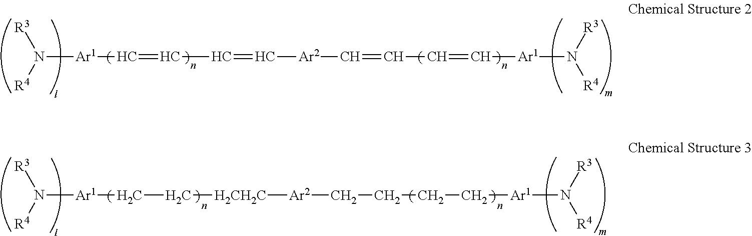

Specific examples of alkyl group contained in the chemical structures 2 and 3 include, but are not limited to, methyl group, ethyl group, propyl group, butyl group, hexyl group, and undecanyl group. Specific examples of the aromatic ring groups include, but are not limited to, single to six valent aromatic hydrocarbon groups of aromatic hydrocarbon groups such as benzene, naphthalene, anthracene, and pyrene and single to six valent aromatic heterocyclic ring groups of aromatic heterocyclic rings such as pyridine, quinoline, thiophene, furan, oxazole, oxadiazole, and carbazole. In addition, specific examples of these substitution groups include, but are not limited to, the alkyl groups specified above, alkoxy groups such as a methoxy group, an ethoxy group, a propoxy group, and a butoxy group, halogen atoms such as a fluorine atom, a chlorine atom, a bromine atom, and an iodine atom, and an aromatic ring group. Furthermore, specific examples of the heterocyclic rings having a nitrogen atom in which R¹ and R² share bond connectivity include, but are not limited to, a pyrrolidinyl group, a piperidinyl group, and a pyrrolinyl group.

Specific examples of the heterocyclic rings sharing a nitrogen atom include, but are not limited to, aromaric heterocyclic ring groups such as N-methylcarbazole, N-ethyl carbazole, N-phenyl carbazole, indol, and quinoline.

Preferred specific examples of the compounds represented by the Chemical structures 2 and 3 are as follows. However, the compounds of the present disclosure are not limited to those.

TABLE 1-1

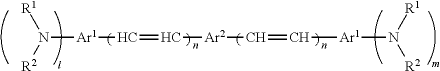

| Compound | |
|---|---|
| No. | Chemical structure |
| 1 -1 | 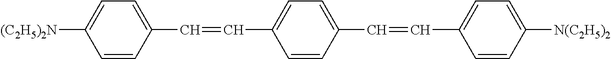 |
| 1-2 | 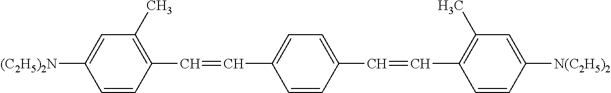 |
| 1-3 | 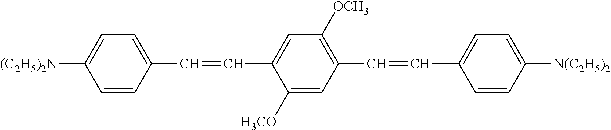 |
| 1-4 | 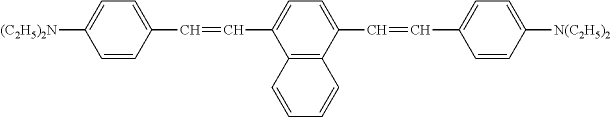 |
| 1-5 | 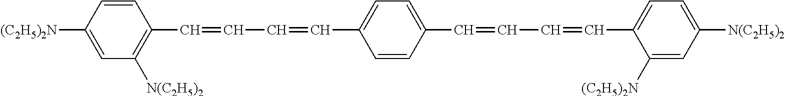 |
| 1-6 | 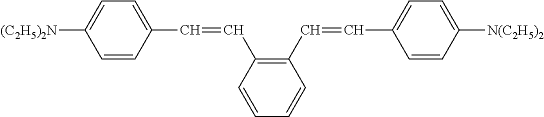 |
| 1-7 | 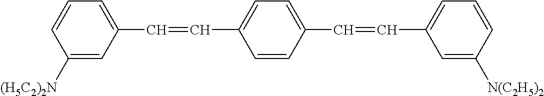 |
| 1-8 | 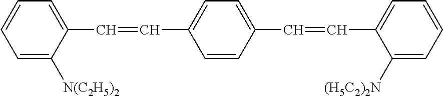 |

TABLE 1-2

| Compound | Chemical |
|---|---|
| No. | structure |
| 1-9 | 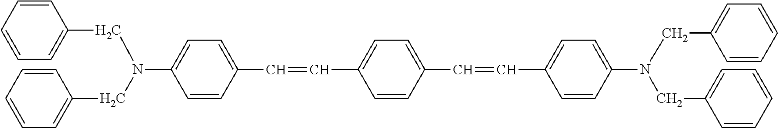 |
| 1-10 | 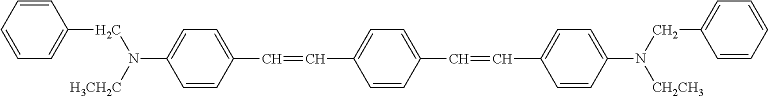 |
| 1-11 | 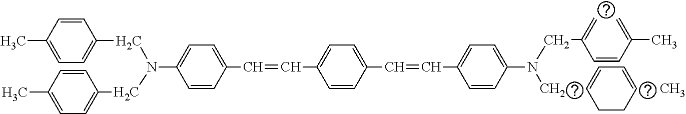 |
| 1-12 | 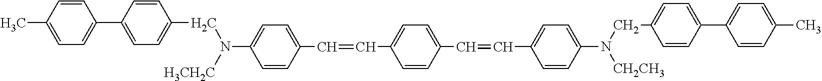 |
| 1-13 | 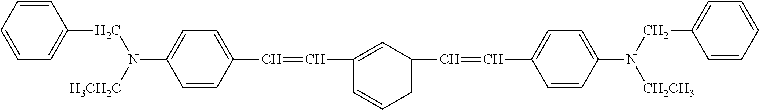 |
| 1-14 | 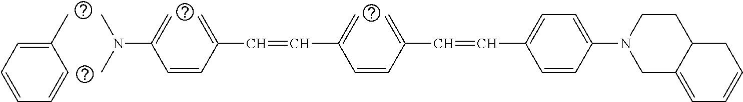 |
| 1-15 | 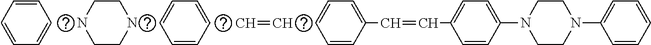 |

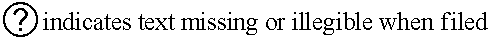

TABLE 2-1

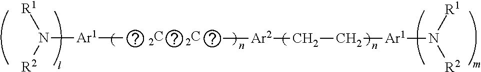

| Compound | |
|---|---|
| No. | Chemical structure |
| 2-1 | 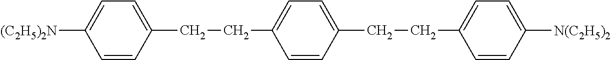 |
| 2-2 | 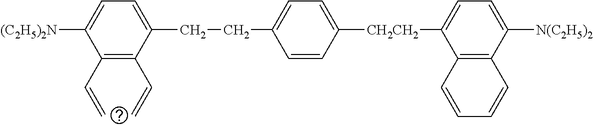 |
| 2-3 | 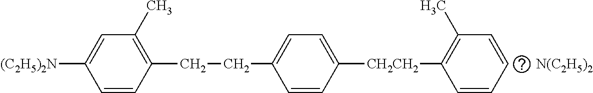 |
| 2-4 | 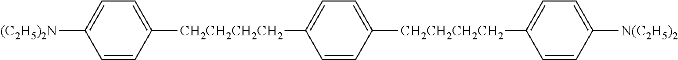 |
| 2-5 | 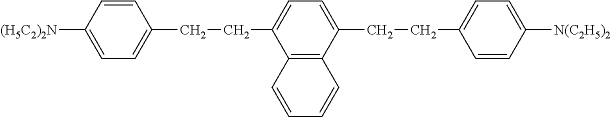 |
| 2-6 | 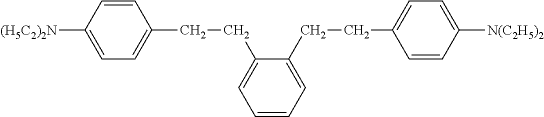 |
| 2-7 | 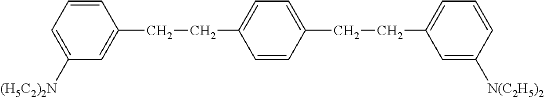 |
| 2-8 | 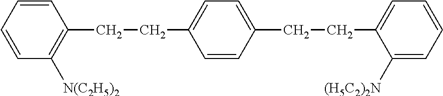 |
| 2-9 | 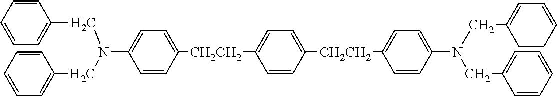 |

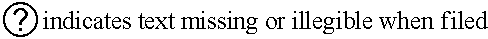

TABLE 2-2

| Compound | |
|---|---|
| No. | Chemical structure |
| 2-10 | 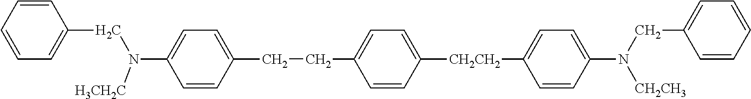 |
| 2-11 | 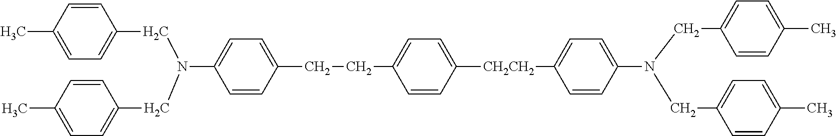 |
| 2-12 | 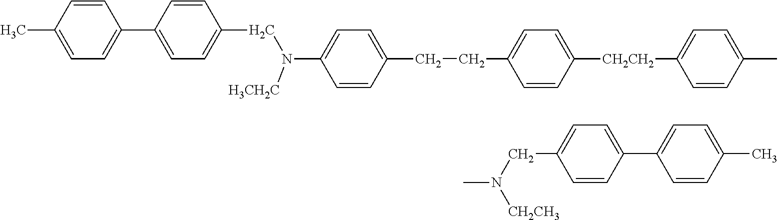 |
| 2-13 | 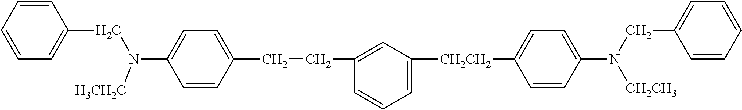 |
| 2-14 | 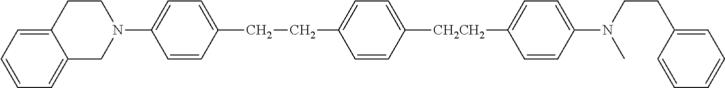 |
| 2-15 | 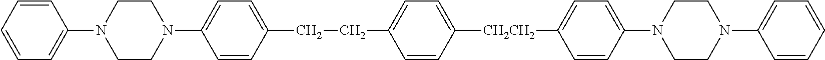 |

The content of the diamine compounds represented by the chemical structures 1, 2, and 3 is preferably from 0.1% by weight to 40% by weight and more preferably from 1% by weight to 30% by weight.

When the content of the diamine compounds are excessively small, the diamine compounds tends to not prevent decomposition of the aliphatic acid salts, thereby not being effective to reduce the image blur.

In addition, when the content is excessively large, the content of the component of the lubricant tends to be short, thereby causing poor cleaning performance or hollow spots during transfer, resulting in production of deficient images like moth-eaten images.

Furthermore, the solid mixture as the lubricant tends to be brittle, thereby increasing the consumption amount thereof.

The image forming apparatus of the present disclosure include a latent image bearing member to bear a latent electrostatic image thereon, a charger to charge the surface of the latent electrostatic image, a latent image forming device to form an electrostatic image on the latent image bearing member, a development device to develop the latent image bearing member to form a toner image, a transfer device to transfer the toner image formed on the latent image bearing member to a transfer body, and a lubricant applicator to apply lubricant accommodated therein to the surface of the latent image bearing member.

The image forming apparatus of the present disclosure is described in detail.

### Latent Image Bearing Member

Any known latent image bearing member can be used in the image forming apparatus of the present disclosure. Among these, organic photoconductor (OPC) is preferably used in terms of: (1): the range of the optical absorption range and the size of the optical absorption amount; (2): electric properties such as sensitivity and charging property; (3): selection range of material; (4): easiness of manufacturing; (5): cost; and (6): non-toxicity. Among these, an organic photoconductor is preferably used which has a cross-linked surface layer formed and hardened by reacting a radical polymerizable monomer having no charge transport structure and a radical polymerizable compound having a charge transport structure because it has a high durability and excellent electric characteristics.

In a first embodiment of the latent image bearing member, a single-layer structured photosensitive layer is provided on a substrate with optional layers such as a protection layer, and an intermediate layer.

In a second embodiment of the latent image bearing member, a laminate structured photosensitive layer having at least a charge generation layer and a charge transport layer are provided on a substrate in that order, with optional layers such as a protection layer and an intermediate layer. In the second embodiment, the charge generation layer and the charge transport layer can be reversely arranged.

In the single layer structured photosensitive layer, the photosensitive layer or the protection layer formed thereon serves as the surface layer. In the laminate structured photosensitive layer, the charge transport layer or the protection layer formed thereon serves as the surface layer.

The latent image bearing member is described in detail with reference to accompanying drawings.

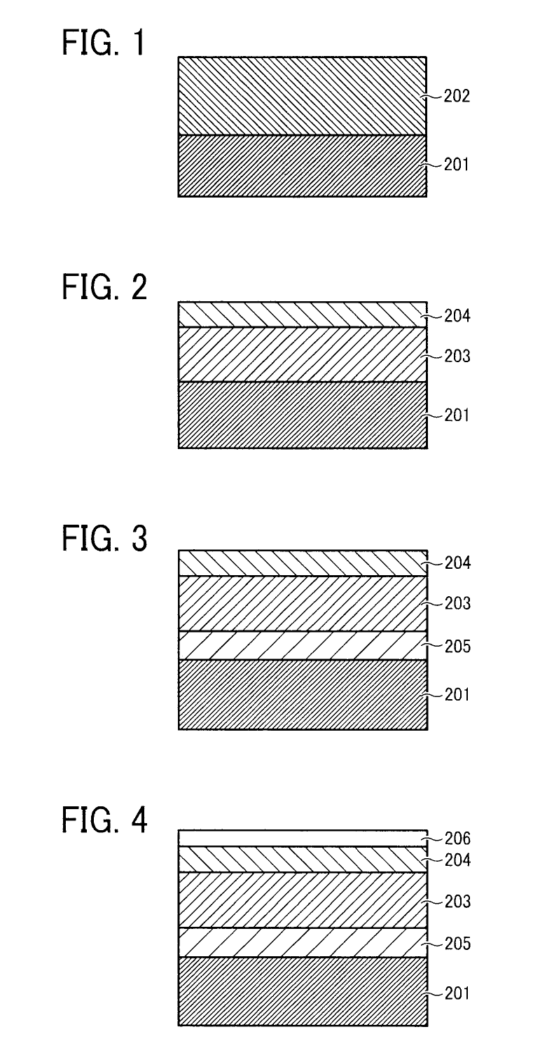

FIG. 1 is a schematic cross section illustrating a latent image bearing member of the present disclosure having a structure of a substrate 201 and a photosensitive layer 202 provided thereon.

FIGS. 2, 3, and 4 illustrate other examples of the layer structures of the latent image bearing member.

FIG. 2 is diagram illustrating a function separated type in which a photosensitive layer is formed of a charge generation layer (CGL) 203 and a charge transport layer (CTL) 204. FIG. 3 is a diagram of a structure formed of the substrate 201, and the function separated photosensitive layer having the charge generation layer (CGL) 203 and the charge transport layer (CTL) 204 with an undercoating layer 205 between the substrate 201 and the photosensitive layer. FIG. 4 is a diagram illustrating a structure having a protection layer 206 provided on the charge transport layer 204.

Any latent image bearing member having a photosensitive layer on the substrate 201 can preferably be used in the present disclosure and in any combination with other layers and the type of the photosensitive layer. A latent image bearing member having a surface layer formed of a cross-linking resin is preferable and a cross-linked surface layer formed and hardened by using at least a polymerizable compound having a charge transport structure is particularly preferable.

### Protection Layer

Next, the protection layer is described in detail.

In the latent image bearing member, it is preferable to use a protection layer formed of a cross-linking resin or provide a protection layer containing inorganic particulates and lubricant particulates to obtain a high abrasion resistance.

Specific examples of the cross-linking resins include, but are not limited to, urethane resins, silicone resins, phenol resins, epoxy resins, and acrylic resins. In particular, a cross-linked surface layer formed and hardened by a composition containing a monomer having a charge transport structure is preferably used to obtain a high abrasion resistance and excellent electric characteristics.

For example, a suitable cross-liked surface layer is formed by applying heat to harden a monomer having a charge transport structure containing a hydroxyl group and an isocyanate compound.

Specific examples of the charge transport materials containing a hydroxyl group that can form a cross-linked surface layer by applying heat to harden a urethane resin or a silicone resin are shown in Tables 5 to 10, but are not limited thereto.

TABLE 5

| Illu- | |
|---|---|
| strated | |
| Com- | |
| pound | |
| No. | Chemical structure |
| D1-1 | 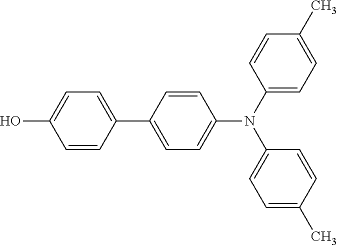 |
| D1-2 | 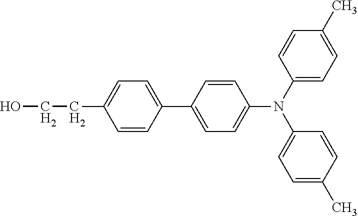 |
| D1-3 | 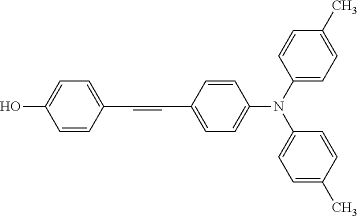 |

TABLE 6

| Illustrated | Chemical |
|---|---|
| compound No. | structure |
| D1-4 | 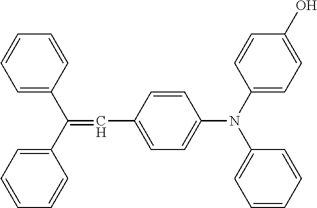 |
| D1-5 | 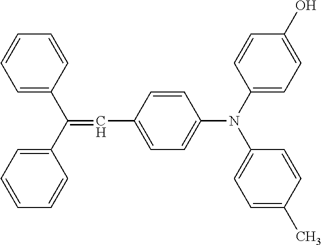 |

TABLE 7

| Illustrated | |
|---|---|
| compound No. | Chemical structure |
| D2-1 | 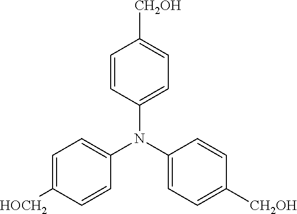 |
| D2-2 | 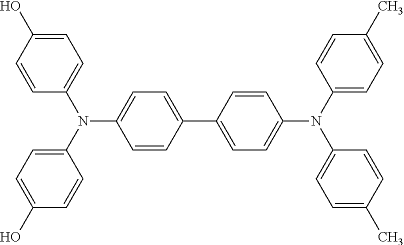 |
| D2-3 | 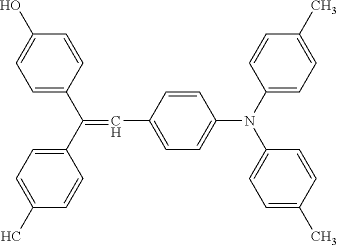 |
| D2-4 | 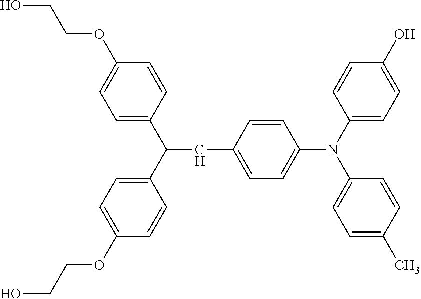 |

TABLE 8

| Illustrated | |
|---|---|
| compound No. | Chemical structure |
| D2-5 | 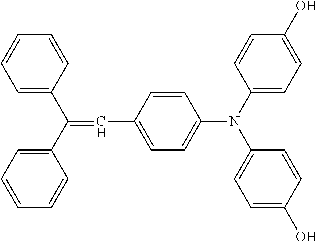 |
| D2-6 | 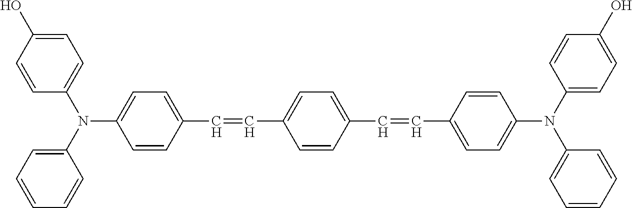 |
| D2-7 | 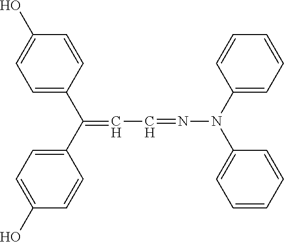 |

TABLE 9

| Illustrated | |
|---|---|
| compound No. | Chemical strucutre |
| D3-1 | 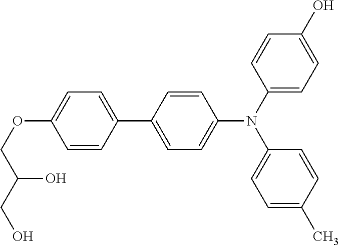 |
| D3-2 | 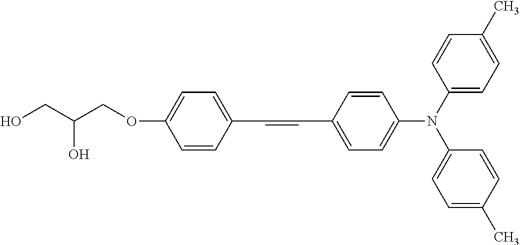 |
| D3-3 | 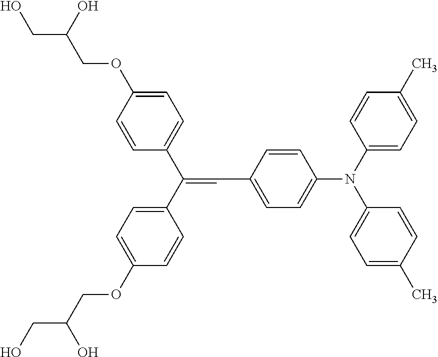 |

TABLE 10

| Illustrated | |
|---|---|
| compound | |
| No. | Chemical structure |
| D3-4 | 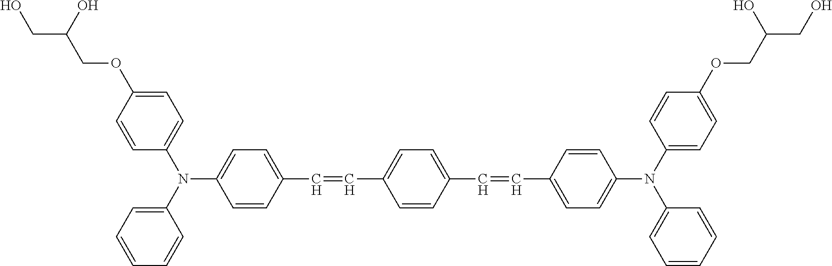 |
| D3-5 | 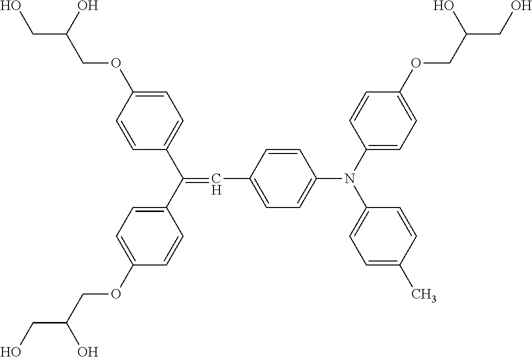 |
| D3-6 | 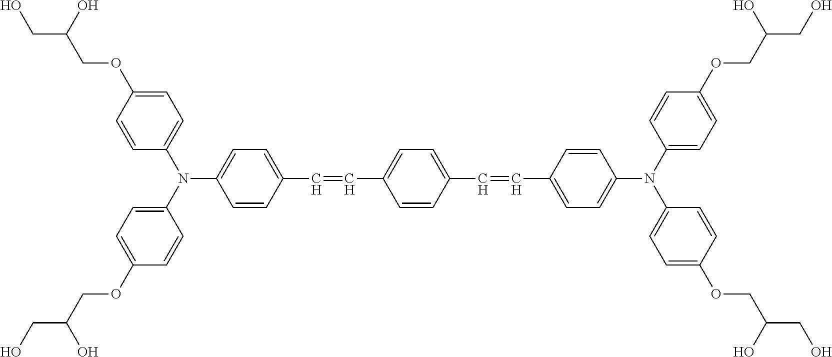 |

The charge transport material having a hydroxyl group specified as a preferably usable polymerizable compound having a charge transport structure for use in the present disclosure can be obtained by, for example, the synthetic method described in JP 3540056-B.

Specific examples of the charge transport material having a hydroxyl group include, but are not limited to, the illustrated compound D1-3 in Table 5??? and the illustrated compound D3-2 in Table 9???.

### Synthesis Example of Charge Transport Polyol

(1) Synthesis of [4-methoxy benzyl diethylphosphonate]

4-methoxy benzyl chloride and triethyl phosphite are reacted at 150° C. for 5 hours. Thereafter, excess triethyl phosphite and a by-product of ethyl chloride are removed by distillation with a reduced pressure to obtain 4-methoxy benzyl diethylphosphonate.

(2) Synthesis of [4-methoxy-4′-(di-p-tolylamino)stilbene]

Equimolar of 4-methoxy benzyl diethylphosphonate and 4-(di-p-tolylamino)benzaldehyde are dissolved in N,N-dimethyl formamide and tert-butoxy potassium is added little by little while stirring in water-cooling condition. After a five hour stirring at room temperature, water is added to obtain a coarse product of the target compound precipitates by acidation. Furthermore, the coarse product is fined by column chromatography using silica gel to obtain the target product of 4-methoxy-4′-(di-p-tolyl amino)stilbene.

(3) Synthesis of [4-hydroxy-4′-(di-p-tolyl amino)stilbene]

The thus obtained 4-methoxy-4′-(di-p-tolyl amino)stilbene and its twice equivalent of sodium ethane thiolate are dissolved in N,N-dimethyl formamide followed by reaction at 130° C. for 5 hours. Thereafter, the solution is cooled down and poured to water followed by neutralization with hydrochloric acid to extract the target object with ethyl acetate. The liquid extraction is washed with water followed by drying and thereafter the solvent is removed to obtain a coarse produce. Furthermore, the coarse product is fined by column chromatography using silica gel to obtain the target product of 4-methoxy-4′-(di-p-tolyl amino)stilbene, represented by the following chemical structure D1-3 (i.e., illustrated compound D1-3 in Table 5).

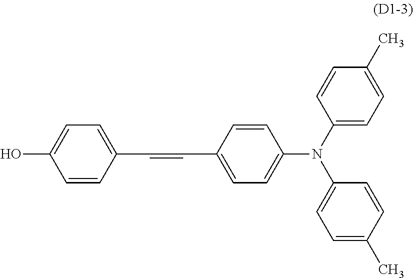

[4] Synthesis of [1,2-dihydroxy-3-[4′-(di-p-tolyl amino)stilbene-4-yloxy]propane

11.75 g of [4-hydroxy-4′-(di-p-tolyl amino)stilbene], 4.35 g of glycidyl methacryalte, and 8 ml of toluene are placed in a reaction container equipped with a stirrer, a thermometer, a condenser, and a dripping funnel and the system is heated to 90° C. followed by addition of 0.16 g of triethylamine. The resultant is heated and stirred at 95° C. for eight hours. Thereafter, 16 ml of toluene and 20 ml of 10% sodium hydroxide are added and the resultant is heated and stirred at 95° C. for eight hours again.

After completion of the reaction, the resultant is diluted with ethyl acetate. Subsequent to acid-washing followed by water-washing, the solvent is distilled away to obtain 19 g of a coarse product. Furthermore, by column chromatography (solvent: ethylacetate) using silica gel, the target object of [1,2-dihydroxy-3-[4′-(di-p-tolyl amino)stilbene-4-yloxy]propane (CTP-2) (OH equivalent: 232.80) represented by the following chemical structure D3-2 (i.e., illustrated compound D3-2 of Table 9) is obtained (yield: 9.85 g, yellow crystal, melting point: 127 to 128.7° C.).

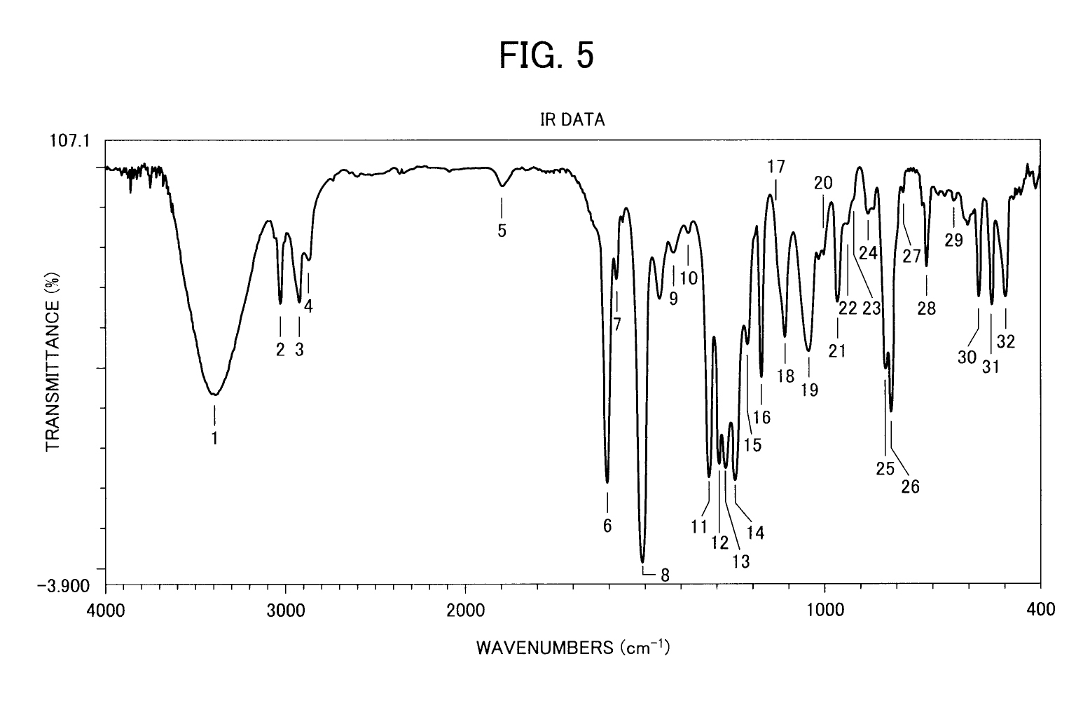

IR measurement data of the obtained target product are illustrated in FIG. 5 (IR data No. 5).

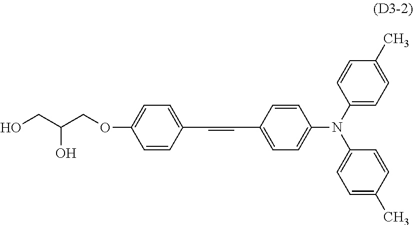

In addition, a protection layer formed of a cross-linked resin by using a radical polymerizable monomer and a radical polymerizable compound having a charge transport structure to obtain a three dimensional network structure forms a hard surface layer having an extremely high cross-linking density, thereby achieving a higher abrasion resistance.

In the case in which the cross-linked surface layer contains a radical polymerizable compound having one functional group with a charge transport structure and a radical polymerizable monomer having three or more functional groups, the radical polymerizable compound having one functional group with a charge transport structure is entrapped in the cross-linking bondings during the curing of the radical polymerizable monomer having three or more functional groups.

On the other hand, when a small molecular weight charge transport material having no functional group is contained in the cross-linked surface layer, the small molecular weight charge transport material tends to precipitate and cause white crowd phenomenon due to their low compatibility, thereby degrading the mechanical strength of the cross-linked surface layer.

When a charge transport compound having two or more functional groups is used as the main component, the charge transport compound is fixed in the cross-linking structure by multiple bondings. However, since the charge transport structure is excessively bulky, distortion occurs in the cured resin. Therefore, the internal stress in the cross-linked surface layer increases so that cracking or scar may repeatedly occur due to attachment of carriers, etc.

Furthermore, the latent image bearing member using the radical polymerizable compound having one functional group with a charge transport structure has good electric characteristics, thereby producing quality images for an extended period of time.

This is because the radical polymerizable compound having one functional group with a charge transport structure fixed among the cross-linking bondings pendulously.

By contrast, since the small molecular weight charge transport material having no functional group tends to precipitate and cause white crowd phenomenon, the sensitivity tends to extremely deteriorate and the residual voltage tends to extremely rise over repetitive use. When the radical polymerizable compound having two or more functional groups with a charge transport structure is used as the main component, the polymerizable compound having two or more functional groups are fixed in the cross linking structure with multiple bondings. Therefore, the intermediate structure (cation radical) during charge transport is not sustained stable, resulting in deterioration of the sensitivity and rise in the residual voltage due to charge trap. Such deterioration of the electric characteristics leads to reduction of the image density and production of thinner texts.

Next, the material that forms the cross-linked surface layer using the radical polymerizable monomer and a radical polymerizable compound having a charge transport structure.

The radical polymerizable monomer having three or more functional groups without a charge transport structure preferably for use in the cross-linked surface layer of the latent image bearing member represents a monomer having three or more radical polymerizable functional groups without a positive hole transport structure such as triaryl amine, hydrazone, pyrazoline, or carbazole or an electron transport structure such as condensed polycyclic quinone, diphenoquinone or an electron absorbing aromatic ring having a cyano group or a nitro group. The radical polymerizable functional group is any radical polymerizable functional group which has a carbon-carbon double bond.

For example, 1-substituted ethylene functional groups and 1,1-substituted ethylene functional groups are suitably used as the radical polymerizable functional group.

(1) A specific example of 1-substituted ethylene functional groups is the functional group represented by the following chemical structure d.

Chemical Structure d

CHₓ═CH—X₁— (d)

In the Chemical structure d, X1 represents an arylene group optionally having a substitution group, an alkenylene group optionally having a substitution group, —S— group, —CO— group, —COO— group, and —CON(R⁵)— group, where R⁵ represents hydrogen, an alkyl group, an aralkyl group and an aryl group,

Specific examples of the arylene group of the Chemical structure d include, but are not limited to, a phenylene group optionally having a substitution group and a naphtylene group optionally having a substitution group. Specific examples of the alkyl groups include, but are not limited to, methyl group and ethyl group. Specific examples of the aralkyl groups include, but are not limited to, benzyl group, naphthylmethyl group, and phenethyl group. Specific examples of the aryl groups include, but are not limited to, phenyl group and naphthyl group.

Specific examples of such functional groups represented by the Chemical structure d include, but are nor limited to, vinyl group, styryl group, 2-methyl-1,3-butadienyl group, vinyl carbonyl group, acryloyloxy group, acryloyl amide group, and vinylthio ether group.

(2) A specific example of 1,1-substituted ethylene functional groups is the functional group represented by the following Chemical structure e.

Chemical Structure e

CH_{z}═C(Y)—X_{z}— (e)

In the Chemical structure e, Y represents an alkyl group optionally having a substitution group, an aralkyl group optionally having a substitution group, an aryl group optionally having a substitution group, a halogen atom, a cyano group, a nitro group, an alkoxy group, and —COOR₆ group, where R₆ represents a hydrogen atom, an alkyl group optionally having a substitution group, an aralkyl group optionally having a substitution group, an aryl group optionally having a substitution group, and —CONR7R₈, where R₇ and R₈ independently represent a hydrogen atom, an alkyl group optionally having a substitution group, an aralkyl group optionally having a substitution group, and an aryl group optionally having a substitution group. X₂ represents a single bond, the same substitution group as X1 of the Chemical structure d, and an alkylene group. At least one of Y and X₂ is an oxycarbonyl group, a cyano group, an alkenylene group, and an aromatic ring.

Specific examples of the aryl group of the Chemical structure e include, but are not limited to, a phenyl group and a naphtyl group. Specific examples of the alkoxy groups include, but are not limited to, methoxy group and ethoxy group. Specific examples of the aralkyl groups include, but are not limited to, benzyl group, naphthylmethyl group, and phenethyl group. Specific examples of the alkyl groups include, but are not limited to, methyl group and ethyl group.

Specific examples of these functional groups represented by the Chemical structure e include, but are not limited to, α-acryloyloxy chloride group, methacryloyloxy group, α-cyanoethylene group, α-cyanoacryloyloxy group, α-cyanophenylene group, and methacryloyl amino group.

Specific examples of substitution groups further substituted with the substitution groups of X₁, X₂, and Y include, but are not limited to, a halogen atom, a nitro group, a cyano group, an alkyl group such as methyl group and ethyl group, an alkoxy group such as methoxy group and ethoxy group, aryloxy group such as phenoxy group, aryl group such as phenyl group and naphtyl group, and an aralkyl group such as benzyl group and phenetyl group.

Among these radical polymerizable functional groups, an acryloyloxy group and a methcryloyloxy group are particularly suitable. A compound having at least three acryloyloxy groups is obtained by conducting ester reaction or ester conversion reaction using, for example, a compound having at least three hydroxyl groups therein and an acrylic acid (salt), a halide acrylate, and an ester of acrylic acid. A compound having at least three methacryloyloxy groups is obtained in the same manner. In addition, the radical polymerizable functional groups in a monomer having at least three radical polymerizable functional groups can be the same or different from each other.

The radical polymerizable monomer having at least three functional groups without having a charge transport structure include the following compounds, but are not limited thereto.

Specific examples of the radical polymerizable monomers mentioned above for use in the present disclosure include, but are not limited to, trimethylol propane triacrylate (TMPTA), trimethylol propane trimethacrylate, EO modified trimethylol propane triacrylate, PO modified trimethylol propane triacrylate, caprolactone modified trimethylol propane triacrylate, HPA modified trimethylol propane triacrylate, pentaerythritol triacrylate, pentaerythritol tetra acrylate (PETTA), glycerol triacrylate, ECH modified glycerol triacrylate, EO modified glycerol triacrylate, PO modified glycerol triacrylate, tris (acryloxyrthyl)isocyanulate, dipenta erythritol hexacrylate (DPHA), caprolactone modified dipenta erythritol hexacrylate, dipenta erythritol hydroxyl dipenta acrylate, alkylized dipenta erythritol tetracrylate, alkylized dipenta erythritol triacrylate, dimethylol propane tetracrylate (DTMPTA), penta erythritol ethoxy tetracrylate, EO modified phosphoric acid triacrylate, and 2,2,5,5-tetrahydroxy methyl cyclopentanone tetracrylate. These can be used alone or in combination.

EO modified represents ethyleneoxy modified, PO modified represents propyleneoxy modified, and ECH modified represents epichlorohydrin modified.

In addition, in the radical polymerizable monomer having at least three functional groups without having a charge transport structure preferably used in the present disclosure, the ratio of the molecular weight to the number of the functional groups is preferably 250 or less to form dense cross-linking bondings in the cross-linked surface layer.

When the ratio is too great, the cross-linked surface layer tends to be soft and thus the abrasion resistance slightly deteriorates. Therefore, among the monomers specified above, it is not preferred to singly use a monomer which is modified by HPA, EO, or PO and has an extremely long modified group.

In addition, the content ratio of the radical polymerizable monomer having three functional groups without having a charge transport structure for use in the cross-linked surface layer is from 20 to 80% by weight and preferably from 35 to 65% by weight based on the total weight of the cross-linked surface layer. When the monomer content ratio is too small, the density of three-dimensional cross-linking bonding in the cross-linked surface layer tends to be small. Therefore, the abrasion resistance thereof is not drastically improved in comparison with a case in which a typical thermal plastic binder resin is used. When the monomer content ratio is too large, the content of the charge transport compound easily decreases, which may cause deterioration of the electric characteristics. Desired electric characteristics and abrasion resistance vary depending on the process used. Therefore, it is difficult to jump to any conclusion but considering the balance of the combination, the range of from 35% to 65% by weight is most preferred.

The radical polymerizable compound (monomer) having a charge transport structure preferably used in the present disclosure represents a compound having a radical polymerizable functional group, and a positive hole structure such as triaryl amine, hydrazone, pyrazoline, or carbazole, or an electron transport structure such as condensed polycyclic quinone, diphenoquinone or an electron absorbing aromatic ring having a cyano group or a nitro group. As the radical polymerizable functional group, the radical polymerizable functional groups specified in the radical polymerizable monomer mentioned above can be suitably used. Among these, acryloyloxy group and methcryloyloxy group are particularly suitable.

Among the charge transport structures, triaryl amine structure is preferable. Furthermore, when the radical polymerizable compound having one functional group with a charge transport structure having a triaryl amine structure represented by the following chemical structures I and II are used, the electric characteristics such as sensitivity and residual voltage are sustained preferably.

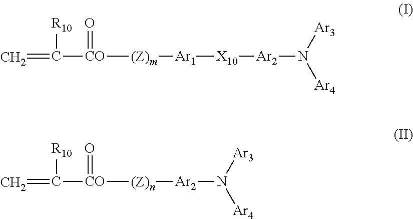

In the Chemical structures I and II, R₁₀ represents a hydrogen atom, a halogen atom, an alkyl group optionally having a substitution group, an aralkyl group optionally having a substitution group, an aryl group optionally having a substitution group, a cyano group, a nitro group, an alkoxy group, and —COOR₁₁ group, where R₁₁ represents a hydrogen atom, an alkyl group optionally having a substitution group, an aralkyl group optionally having a substitution group, an aryl group optionally having a substitution group, and —CONR₁₂R₁₃, where R₁₂ and R₁₃ independently represent a hydrogen atom, a halogen atom, an alkyl group optionally having a substitution group, an aralkyl group optionally having a substitution group, and an aryl group optionally having a substitution group.

Ar₅ and Ar₆ independently represent an arylene group optionally having a substitution group. Ar₃ and Ar₄ independently represent an aryl group optionally having a substitution group. X₁₀ represents a single bond, an alkylene group optionally having a substitution group, a cycloalkylene group optionally having a substitution group, an alkylene ether group optionally having a substitution group, an oxygen atom, a sulfur atom, and a vinylene group. Z represents an alkylene group optionally having a substitution group, an alkylene ether group optionally having a substitution group, and an alkyleneoxy carbonyl group. m and n independently represent an integer of from 0 to 3.

Specific examples of each group of the Chemical structures I and II are as follows.

In the Chemical structures I and II, as the substitution groups of R₁₀, specific examples thereof include, but are not limited to, a methyl group, an ethyl group, a propyl group, and a butyl group. Specific examples of the aryl groups of R₁₀ include, but are not limited to, phenyl group and naphtyl group. Specific examples of the aralkyl groups of R₁₀ include, but are not limited to, benzyl group, a phenthyl group and a naphtyl methyl group. Specific examples of the alkoxy group of R₁₀ include, but are not limited to, a methoxy group, an ethoxy group, and a propoxy group. These can be substituted by a halogen atom, a nitro group, a cyano group, an alkyl group such as methyl group and ethyl group, an alkoxy group such as methoxy group and ethoxy group, an aryloxy group such as phenoxy group, an aryl group such as phenyl group and naphtyl group, and an aralkyl group such as benzyl group and phenthyl group.

Among these substitution groups of R₁₀, a hydrogen atom and a methyl group are particularly preferable.

Ar₃ and Ar₄ represent an aryl group optionally having a substitution group. Specific examples thereof include, but are not limited to, condensed polycyclic hydrocarbon groups, non-condensed ring hydrocarbon groups, and heterocyclic groups.

Specific examples of the condensed polycyclic hydrocarbon groups include, but are not limited to, a group in which the number of carbons forming a ring is not greater than 18 such as pentanyl group, indenyl group, naphtyl group, azulenyl group, heptalenyl group, biphenylenyl group, as-indacenyl group, s-indacenyl group, fluorenyl group, acenaphtylenyl group, pleiadenyl group, acenaphtenyl group, phenalenyl group, phenanthryl group, anthryl group, fluorantenyl group, acephenantrirenyl group, aceantrirenyl group, triphenylene group, pyrenyl group, chrysenyl group, and naphthacenyl group.

Specific examples of the non-condensed ring hydrocarbon groups include, but are not limited to, a single-valent group of monocyclic hydrocarbon compounds such as benzene, diphenyl ether, polyethylene diphenyl ether, diphenylthio ether and phenylsulfon, a single-valent group of non-condensed polycyclic hydrocarbon compounds such as biphenyl, polyphenyl, diphenyl alkane, diphenyl alkene, diphenyl alkyne, triphenyl methane, distyryl benzene, 1,1-diphenyl cycloalkane, polyphenyl alkane and polyphenyl alkene or a single-valent group of ring aggregated hydrocarbon compounds such as 9,9-diphenyl fluorene.

Specific examples of the heterocyclic groups include, but are not limited to, a single-valent group such as carbazol, dibenzofuran, dibenzothiophene, oxadiazole, and thiadiazole.

The aryl groups represented by Ar₃ and _{Ar4} can have a substitution group. Specific examples thereof are as follows:

(1) Halogen atom, Cyano group, and Nitro group;

(2) Alkyl Group A straight chained or side chained alkyl group having one to 12, more preferably one to eight, and furthermore preferably from one to four carbons is preferably specified. These alkyl groups can have a fluorine atom, a hydroxyl group, an alkoxy group having one to four carbon atoms, a phenyl group, and a phenyl group substituted by a halogen atom, an alkyl group having one to four carbon atoms, or an alkoxy group having one to four carbon atoms.

Specific examples thereof include, but are not limited to, methyl group, ethyl group, n-butyl group, i-propyl group, t-butyl group, s-butyl group, n-propyl group, trifluoromethyl group, 2-hydroxy ethyl group, 2-ethoxyethyl group, 2-cyanoethyl group, 2-methoxyethyl group, benzyl group, 4-chlorobenzyl group, 4-methyl benzyl group and 4-phenyl benzyl group;

(3) Alkoxy Group (—OR₁₄) R₁₄ is the same alkyl group as represented in (2).

Specific examples thereof include, but are not limited to, methoxy group, ethoxy group, n-propoxy group, i-propoxy group, t-butoxy group, n-butoxy group, s-butoxy group, i-butoxy group, 2-hydroxy ethoxy group, benzyl oxy group, and trifluoromethoxy group;

(4) Aryloxy Group Specific examples of the aryl group of the aryloxy group include, but are not limited to, phenyl group and naphtyl group. These can contain an alkoxy group having one to four carbon atoms, an alkyl group having one to four carbon atoms, or a halogen atom as a substitution group.

Specific examples include, but are not limited to, phenoxy group, 1-naphtyloxy group, 2-naphtyloxy group, 4-methoxyphenoxy group, and 4-methylphenoxy group;

(5) Alkyl Mercapto Group or Aryl Mercapto Group

Specific examples include, but are not limited to, a methylthio group, an ethylthio group, a phenylthio group, and p-methylphenylthio group.

(6) Group represented by Chemical Structure f

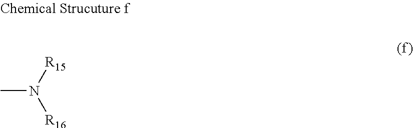

In Chemical formula f, R₁₅ and R₁₆ independently represent a hydrogen atom, the alkyl group defined in (2), and an aryl group. R₁₅ and R₁₆ can share a linkage to form a ring.

Specific examples of the aryl groups include, but are not limited to, phenyl group, biphenyl group, or naphtyl group. These can contain an alkoxy group having one to four carbon atoms, an alkyl group having one to four carbon atoms or a halogen atom as a substitution group.

Specific examples thereof include, but are not limited to, amino group, diethyl amino group, N-methyl-N-phenyl amino group, N,N-diphenyl amino group, N,N-di(tolyl)amino group, dibenzyl amino group, piperidino group, morpholino group, and pyrrolidino group;

(7) Alkylene dioxy group or alkylene dithio group such as methylene dioxy group and methylene dithio group; and

(8) Styryl group optionally having a substitution group, β-phenyl styryl group optionally having a substitution group, diphenyl aminophenyl group, ditolyl aminophenyl group, etc.

The arylene groups represented by Ar₅ and Ar₆ specified above are divalent groups deriving from the aryl group represented by Ar₃ and Ar₄ mentioned above.

X₁₀ represents a single bond, an alkylene group optionally having a substitution group, a cycloalkylene group optionally having a substitution group, an alkylene ether group optionally having a substitution group, an oxygen atom, a sulfur atom, or a vinylene group.

The straight chained or side chained alkyl group optionally having a substitution group has one to 12 carbon atoms, preferably one to eight carbon atoms, and more preferably from one to four carbon atoms. These alkyl groups can have a fluorine atom, a hydroxyl group, an alkoxy group having one to four carbon atoms, a phenyl group, or a phenyl group substituted by a halogen atom, an alkyl group having one to four carbon atoms, or an alkoxy group having one to four carbon atoms.

Specific examples thereof include, but are note limited to, methylene group, ethylene group, n-butylene group, -propylene group, t-butylene group, s-butylene group, n-propylene group, trifluoromethylene group, 2-hydroxy ethylene group, 2-ethoxyethylene group, 2-cyanoethylene group, 2-methoxyethylene group, benzylidene group, phenyl ethylene group, 4-chlorophenyl ethylene group, 4-methylpheny ethylene group, and 4-biphenyl ethylene group.

Specific examples of the cycloalkylene groups optionally having a substitution group include, but are not limited to, a cyclic alkylene group having five to seven carbon atoms. These cyclic alkylene groups can have a fluorine atom, a hydroxyl group, an alkyl group having one to four carbon atoms, and an alkoxy group having one to four carbon atoms. Specific examples thereof include, but are not limited to, a cyclohexylidene group, a cyclohexylene group, and a 3,3-dimethyl cyclohexylidene group.

Specific examples of the alkylene ether groups optionally having a substitution group include, but are not limited to, —CH₂CH₂O—, —CH₂CH₂CH₂O—, —(OCH₂CH₂)h—O—, and —(OCH₂CH₂CH₂)i-O—. In these alkylene ether groups, h and i independently represent an integer of from 1 to 4.

These alkylene ether groups can have a substitution group such as a hydroxyl group, a methyl group or an ethyl group.

The vinylene groups in X₁₀ are groups represented by the following Chemical structure g or h.

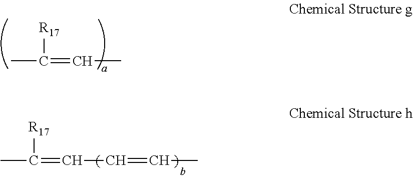

In the Chemical structures g and h, R_{y}, represents a hydrogen atom and an alkyl group {the same as the alkylene groups defined in (2)} and “a” represents 1 or 2 and b is an integer of from 1 to 3.

Z represents an alkylene group optionally having a substitution group, an alkylene ether group optionally having a substitution group, and an alkyleneoxy carbonyl group.

Specific examples of the alkylene groups optionally having a substitution group include, but are not limited to, the same as those specified for the X mentioned above.

Specific examples of the alkylene ether groups optionally having a substitution group include, but are not limited to, the same as those specified for the X mentioned above.

A specific example of the alkyleneoxy carbonyl group is a caprolactone modified group.

The compound represented by the following Chemical structure III is a further suitably preferable radical polymerizable compound having one functional group with a charge transport structure.

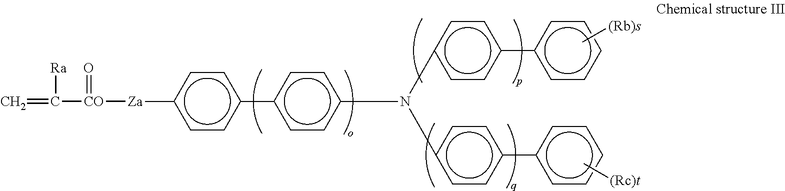

In the Chemical structure III, “o”, “p”, “q”, each, independently, represent 0 or 1, Ra represents a hydrogen atom or a methyl group, and Rb and Rc, each, independently, represent an alkyl group (excluding hydrogen atom) having one to six carbon atoms. s and t independently represent 0 or an integer of from 1 to 3. Za represents a single bond, a methylene group, an ethylene group, or a divalent group represented by the following Chemical structures a, b, and c.

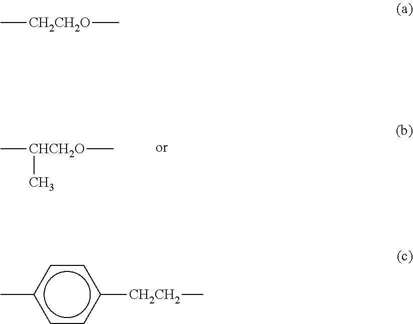

Among the compounds represented by the Chemical structure III illustrated above, compounds having a methyl group or an ethyl group as a substitution group of Rb and Rc are particularly preferred.

The cross-linked surface layer preferably for use in the present disclosure is free from cracking and has excellent electric characteristics. The radical polymerizable compound having a functional group with a charge transport structure for use in the present disclosure represented by the Chemical structures I, II, and III in particular is polymerized in a manner that both sides of the carbon-carbon double bonding are open. Therefore, the radical polymerizable compound does not constitute an end of the structure and is set in a chained polymer. The radical polymerizable compound having a functional group is present in the main chain of a polymer in which cross-linking is formed by polymerization with a radical polymerizable monomer having three functional groups or a cross-linking chain between the main chains. There are two kinds of the cross-linking chains. One is the cross-linking chain between a polymer and another polymer and the other is the cross-linking chain formed by cross-linking a portion in the main chain present in a folded state in a polymer and a moiety deriving from a monomer polymerized away from the portion. Whether a radical polymerizable compound having a functional group with a charge transport structure is present in a main chain or in a cross-linking chain, the triaryl amine structure suspends from the chain portion. The triaryl amine structure has at least three aryl groups disposed in the radial directions relative to the nitrogen atom therein. Although such a triaryl amine structure is bulky, it does not directly bind with the chain portion but suspends from the chain portion via the carbonyl group, etc. That is, the triaryl amine structure is stereoscopically fixed in a flexible state. Therefore, these triaryl amine structures can be adjacent to each other with a moderate space. Therefore, the structural distortion is slight in a molecule. In addition, when the structure is used in the surface layer of an image bearing member, it can be deduced that the internal molecular structure can have a structure in which there are relatively few disconnections in the charge transport route.

Specific examples of the radical polymerizable monomer having one functional group with a charge transport structure include, but are not limited to, the following compounds, but are not limited thereto.

TABLE 11

| | |
|---|---|
| No. 1 | 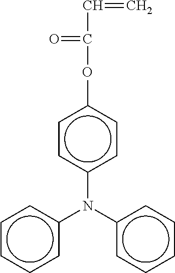 |
| No. 2 | 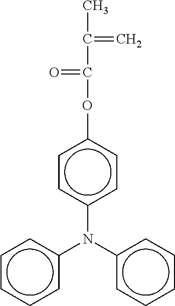 |
| No. 3 | 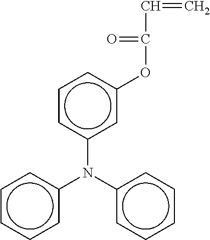 |
| No. 4 | 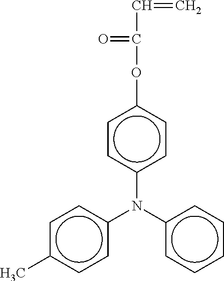 |
| No. 5 | 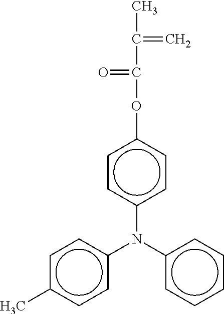 |
| No. 6 | 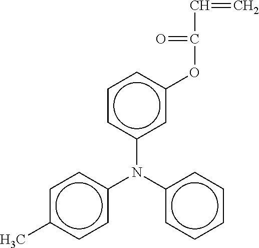 |
| No. 7 | 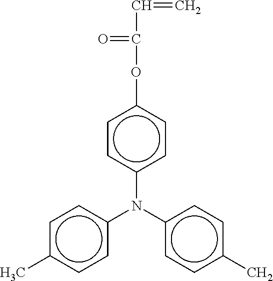 |
| No. 8 | 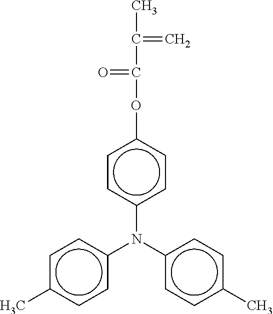 |

TABLE 12

| | |
|---|---|
| No. 9 | 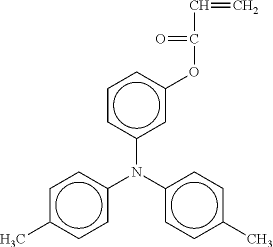 |
| No. 10 | 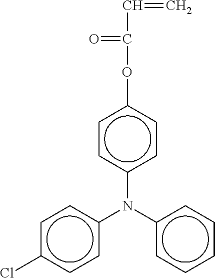 |
| No. 11 | 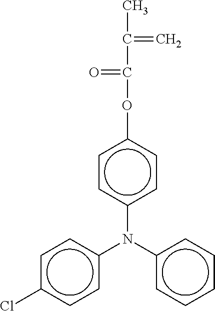 |
| No. 12 | 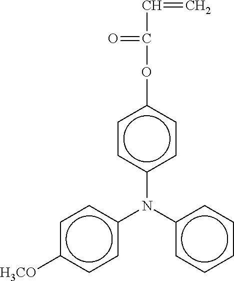 |
| No. 13 | 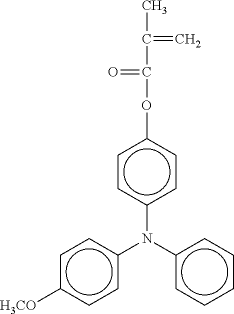 |
| No. 14 | 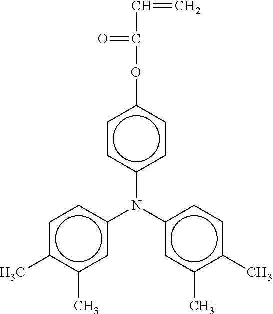 |
| No. 15 | 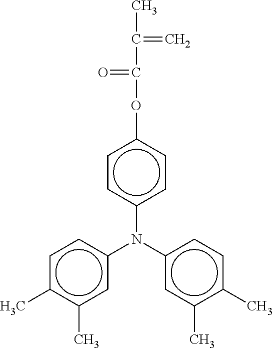 |
| No. 16 | 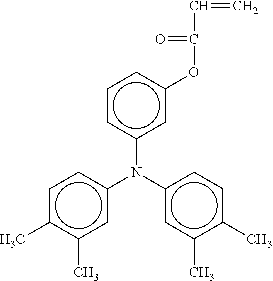 |

TABLE 13

| | |
|---|---|
| No. 17 | 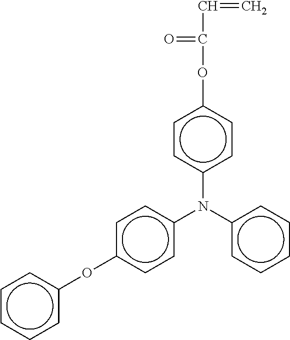 |
| No. 18 | 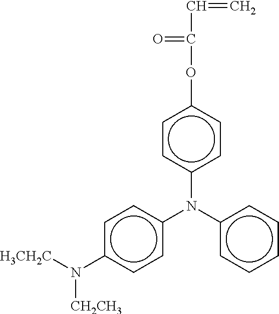 |
| No. 19 | 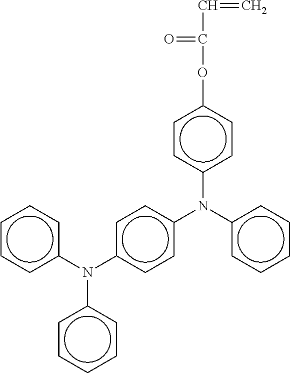 |
| No. 20 | 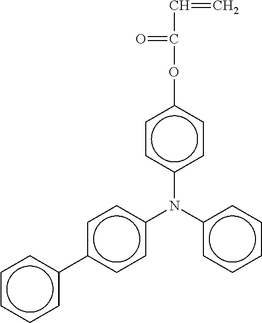 |
| No. 21 | 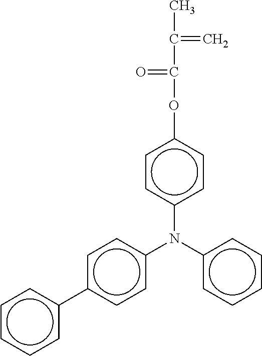 |
| No. 22 | 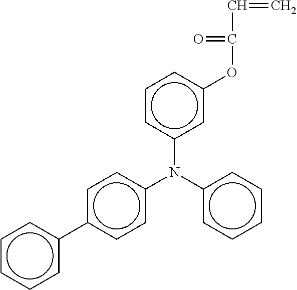 |

TABLE 14

| | |
|---|---|
| No. 23 | 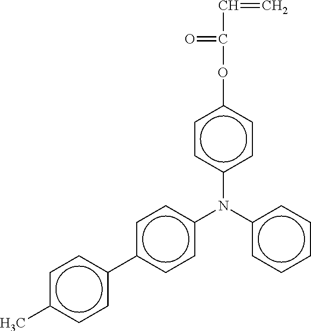 |
| No. 24 | 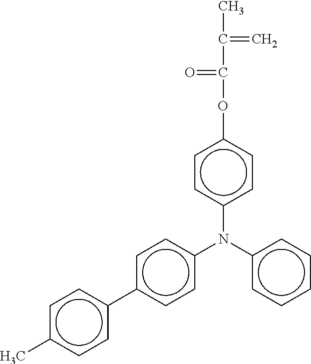 |
| No. 25 | 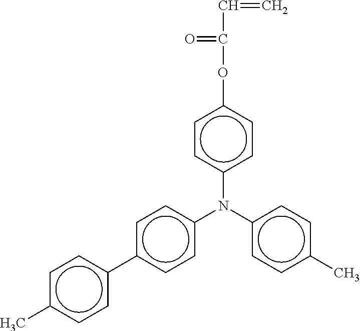 |
| No. 26 | 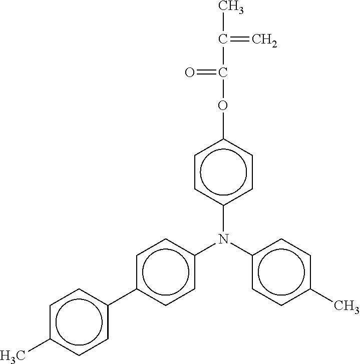 |
| No. 27 | 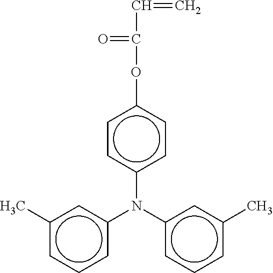 |
| No. 28 | 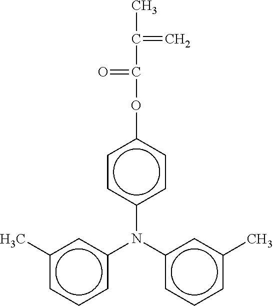 |
| No. 29 | 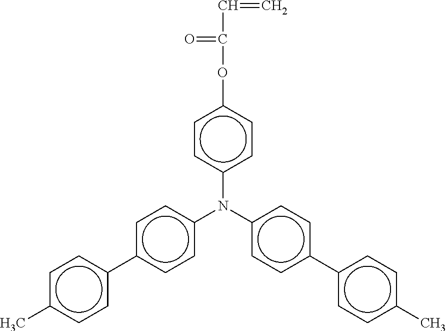 |
| No. 30 | 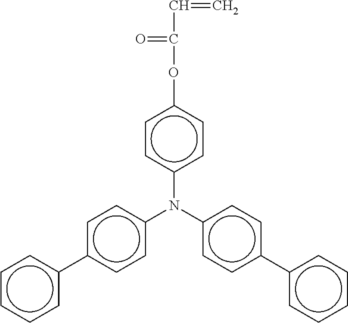 |

TABLE 15

| | |
|---|---|
| No. 31 | 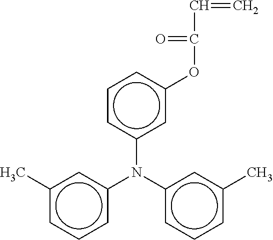 |
| No. 32 | 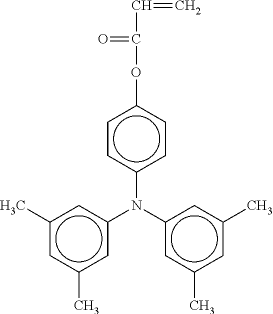 |
| No. 33 | 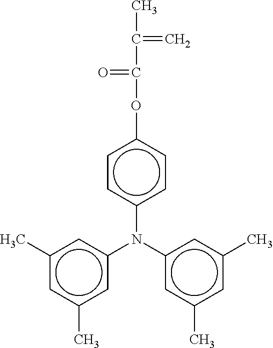 |
| No. 34 | 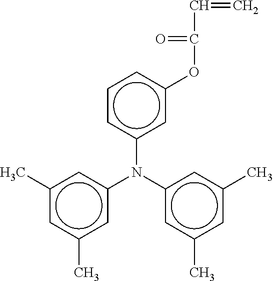 |
| No. 35 | 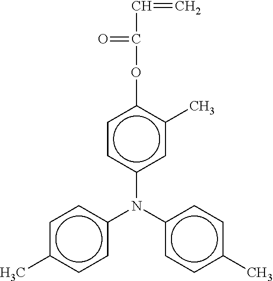 |
| No. 36 | 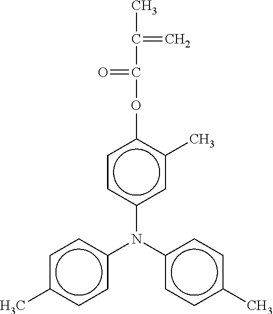 |
| No. 37 | 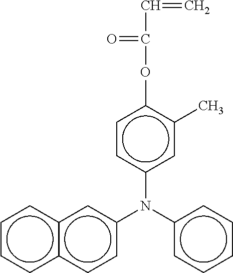 |
| No. 38 | 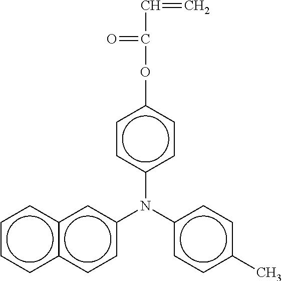 |

TABLE 16

| | |
|---|---|
| No. 39 | 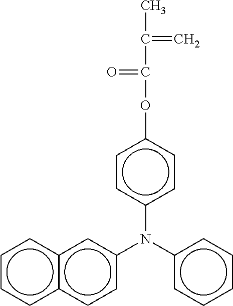 |
| No. 40 | 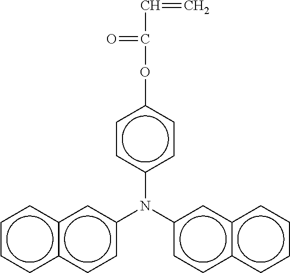 |
| No. 41 | 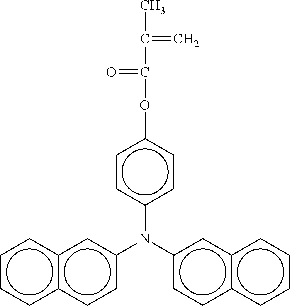 |
| No. 42 | 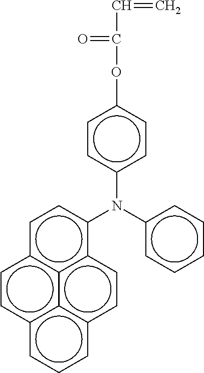 |
| No. 43 | 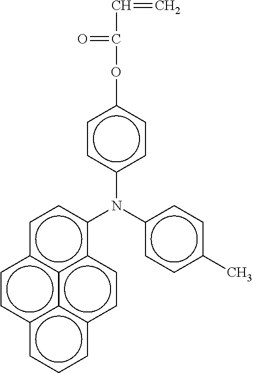 |
| No. 44 | 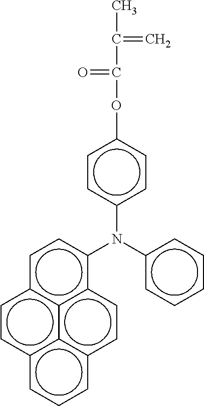 |

TABLE 17

| | |
|---|---|
| No. 45 | 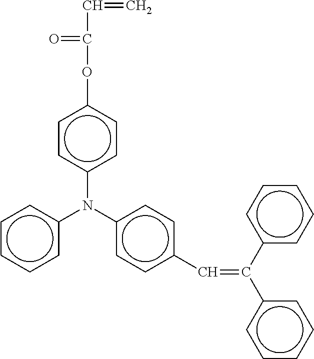 |
| No. 46 | 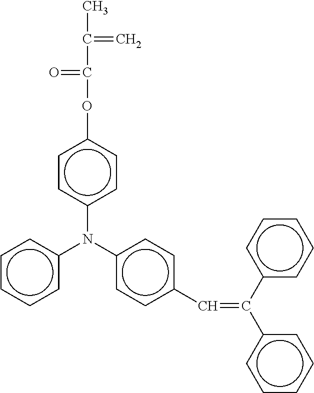 |
| No. 47 | 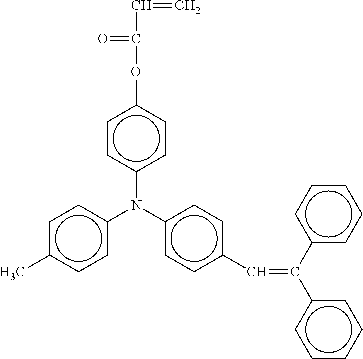 |
| No. 48 | 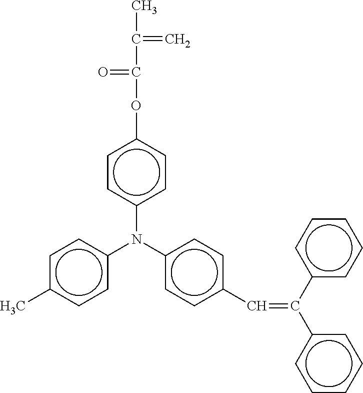 |
| No. 49 | 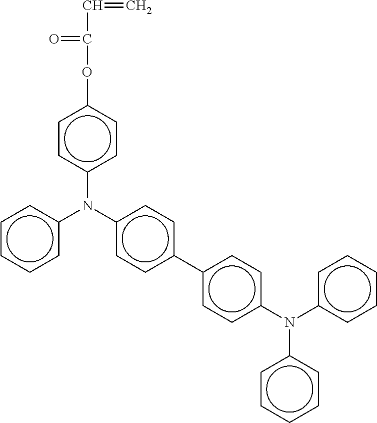 |
| No. 50 | 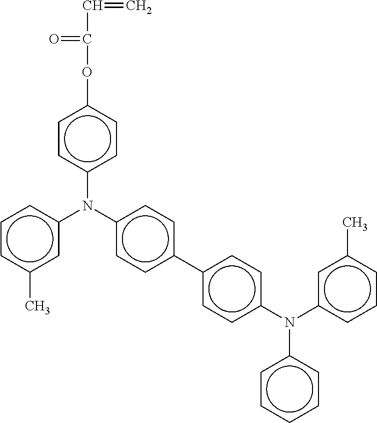 |

TABLE 18

| | |
|---|---|
| No. 51 | 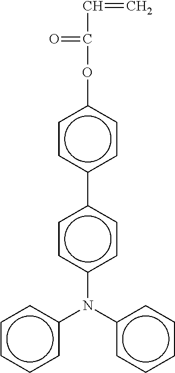 |
| No. 52 | 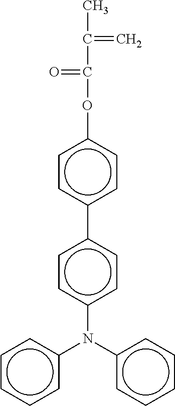 |
| No. 53 | 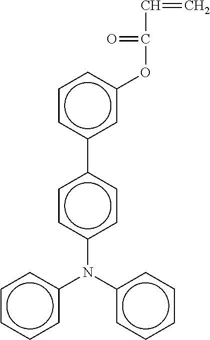 |
| No. 54 | 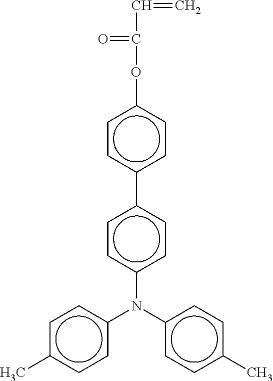 |
| No. 55 | 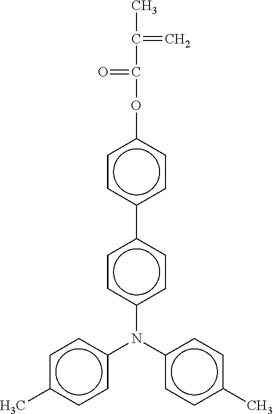 |
| No. 56 | 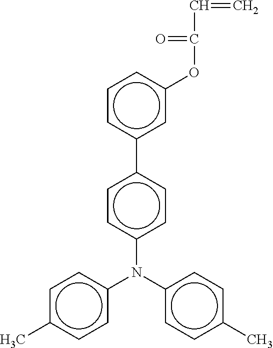 |

TABLE 19

| | |
|---|---|
| No. 57 | 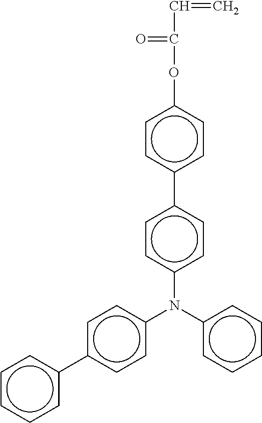 |
| No. 58 | 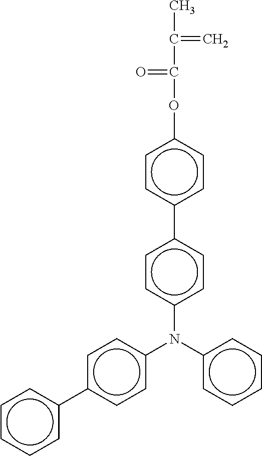 |
| No. 59 | 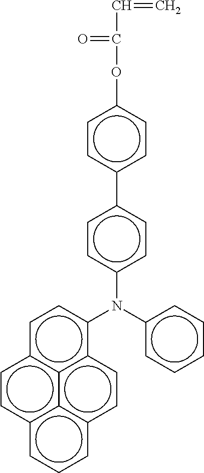 |
| No. 60 | 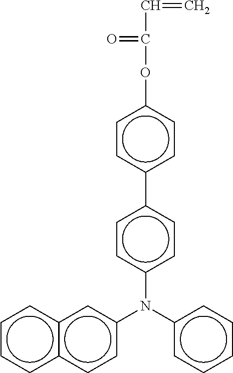 |
| No. 61 | 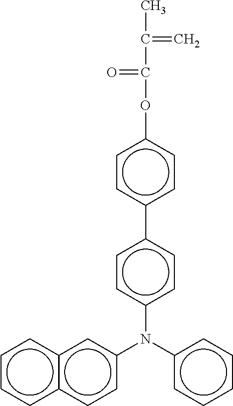 |
| No. 62 | 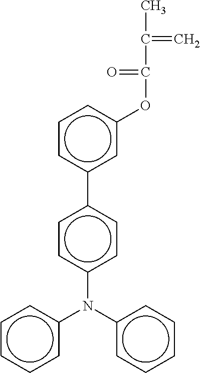 |

TABLE 20

| | |
|---|---|
| No. 63 | 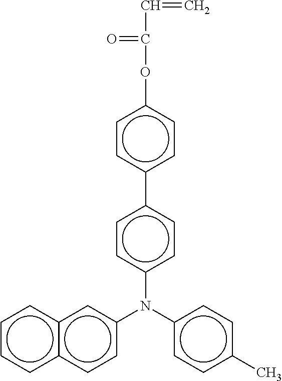 |
| No. 64 | 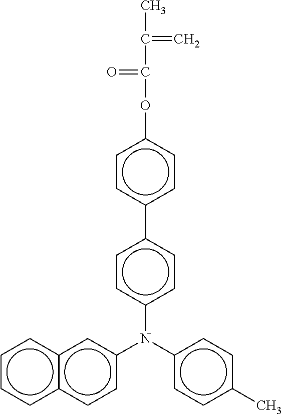 |
| No. 65 | 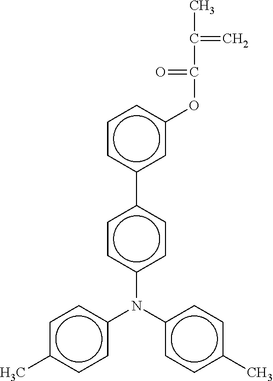 |
| No. 66 | 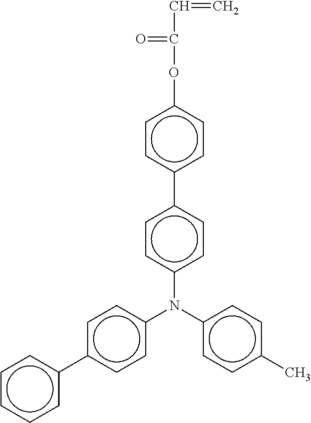 |
| No. 67 | 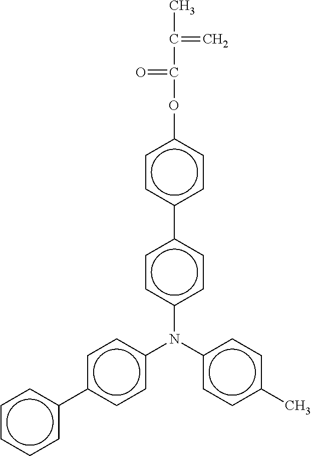 |
| No. 68 | 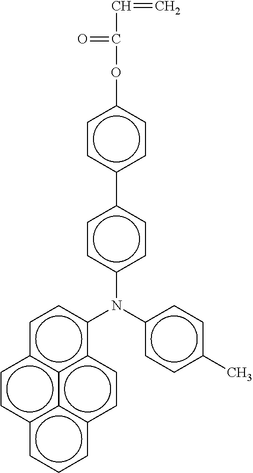 |

TABLE 21

| | |
|---|---|
| No. 69 | 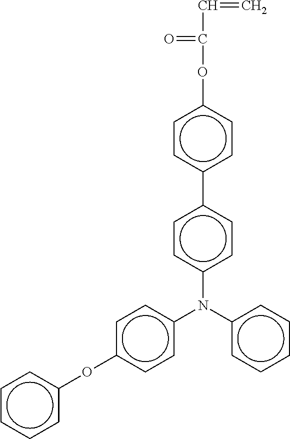 |
| No. 70 | 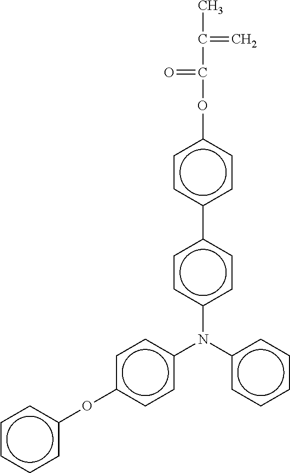 |
| No. 71 | 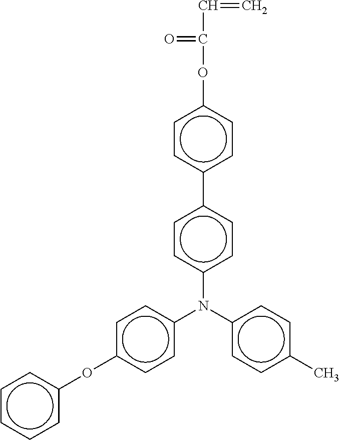 |
| No. 72 | 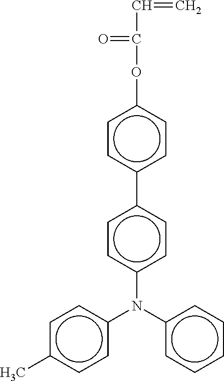 |
| No. 73 | 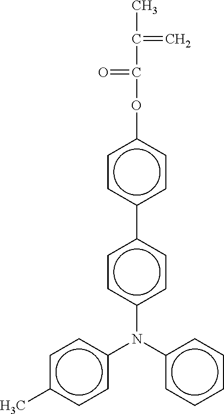 |
| No. 74 | 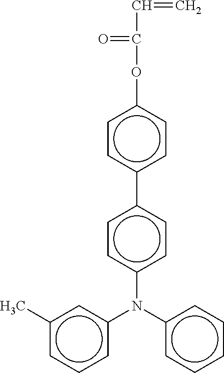 |

TABLE 22

| | |
|---|---|
| No. 75 | 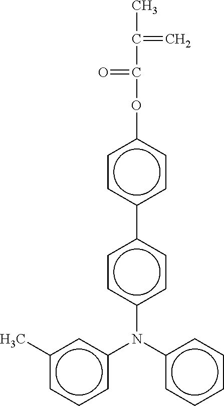 |
| No. 76 | 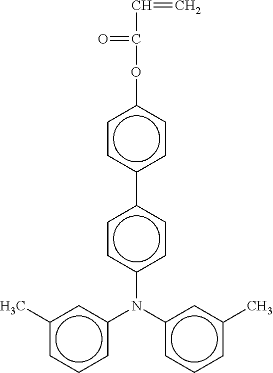 |
| No. 77 | 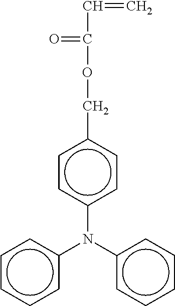 |
| No. 78 | 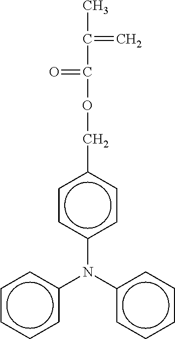 |
| No. 79 | 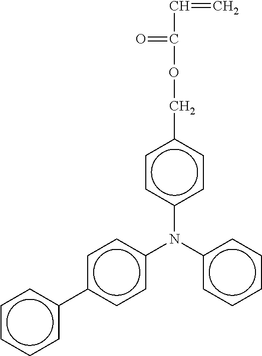 |
| No. 80 | 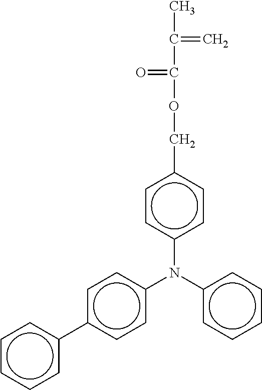 |

TABLE 23

| | |
|---|---|
| No. 81 | 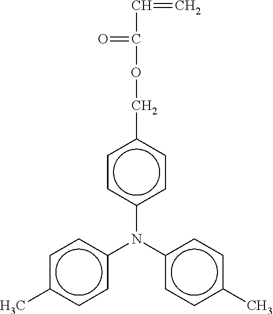 |
| No. 82 | 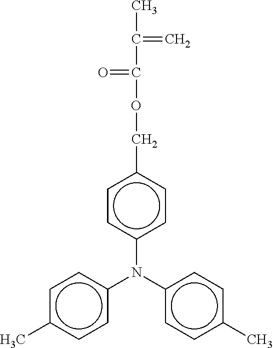 |
| No. 83 | 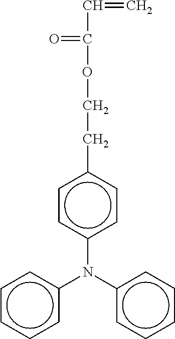 |
| No. 84 | 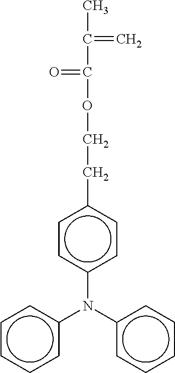 |
| No. 85 | 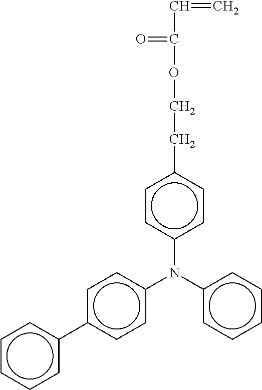 |
| No. 86 | 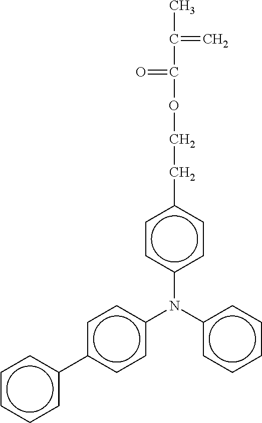 |

TABLE 24

| | |
|---|---|
| No. 87 | 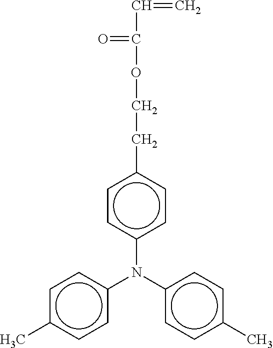 |
| No. 88 | 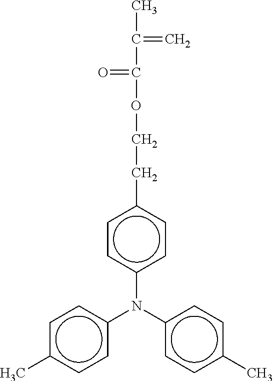 |
| No. 89 | 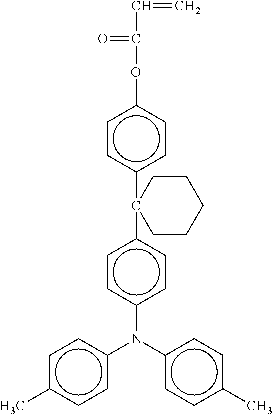 |
| No. 90 | 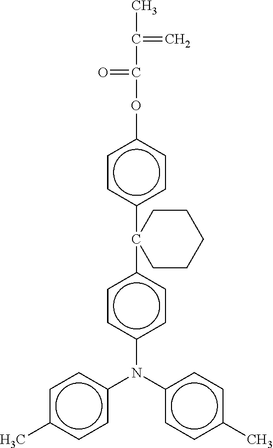 |
| No. 91 | 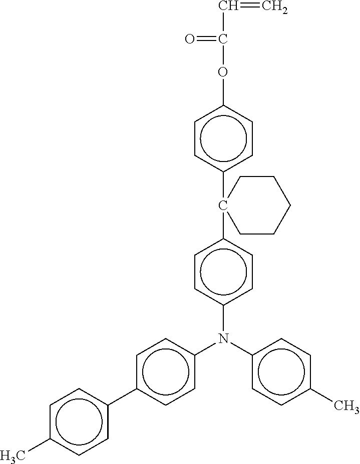 |
| No. 92 | 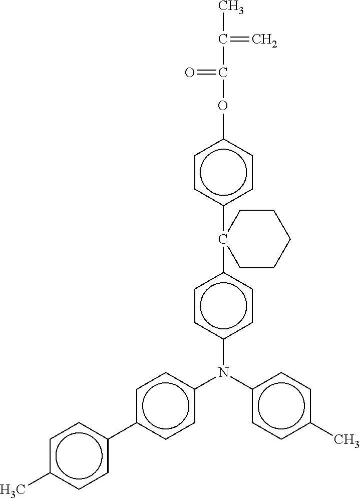 |

TABLE 25

| | |
|---|---|
| No. 93 | 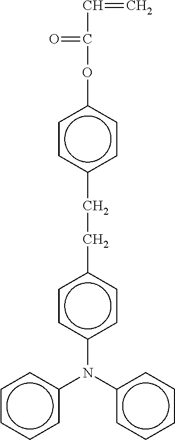 |
| No. 94 | 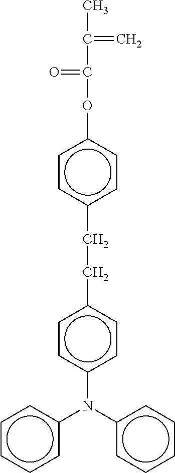 |
| No. 95 | 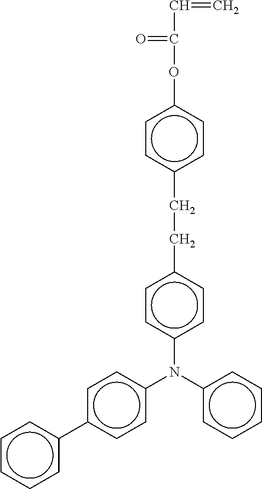 |
| No. 96 | 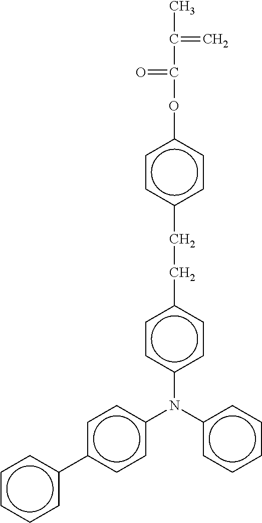 |

TABLE 26

| | |
|---|---|
| No. 97 | 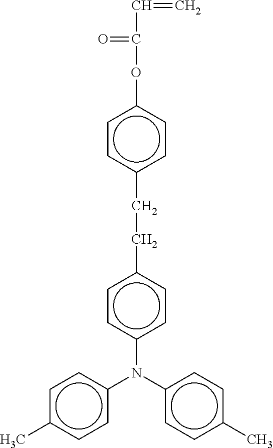 |
| No. 98 | 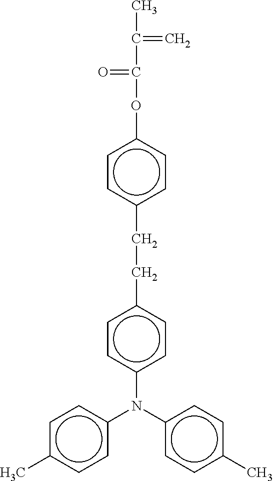 |
| No. 99 | 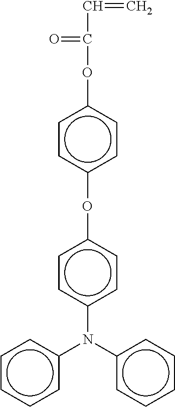 |
| No. 100 | 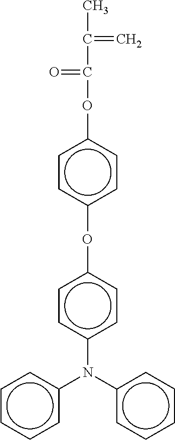 |

TABLE 27

| | |
|---|---|
| No. 101 | 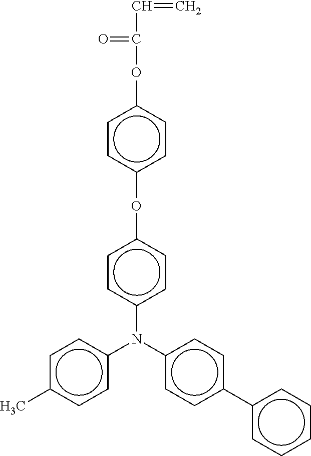 |
| No. 102 | 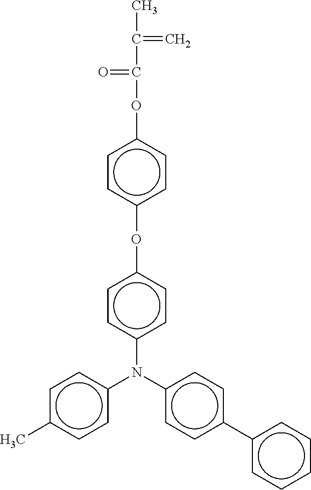 |
| No. 103 | 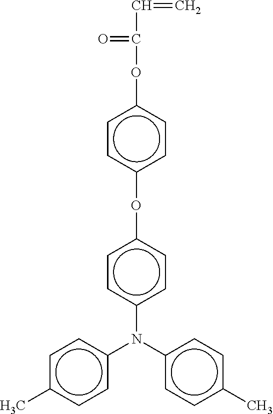 |
| No. 104 | 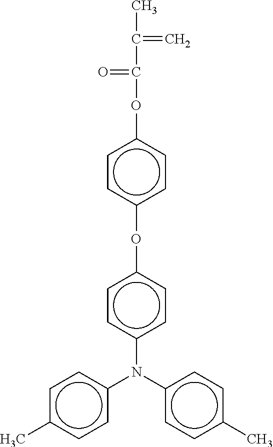 |

TABLE 28

| | |
|---|---|
| No. 105 | 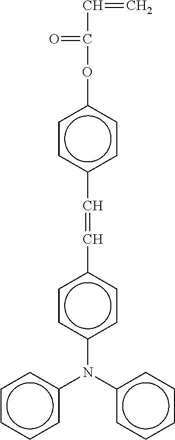 |
| No. 106 | 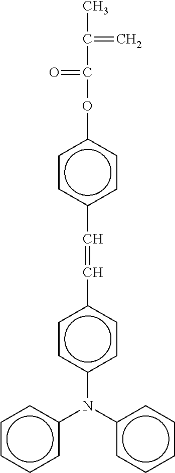 |
| No. 107 | 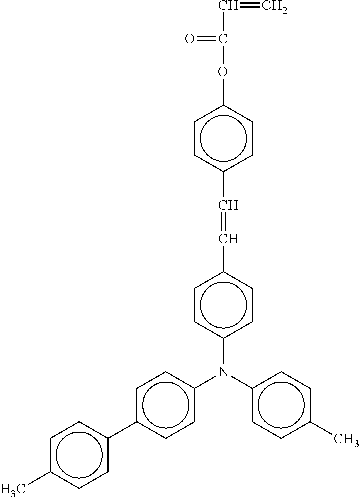 |
| No. 108 | 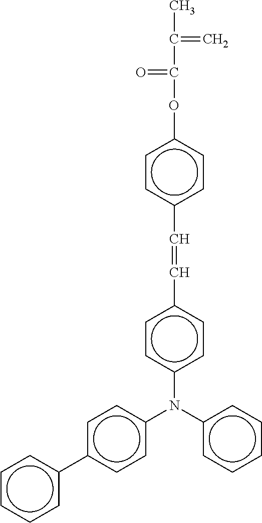 |

TABLE 29

| | |
|---|---|
| No. 109 | 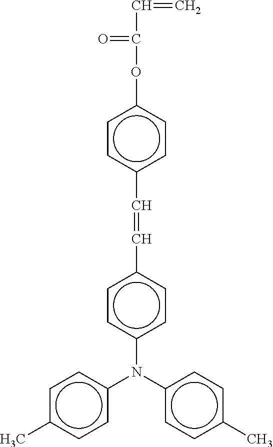 |
| No. 110 | 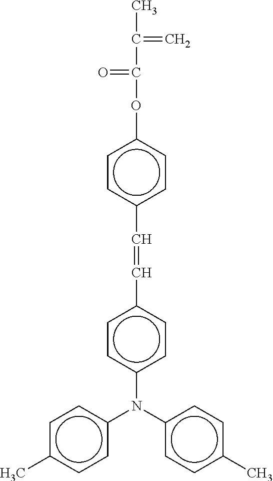 |
| No. 111 | 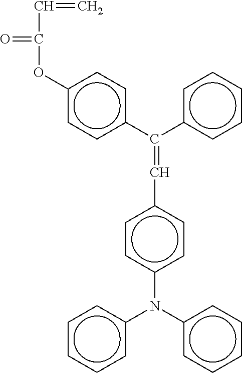 |
| No. 112 | 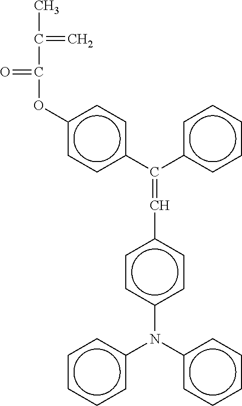 |
| No. 113 | 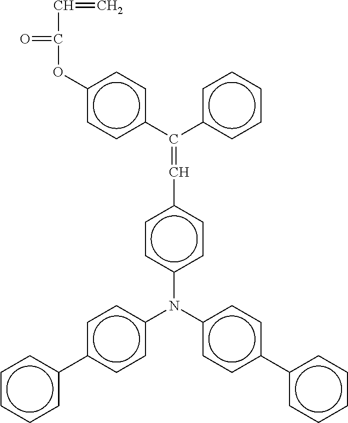 |
| No. 114 | 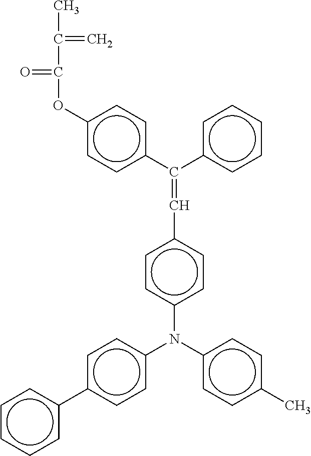 |

TABLE 30

| | |
|---|---|
| No. 115 | 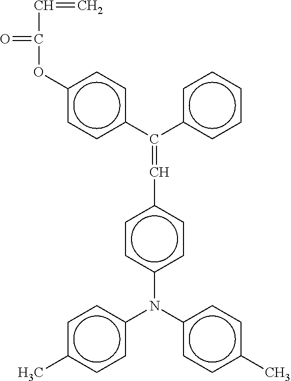 |
| No. 116 | 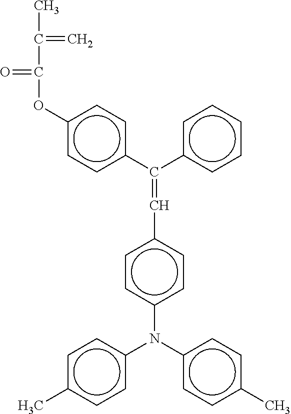 |
| No. 117 | 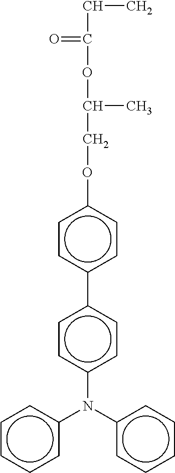 |
| No. 118 | 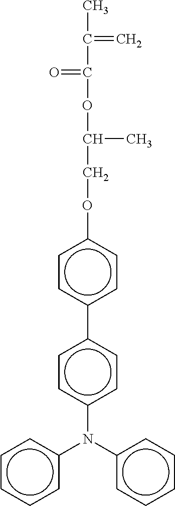 |

TABLE 31

| | |
|---|---|
| No. 119 | 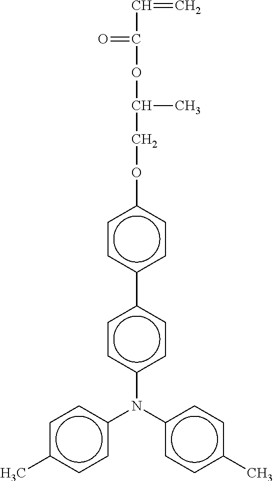 |
| No. 120 | 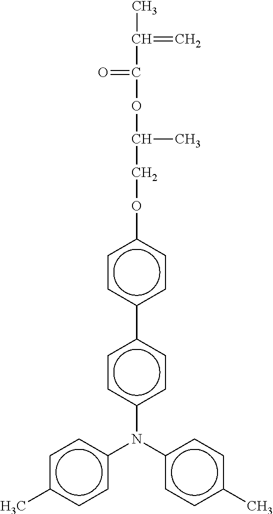 |
| No. 121 | 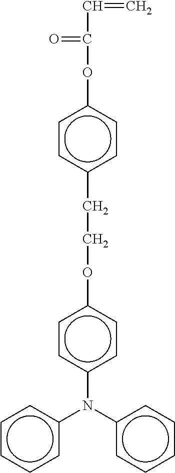 |
| No. 122 | 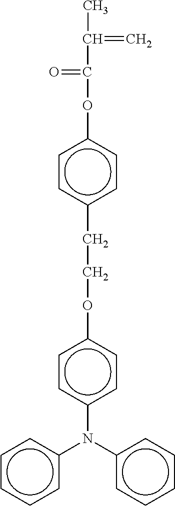 |

TABLE 32

| | |
|---|---|
| No. 123 | 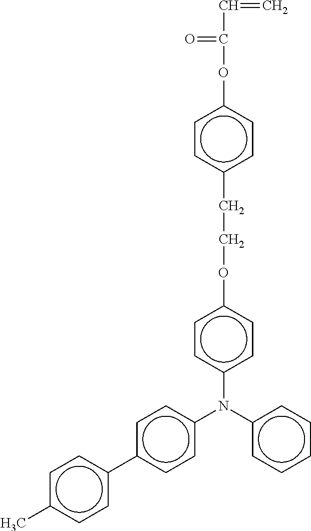 |
| No. 124 | 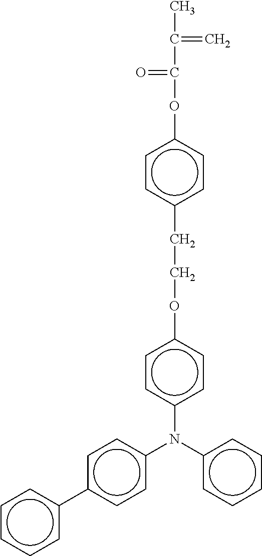 |
| No. 125 | 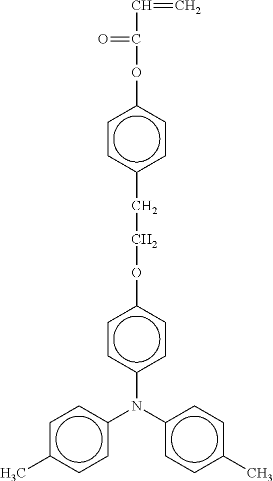 |
| No. 126 | 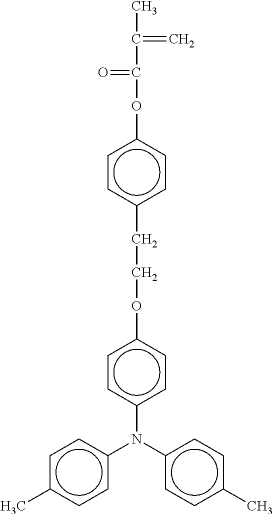 |

TABLE 33

| | |
|---|---|
| No. 127 | 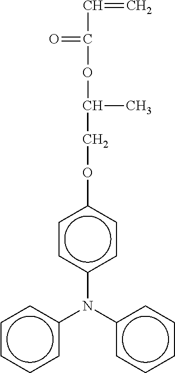 |
| No. 128 | 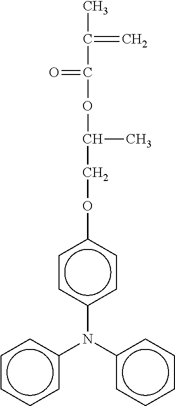 |
| No. 129 | 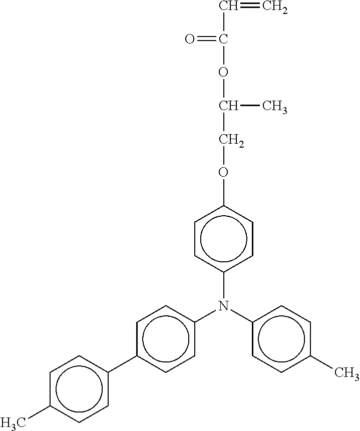 |
| No. 130 | 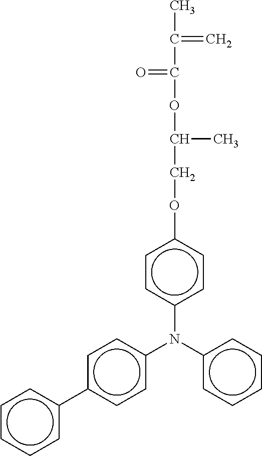 |
| No. 131 | 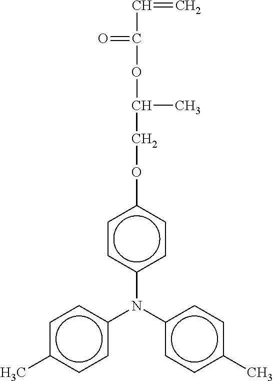 |
| No. 132 | 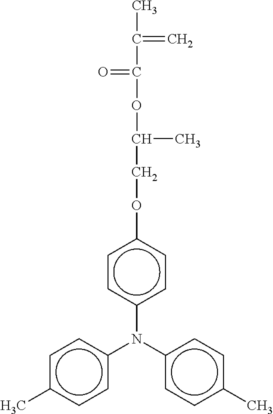 |

TABLE 34

| | |
|---|---|
| No. 133 | 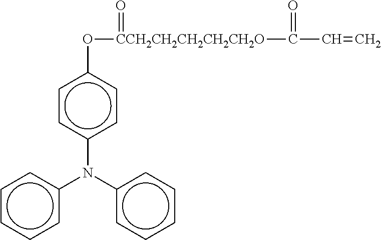 |
| No. 134 | 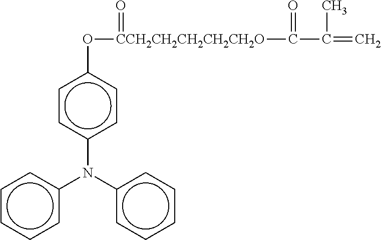 |
| No. 135 | 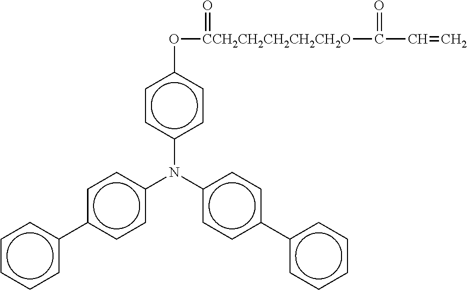 |
| No. 136 | 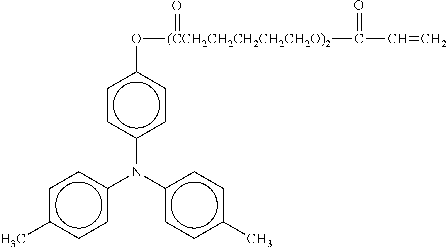 |

TABLE 35

| | |
|---|---|
| No. 137 | 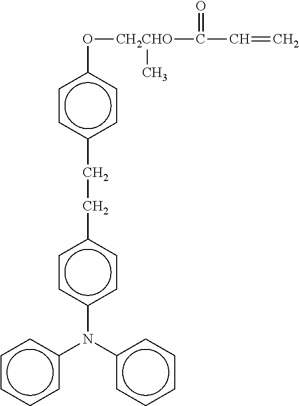 |
| No. 138 | 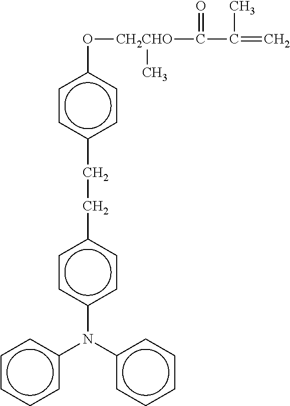 |
| No. 139 | 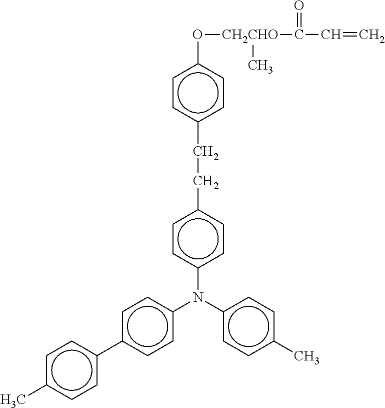 |
| No. 140 | 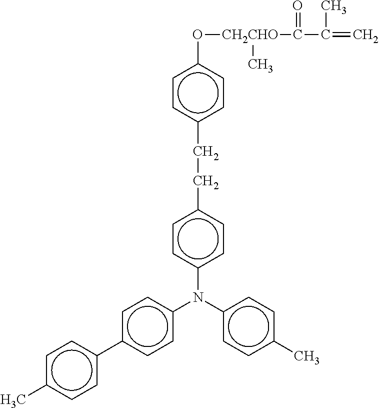 |

TABLE 36

| | |
|---|---|
| No. 141 | 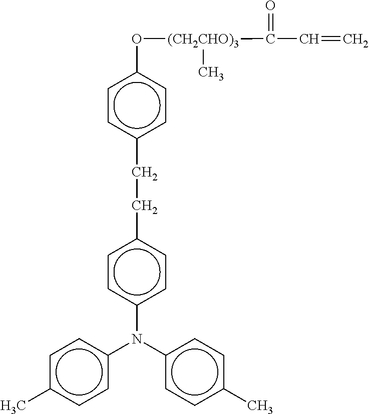 |
| No. 142 | 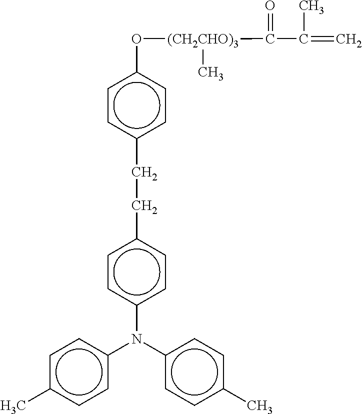 |
| No. 143 | 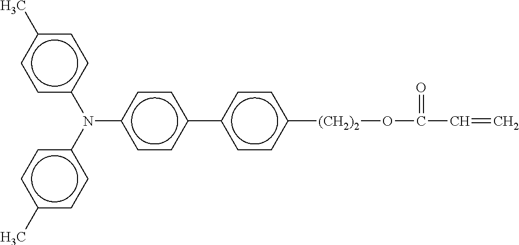 |
| No. 144 | 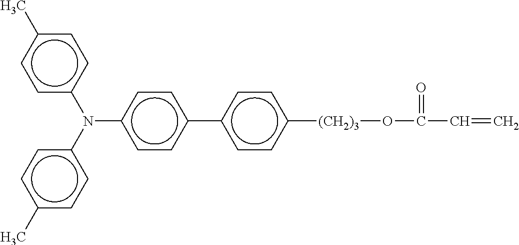 |

TABLE 37

| | |
|---|---|
| No. 145 | 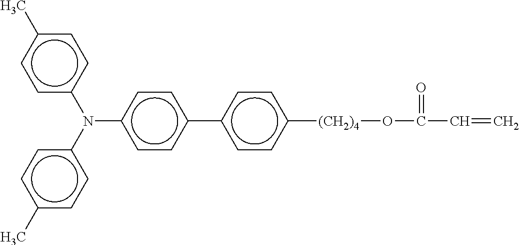 |
| No. 146 | 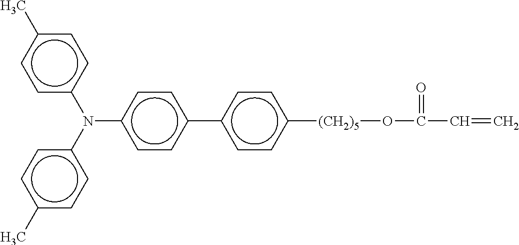 |
| No. 147 | 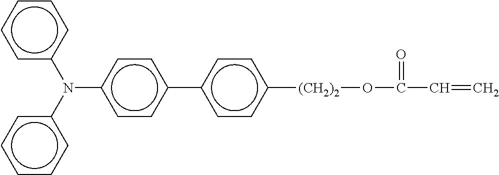 |
| No. 148 | 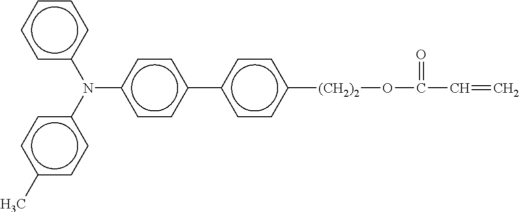 |
| No. 149 | 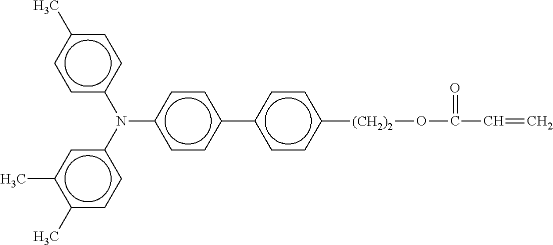 |

TABLE 38

| No. 150 | 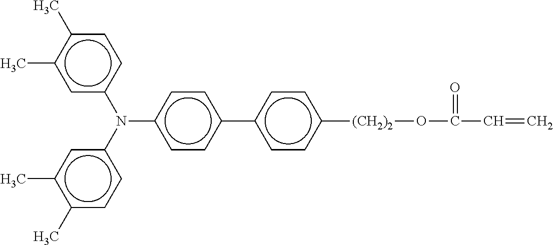 | | |
|---|---|---|---|
| No. 151 | 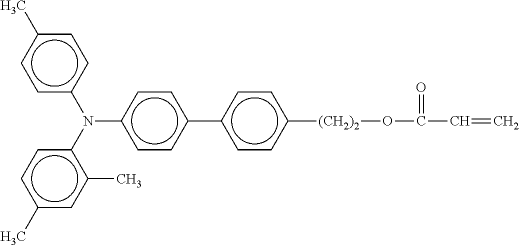 | | |
| No. 152 | 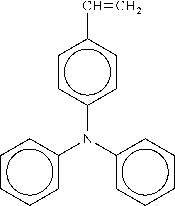 | No. 153 | 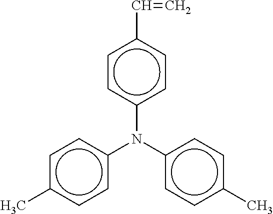 |
| No. 154 | 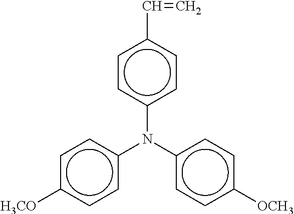 | No. 155 | 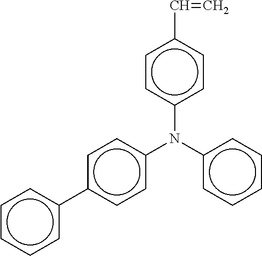 |
| No. 156 | 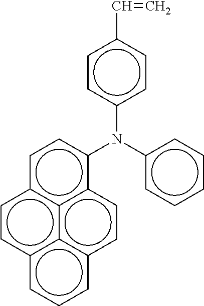 | No. 157 | 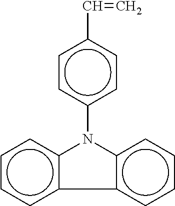 |

TABLE 39

| | |
|---|---|
| No. 158 | 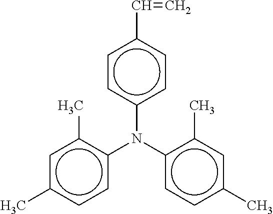 |
| No. 159 | 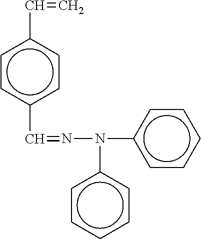 |
| No. 160 | 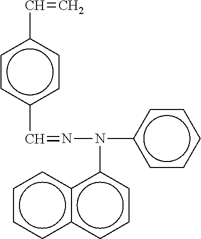 |
| No. 161 | 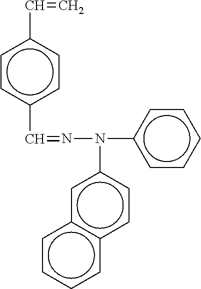 |
| No. 162 | 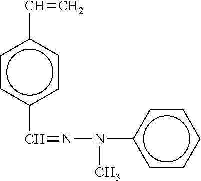 |
| No. 163 | 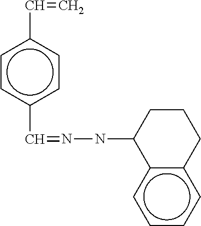 |
| No. 164 | 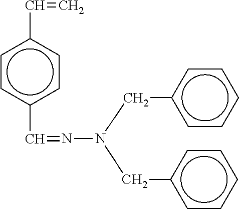 |
| No. 165 | 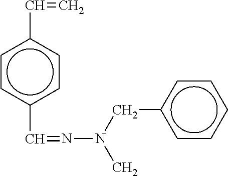 |
| No. 166 | 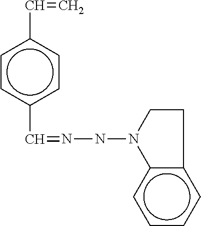 |
| No. 167 | 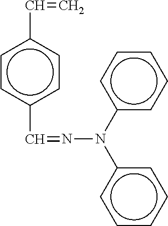 |

TABLE 40

| | |
|---|---|
| No. 168 | 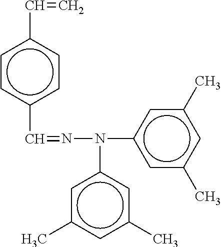 |
| No. 169 | 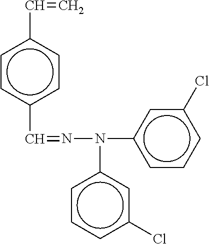 |

In addition, the radical polymerizable compound having one functional group with a charge transport structure preferably for use in the present disclosure imparts a charge transport power to the cross-linked surface layer and the content ratio of the radical polymerizable compound is from 20% to 80% by weight, and preferably from 35% to 65% by weight based on the total weight of the cross-linked surface layer. When the content of the radical polymerizable compound having a charge transport structure is excessively small, the charge transport power of the cross-linked surface layer tends not to be sustained, which leads to deterioration of the electric characteristics such as sensitivity and the residual voltage over repetitive use. When the content of the radical polymerizable monomer having a charge transport structure is excessively large, the content of the monomer having three functional groups without having a charge transport structure reduces. This easily leads to reduction of the cross-linking density, which prevents demonstration of a high abrasion resistance. Desired electrostatic characteristics and abrasion resistance vary depending on the process used. Therefore, it is difficult to jump to any conclusion but considering the balance of both, the range of from 35% to 65% by weight is most preferred.

Although a cross-linked surface formed by curing the radical polymerizable monomer having at least three functional groups without having a charge transport structure and the radical polymerizable compound having a charge transport structure is suitably used in the present disclosure, a radical polymerizable monomer having one or two functional groups, a functional monomer, and/or a radical polymerizable oligomer can be used in combination therewith to control the viscosity during coating, reduce the internal stress within the cross-linked surface layer, lower the surface energy, decrease the friction index, etc. Any known radical polymerizable monomers and oligomers can be used. Specific examples are as follows:

Specific examples of such radical monomers having one functional group include, but are not limited to, 2-ethyl hexyl acrylate, 2-hydroxy ethyl acrylate, 2-hydroxy propyl acrylate, tetrahydroflu frylacrylate, 2-ethylhexyl carbitol acrylate, 3-methoxy butyl acrylate, benzyl acrylate, cyclohexyl acrylate, isoamyl acrylate, isobutyl acrylate, methoxy triethylene glycol acrylate, phenoxy tetraethylene glycol acrylate, cetyl acrylate, isostearyl acrylate, stearyl acrylate, and a styrene monomer.

Specific examples of the radical polymerizable monomer having two functional groups include, but are not limited to, 1,3-butane diol acrylate, 1,4-butane diol acrylate, 1,4-butane diol dimethacrylate, 1,6-hexane diol diacrylate, 1,6-hexane diol dimethaacrylate, diethylene glycol diacrylate, neopentyl glycol diacrylate, bisphenol A-EO modified diacrylate, bisphenol F-EO modified diacrylate, and neopentyl glycol diacrylate.

Specific examples of such functional monomers include, but are not limited to, a substitution product of, for example, octafluoro pentyl acrylate, 2-perfluoro octyl ethyl acrylate, 2-perfluoro octyl ethyl methacrylate, and 2-perfluoroisononyl ethyl acrylate, in which a fluorine atom is substituted; and a vinyl monomer, an acrylate, or a methacrylate having a polysiloxane group such as acryloyl polydimethyl siloxane ethyl, methacryloyl polydimethyl siloxane ethyl, acryloyl polydimethyl siloxane propyl, acryloyl polydimethyl siloxane butyl, and diacryloyl polydimethyl siloxane diethyl having 20 to 70 repeating units described in unexamined published Japanese patent applications Nos. JP H05-60503-A and JP H06-45770-A.

Specific examples of the radical polymerizable oligomers include, but are not limited to, an epoxy acrylate based oligomer, a urethane acrylate based oligomer, and a polyester acrylate based oligomer. An excessive amount of the radical polymerizable monomer having one or two functional groups and a radical polymerizable oligomer tends to lead to a substantial decrease in the density of three-dimensional cross-linking in the cross-linked surface layer, which results in deterioration of the abrasion resistance thereof. Therefore, the content of these monomers and oligomers is not greater than 50 parts and preferably not greater than 30 parts based on 100 parts of a radical polymeric monomer having at least three functional groups.

As described above, a cross-linked surface formed by curing the radical polymerizable monomer having at least three functional groups without having a charge transport structure and the radical polymerizable compound having a charge transport structure is suitably used in the present disclosure. Optionally, a polymerization initiator can be used to form the cross-linked surface layer may contain to accelerate the curing reaction (cross-linking reaction).

Specific examples of thermal polymerization initiators include a peroxide based initiator such as 2,5-dimethyl'hexane-2,5-dihydroperoxide, dicumyl peroxide, benzoyl peroxide, t-butylcumyl peroxide, 2,5-dimethyl-2,5-di(peroxybenzoyl)hexine-3, di-t-butyl beroxide, t-butylhydro beroxide, cumenehydro beroxide, lauroyl peroxide, and 2,2-bis(4,4-di-t-butylperoxy cyclohexane)propane, and an azo based initiator such as azobis isobutyl nitrile, azobis cyalohexane carbonitrile, azobis iso methyl butyric acid, azobis isobutyl amidine hydrochloride, and 4,4′-azobis-4-cyano valeric acid.

Specific examples of photopolymerization initiators include, but are not limited to, an acetophenon based or ketal based photopolymerization initiators such as diethoxy acetophenone, 2,2-dimethoxy-1,2-diphenyl ethane-1-on, 1-hydroxy-cyclohexyl-phenyl-ketone, 4-(2-hydroxyethoxy)phenyl-(2-hydroxy-2-propyl)ketone, 2-benzyl-2-dimethylamino-1-(4-molpholinophenyl)butanone-1,2-hydroxy-2-methyl-1-phenyl propane-1-on, and 1-phenyl-1,2-propanedion-2-(o-ethoxycarbonyl)oxime; a benzoine ether based photopolymerization initiator such as benzoine, benzoine methyl ether, benzoine ethyl ether, benzoine isobutyl ether, and benzoine isopropyl ether; a benzophenone based photopolymerization initiator such as benzophenone, 4-hydroxy benzophenone, o-benzoyl methyl benzoate, 2-benzoyl naphthalene, 4-benzoyl biphenyl, 4-benzoyl phenyl ether, acrylizes benzophenone and 1,4-benzoyl benzene; a thioxanthone based photopolymerization initiator such as 2-isopropyl thioxanthone, 2-chlorothioxanthone, 2,4-dimethyl thioxanthone, 2,4-diethyl thioxanthone, and 2,4-dichloro thioxanthone; and other photopolymerization initiators such as ethyl anthraquinone, 2,4,6-trimethyl benzoyl diphenyl phosphine oxide, 2,4,6-trimethyl benzoyl phenyl ethoxy phosphine oxide, bis(2,4,6-trimethyl benzoyl)phenyl phosphine oxide, bis(2,4-dimethoxybenzoyl)-2,4,4-trimethyl pentyl phosphine oxide, a methylphenyl glyoxy ester, 9,10-phenanthrene, an acridine based compound, a triadine based compound and an imidazole based compound.

In addition, a compound having an acceleration effect on photopolymerization can be used alone or in combination with the photopolymerization initiator. Specific examples of such compounds include, but are not limited to, triethanol amine, methyl diethanol amine, 4-dimethyl amino ethyl benzoate, 4-dimethyl amino isoamyl benzoate, ethyl benzoate (2-dimethyl amino), and 4,4′-dimethyl amino benzophenone.

These polymerization initiators can be used alone or in combination. The content of such a polymerization initiator is from 0.5 to 40 parts by weight and preferably from 1 to 20 parts by weight based on 100 parts by weight of the compound having a radical polymerization property.

Moreover, the surface layer (cross-linked surface layer) of the present disclosure can be formed by a liquid application. To prepare such a liquid application, various kinds of additives such as plasticizers (to relax the internal stress and improve the attachability), leveling agents, and small molecular weight transport materials having no radical reaction property can be used in addition to the polymerizable compound having a charge transport structure (e.g., radical polymerizable compounds having one functional group with a charge transport structure and radical polymerizable monomers having at least three or more functional groups without a charge transport structure).

Known additives can be suitably used as these additives. A typical resin such as dibutylphthalate and dioctyl phthalate can be used as the plasticizer. The content ratio thereof is not greater than 20% by weight and preferably not greater than 10% based on the total solid portion of the liquid application.

Silicone oils such as dimethyl silicone oil, methyl phenyl silicone oil and a polymer or an oligomer having a perfluoroalkyl group in its side chain can be used as the leveling agent. The content ratio thereof is suitably not greater than 3% by weight based on the total solid portion of the liquid application.

As described above, the cross-linked surface layer formed by coating and curing a liquid application containing the radical polymerizable monomer having at least three functional groups with no charge transport structure and the radical polymerizable compound having a charge transport structure is suitably used in the present disclosure.

When a liquid radical polymerizable monomer is used in the liquid application, other components are possibly dissolved in the liquid followed by application. Optionally, the liquid application is diluted by a suitable solvent before coating.

Specific examples of such solvents include, but are not limited to, an alcohol such as methanol, ethanol, propanol and butanol; a ketone such as acetone, methyl ethyl ketone, methyl isobutyl ketone, and cycle hexanone; an ester such as ethyl acetate and butyl acetate; an ether such as tetrahydrofuranm dioxane and propyl ether; a halogen based solvent such as dichloromethane, dichloroethane, trichloroethane and chlorobenzene; an aromatic series based solvent such as benzene, toluene and xylene; and a cellosolve based solvent such as ethylene glycol monomethylether known as methyl cellosolve, ethylene glycol monoethyletherethyl known as ethyl cellosove, and ethylene glycol monoethylether acetate known as cellosolve acetate. These solvents can be used alone or in combination. The dilution ratio by using such a solvent is arbitrary and varies depending on the solubility of a composition, a coating method, and a target layer thickness. A dip coating method, a spray coating method, a bead coating method, a ring coating method, etc., can be used in application of the liquid application.

In the present disclosure, subsequent to application of a liquid of application, the cross-linked surface layer formed by curing upon application of an external optical energy. As optical energy, a UV irradiation light source such as a high pressure mercury lamp or a metal halide lamp having an emission wavelength mainly in the ultraviolet area is used. A visible light source can be selected according to the absorption wavelength of a radical polymerizable compound and a photopolymerization initiator. In addition, the cross-linking reaction by the radical polymerization is greatly affected by the temperature and the surface temperature of the film formed upon optical irradiation is preferably from 20° C. to 170° C. There is no specific limit to the selection of the surface temperature control device for the film. A method of control the surface temperature using a thermal medium is preferable.

Examples of the latent image bearing member using the cross-linked surface layer materials are described.

For example, when an acrylate monomer having three acryloyloxy groups is used as the radical polymerizable monomer having at least three functional groups with no charge transport structure and a triaryl amine compound having an acryloyloxy group is used as the radical polymerizable compound having one functional group with a charge transport structure, the content ratio of the acrylate monomer to the triaryl amine is 3/7 to 7/3. In addition, a polymerization initiator is added in an amount of 3 to 20% by weight based on the total amount of the acrylate compound followed by an addition of a solvent to prepare the liquid of application.

When a triaryl amine based donor is used as the charge transport material and a polycarbonate is used as a binder resin to form a charge transport layer provided under the cross-linked surface layer applied thereto by a spray method, it is preferred to use teterahydrofuran, 2-butanone, or ethyl acetate as the solvent mentioned above for the liquid application. Its content ratio is 3 to 10 times as much as the total weight of the acrylate compound. The thus cured and manufactured cross-linked surface layer is preferably insoluble in an organic solvent. A film that is not sufficiently cured is soluble in an organic solvent and has a thin cross-linking density, which leads to degradation of mechanical strength.

For example, the liquid of application prepared as described above is applied with, for example, a spray, on a latent image bearing member in which an undercoating layer, a charge generation layer and cured on application of light via drying by finger touch.

In the case of UV ray irradiation, a metal halide lamp, etc. is used with a preferable illuminance of from 50 to 1,000 mW/cm². For example, when a UV ray of 700 mW/cm² is used, all the surface of the drum is irradiated evenly for about two minutes while the drum is in rotation.

The surface temperature is controlled not to be extremely high by using a thermal medium. After completion of curing, the resultant is heated in a range of from 100° C. to 150° C. for 10 to 30 minutes to reduce the residual organic solvent before a latent image bearing member of the present disclosure is obtained.

In addition, it is preferable to extremely reduce the oxygen concentration in the atmosphere when heated or irradiated with UV ray to accelerate the curing reaction. In addition, although the surface is irradiated with UV ray while in rotation, it is more preferable to reduce the oxygen density in the atmosphere for any portion regardless of whether or not it receives the UV ray.

Therefore, the oxygen inhibition during the radical polymerization reaction is extremely reduced so that a surface layer having a high cross-linking density can be obtained.

Furthermore, when a spray coating is used, it is suitable to conduct application in the atmosphere where the oxygen density is reduced by filling nitrogen in the application facility, or dry by finger touch.

The cross-linked surface layer of the latent image bearing member in the image forming apparatus of the present disclosure preferably has a thickness of from 1 to 30 μm, more preferably from 2 to 20 μm, and furthermore preferably from 4 to 15 μm. When the surface layer is too thin and carriers are attached and dent therein, the durability of the cross-linked surface layer is not easily secured. By contrast, a surface layer that is too thick tends to cause a problem such as a rise in the residual voltage. Therefore, it is preferable to form a cross-linked surface layer having a suitable thickness by which an allowance for abrasion and scar is secured and a residual voltage is reduced.

It is preferable to contain filler particulates in the surface layer. The surface layer serves as a protection layer. By dispersing the filler particulates in the surface layer, the abrasion resistance is extremely improved, thereby making the working life of the latent image bearing member longer.

Furthermore, fine convexo-concave portions are formed on the surface by the filler particles, thereby improving the applicability of a lubricant particularly formed of an aliphatic acid salt such as zinc stearate and calcium stearate, resulting in amelioratinon of the cleaning property and the transfer property.

Specific examples of the filler particulates are as follows:

Specific examples of organic filler materials include, but are not limited to, fluorine resin powder such as polytetrafluoroethylene, silicone resin powder, and a-carbon powder.

Specific examples of inorganic filler materials include, but are not limited to, powder of metal such as copper, tin, aluminum, and indium, metal oxides such as silicon oxide, tin oxide, zinc oxide, titanium oxide, indium oxide, antimony oxide, and bismuth oxide, and potassium titanate.

Among these, using the inorganic material is advantageous in terms of the hardness of the filler. In particular, the metal oxide is suitably used because it has little side effect on the electrostatic characteristics of the latent image bearing member. Furthermore, silicon oxide, aluminum oxide, and titanium are preferably used. In addition, particulates pf colloidal silica and colloidal aluminum are suitably used.

The primary particle diameter of the filler particulates is preferably from 0.01 to 0.5 μm in terms of the optical transmittance and abrasion resistance. A primary particle diameter of the filler particulates is too small tends to degrade the abrasion resistance and the dispersion property. A primary particle diameter of the filler particulates is too large tends to accelerate the sedimentation property of the filler in the liquid dispersion (application) or cause toner filming on the surface of the latent image bearing member in an image forming apparatus.

A high concentration of the filler material in the surface layer is preferable because the abrasion resistance increases. However, a concentration that is too high may cause side effects such as an increase of the residual voltage and reduction of the optical transmittance of the writing light for the protection layer.

Therefore, the concentration is from 5 to 50% by weight and preferably not greater than about 30% by weight.

Furthermore, it is preferable to use fillers surface-treated by a surface treatment agent in terms of the dispersion property of the filler. The degradation of the dispersion property of the filler does not only have adverse impacts on the electrostatic characteristics such as a rise in the residual voltage but also causes reduction of the transparency of the film and film deficiency. This may prevent improvement of the durability and the image quality.

Any known surface treatment agent can be used and surface treatment agents that maintain the insulation property of the filler.

For example, silane coupling agents can be used in combination with these surface treatment agents. Other specific examples of the surface treatment agents include Al₂O₃, TiO₂, ZrO₂, silicon and aluminum stearate. Mixing treatment thereof is more preferred in terms of dispersability of a filler and anti-image blurring.

The treatment by a silane coupling agent has an adverse impact in terms of image blurring. However, the mixing treatment of the silane coupling with the above-mentioned surface treatment agents may restrain the adverse impact. The content of the surface treatment agents mentioned above depends on the average primary particle diameter of the filler used but is preferably from 3 to 30 parts by weight and more preferably from 5 to 20 parts by weight. An excessively small amount of the surface treatment agent tends to have an adverse impact on the dispersion effect of the filler. By contrast, an excessively large amount thereof may cause a significant rise in the residual voltage. These can be used alone or in combination.

Specific examples of the binder resins for use in the surface layer (protection layer) in which the filler particulates are dispersed include, but are not limited to, polycarbonate resins, polyester resins, methacrylic resins, acrylic resins, polyethylene resins, polyvinyl chloride resins, polyvinyl acetate resins, polystyrene resins, phenol resins, epoxy resins, polyurethane resins, polyvinylidene chloride resins, alkyd resins, silicone resins, polyvinylcarbazole resins, polyvinyl butyral resins, polyvinyl formal resins, polyacrylate resins, polyacryl amide resins and phenoxy resins. These can be used alone or in combination.

In particular, it is preferable to use a protection layer having a three dimensional network in which the inorganic filler particulates of a metal oxide is dispersed in the cross-linked surface layer using the radical polymerizable compound and the radical polymerizable compound having a charge transport structure to extremely improve the abrasion resistance.

Photosensitive Layer

Next, the laminate type photosensitive layer and the single layer type photosensitive layer that form the latent image bearing member for use in the present invention are described.

Laminate Type Photosensitive Layer

Charge Generation Layer

The charge generation layer contains at least a charge generation material and other optional materials such as a binder resin.

There is no specific limit to the selection of the charge generation material. Either one of an inorganic material and an organic material is suitably used.

There is no specific limit to the selection of the inorganic materials. Specific examples thereof include, but are not limited to, crystal selenium, amorphous-selenium, selenium-tellurium, selenium-tellurium-halogen, and selenium-arsenic compounds.

There is no specific limit to the selection of the organic materials. Any known material can be suitably selected to purpose. Specific examples thereof include phthalocyanine based pigments such as metal phthalocyanine and non-metal phthalocyanine, azulenium salt pigments, methine squarate pigments, azo pigments having a carbazole skeleton, azo pigments having a triphenyl amine skeleton, azo pigments having a diphenyl amine skeleton, azo pigments having a dibenzothiophen skeleton, azo pigments having a fluorenone skeleton, azo pigments having an oxadiazole skeleton, azo pigments having a bisstilbene skeleton, azo pigments having a distyryl oxadiazole skeleton, azo pigments having a distyryl carbazole skeleton, perylene based pigments, anthraquinone based or polycyclic quinone based pigments, quinone imine based pigments, diphenyl methane or triphenyl methane based pigments, benzoquinone or naphthoquinone based pigments, cyanine and azomethine based pigments, indigoid based pigments, and bisbenzimidazole based pigments. These can be used alone or in combination.

There is no specific limit to the selection of the binder resin for use in the charge generation layer. Specific examples of the binder resin include, but are not limited to, polyamides, polyurethanes, epoxy resins, polyketones, polycarbonates, silicone resins, acrylic resins, polyvinylbutyrals, polyvinylformals, polyvinylketones, polystyrenes, poly-N-vinylcarbazoles, and polyacrylamides. These can be used alone or in combination.

A charge transport material can be optionally added. In addition, other than the binder resins mentioned above, a charge transport polymer can be also added.

As a method of forming the charge generation layer, vacuum thin layer forming methods and casting methods from a solution dispersion system can be specified.

In the vacuum thin layer forming methods, for example, there are glow discharging polymerization methods, vacuum deposition methods, chemical vacuum deposition (CVD) methods, sputtering methods, reactive sputtering methods, ion plating methods and accelerated ion injection methods. In these vacuum thin layer forming methods, the inorganic based materials and the organic based materials specified above can be suitably used.

To form a charge generation layer by the casting method, it is possible to use a typical method such as a dip coating method, a spray coating method and a beat coating method.

Specific examples of organic solvents for use in forming a liquid application for the charge generation layer include acetone, methyl ethylketone, methyl itopropylketone, cyclohexanone, benzene, toluene, xylene, chloroform, dichloromethane, dichloroethane, dichloropropane, trichloroethane, trichloroethylene, tetrachloroethane, tetrahydrofuran, dioxolane, dioxane, methanol, ethanol, isopropylalcohol, butanol, ethyl acetate, butyl acetate, dimethyl sulfoxide, methyl Cellosolve®, ethyl Cellosolve®, and propyl Cellosolve®. These can be used alone or in combination. Among these, tetrahydrofuran, methyl ethylketone, dichloromethane, methanol and ethanol, which have a boiling point of from 40° C. to 80° C., are particularly preferred because drying after their coating is easy.

The liquid application for forming the charge generation layer is prepared by dispersing and dissolving the charge generating material and the binder resin in the organic solvent. As a method of dispersing an organic pigment in an organic solvent, there are a dispersion method using a dispersion medium such as a ball mill, a bead mill, a sand mill and a vibration mill, and a high speed liquid collision dispersion method.

The electrophotographic characteristics, especially photosensitivity, vary depending on the thickness of the charge generation layer. In general, as the layer thickens, the photosensitivity becomes high. Therefore, it is preferred to set the layer thickness of the charge generation layer in a suitable range according to the specification of a desired image forming apparatus. To obtain the sensitivity suitable as an image bearing member, the layer thickness thereof is preferably from 0.01 μm to 5 μm and more preferably from 0.05 μm to 2 μm.

Charge Transport Layer

In addition, to achieve the objective of holding the charge, the electric resistance is required to be high for the charge transport layer of the latent image bearing member. Furthermore, to achieve the objective of obtaining a high surface voltage by the held charge, a small dielectric constant and good charge mobility are preferable.

Specific examples of the positive hole carrier transport materials (electron donating materials) include oxazole derivatives, oxadiazole derivatives, imidazole derivatives, triphenyl amine derivatives, 9-(p-diethylaminostyryl anthracene), 1,1-bis-(4-dibenzyl aminophenyl)propane, styrylanthracene, styrylpyrazoline, phenylhydrazones, α-phenylstilbene derivatives, thiazole derivatives, triazole derivatives, phenazine derivatives, acridine derivatives, benzfuran derivatives, benzimidazole derivatives and thiophen derivatives. These can be used alone or in combination.

Specific examples of the charge transport polymers include compounds having the following structure.

(a) Polymer Having Carbazole Ring

Specific examples include, but are not limited to, poly-N-vinylcarbazole, and the compounds described in JPs S54-9632-A, S54-11737-A, H04-175337-A, H04-183719-A and H06-234841-A.

(b) Polymer Having Hydrazone Structure

Specific examples include, but are not limited to, the polymers described in JPs S57-78402-A, S61-20953-A, S61-296358-A, H01-134456-A, H01-179164-A, H03-180851-A, H03-180852-A, H03-50555-A, H05-310904-A and H06-234840-A.

(c) Polysilane Polymer

Specific examples include, but are not limited to, polymers described in JPs S63-285552-A, H01-88461-A, H04-264130-A, H04-264131-A, H04-264132-A, H04-264133-A and H04-289867-A.

(d) Polymer Having Triarylamine Structure

Specific examples include, but are not limited to, N,N,bis(4-methylphenyl)-4-aminopolystyrene, polymers described in JPs H01-134457-A, H02-282264-A, H02-304456-A, H04-133065-A, H04-133066-A, H05-40350-A, and H05-202135-A.

(e) Other Polymers

Specific examples include, but are not limited to, a condensation polymerized formaldehyde compound of nitropropylene, and polymers described in JPs S51-73888, S56-150749-A, H06-234836 and H06-234837.

In addition, there are other examples of the charge transport polymers, which are, for example, polycarbonate resins having a triaryl amine structure, polyurethane resins having a triaryl amine structure, polyester resins having a triaryl amine structure and polyether resins having a triaryl amine structure.

Specific examples thereof include, but are not limited to, polymers described in JPs S64-1728-A, S64-13061-A, S64-19049-A, H04-11627-A, H04-225014-A, H04-230767-A, H04-320420-A, H05-232727-A, H07-56374-A, H09-127713-A, H09-222740-A, H09-265197-A, H09-211877-A and H09-304956-A.

Other than the polymers specified above, copolymers, block polymers, graft polymers and star polymers with a known monomer, and cross-linking polymers having the electron donating groups described in JP H03-109406-A can be used as the polymers having an electron donating group.

Specific examples of the binder resins for use in the charge transport layer include, but are not limited to, polycarbonate resins, polyester resins, methacrylic resins, acrylic resins, polyethylene resins, polyvinyl chloride resins, polyvinyl acetate resins, polystyrene resins, phenol resins, epoxy resins, polyurethane resins, polyvinylidene chloride resins, alkyd resins, silicone resins, polyvinylcarbazole resins, polyvinyl butyral resins, polyvinyl formal resins, polyacrylate resins, polyacrylic amide resins and phenoxy resins. These can be used alone or in combination.

The charge transport layer can also contain a copolymer of a cross-linking binder resin and a cross-linking charge transport material.

The charge transport layer can be formed by dissolving or dispersing these charge transport materials and the binder resins in a suitable solvent followed by coating and drying. The charge transport layer can optionally contain additives such as a plasticizing agent, an anti-oxidizing agent and a leveling agent in a suitable amount if desired.

The layer thickness of the charge transport layer preferably ranges from 5 to 100 μm. The layer thickness of a charge transport layer has been thinned to satisfy the demand for improving the quality of images in recent years. It is preferred that the charge transport layer has a thickness that ranges from 5 to 30 μm for a high definition of 1,200 dpi or higher.

Next, the photosensitive layer is described.

### Single Layered Photosensitive Layer

The exemplary single layer photosensitive layer mentioned above contains a charge generating material, a charge transport material, a binder resin and other optional components.

A single layer photosensitive layer can be formed by a casting method. Such a single-layered photosensitive layer can be formed by dissolving or dispersing a charge generation material, a binder resin, and a charge transport material in a suitable solvent followed by coating and drying. A plasticizer can be optionally contained in such a single-layered photosensitive layer.

The single-layered photosensitive layer preferably has a thickness of from 5 μm to 10 μm and more preferably from 5 μm to 50 μm. When the layer thickness is too thin, the charging property tends to deteriorate. When the layer thickness is too thick, the sensitivity may deteriorate.

Substrate

There is no specific limit to the selection of the substrate of the latent image bearing member in the present invention. Any known material can be suitably used.

For example, an electroconductive body or an electroconductively-treated insulating body are suitably used. Specific examples thereof include: metals such as Al, Ni, Fe, Cu, Au, and alloys thereof; materials in which a thin layer of a metal such as Al, Ag and Au; or an electroconductive material such as In₂O₃ and SnO₂ is formed on an insulating substrate such as polyester, polycarbonate, polyimide and glass; resin substrates to which electroconductivity is imparted by uniformly dispersing carbon black, graphite, metal powder formed of Al, Cu and Ni and electroconductive glass powder in a resin to impart electrocondcutivity; and electroconductivley-treated paper.

There is no specific limit to the form and the size of the substrate. A plate form, a drum form or a belt form substrate can be used. When a substrate having a belt form is used, devices such as a driving roller and a driven roller are desired to be provided. Therefore, the apparatus using such a substrate is increased in size, but there is a merit in that the layout latitude increases. However, when a protective layer is formed, the flexibility thereof is insufficient, which leads to the possibility of cracking on the surface. This may cause the background fouling to appear granular. Therefore, a drum having a high hardness is preferable as the substrate.

Undercoating Layer

An undercoating layer can be optionally provided between the substrate and the photosensitive layer. The undercoating layer is provided to improve the adhesive property, prevent the occurrence of moiré, improve the coating property of a layer provided thereon, reduce the residual voltage, etc.

Typically, such an undercoating layer is mainly made of a resin. Considering that a photosensitive layer is applied to such an undercoating layer (i.e., resin) in a form of solvent, the resin is preferably hardly soluble in a known organic solvent. Specific examples of such resins include, but are not limited to, water-soluble resins such as polyvinyl alcohol, casein and sodium polyacrylate, alcohol-soluble resins such as copolymerized nylon, and methoxymethylated nylon, curing resins forming three-dimensional structure such as polyurethane, melamine resins, alkyd-melamine resins and epoxy resins. In addition, fine powder of metal oxides such as titanium oxide, silica, alumina, zirconium oxide, tin oxide and indium oxide, metal sulfides and metal nitrides can be optionally added. Such an undercoating layer can be formed by a typical method using a suitable solvent.

An undercoating layer can be formed by anodizing a metal oxide layer of Al₂O₃ formed by a sol-gel process, etc. or by coating organic compounds such as a polyparaxylyene (parylene) or an inorganic compound such as SnO₂, TiO₂, ITO, and CeO₂ using a silane coupling agent, a titanium coupling agent, and a chromium coupling agent by a vacuum thin layer forming method.

There is no specific limit to the layer thickness of such an undercoating layer. The layer thickness thereof can be determined to a suitable purpose and preferably ranges from 0.1 μm to 10 μm, and more preferably ranges from 1 μm to 5 μm.

Image Forming Apparatus

The image forming apparatus of the present disclosure has a latent image bearing member to bear a latent electrostatic image, a charger to charge the surface of the latent image bearing member, a development device to develop the latent electrostatic image with toner to obtain a toner image, a transfer device to transfer the toner image formed on the latent image bearing member to a transfer body, and a lubricant applicator to apply the lubricant to the surface of the latent image bearing member. The lubricant applicator accommodates a lubricant containing a lubricant material and at least one of the diamine compounds represented by the following chemical structures 1, 2, and 3 and applies the lubricant to the surface of the latent image bearing member.

The image forming apparatus of the present disclosure optionally has other devices such as a fixing device, a discharger, a cleaning device, a recycling device, and a control device.

Below are descriptions about the latent image forming process (latent electrostatic image forming process) and the latent image forming device (latent electrostatic image forming device), the development process and the development device, the toner for use in forming toner images, the transfer process and the transfer device, a fixing process and the fixing device, the lubricant applying process (lubricant supplying process) and the lubricant applying device (lubricant supplying device), the discharging process and the discharger, the cleaning process and the cleaning device, and the control process and the control device.

Latent Image Forming Process and Device

The latent image forming process (latent electrostatic image forming process) is a process of forming a latent electrostatic image on the latent image bearing member accommodated in the image forming apparatus of the present disclosure.

The latent electrostatic image is formed by, for example, uniformly charging the surface of the latent image bearing member followed by irradiation according to data information with the latent image forming device.

The latent image forming device includes, for example, a charger that uniformly charges the surface of the latent image bearing member, and an irradiation device that irradiates the surface of the latent image bearing member according to data information.

Charging is conducted by applying a voltage to the surface of the latent image bearing member using the charger.

There is no specific limit to the selection of the charing device and any known device can be suitably used. Specific examples thereof include, but are not limited to, a known contact type charger that includes an electroconductive or semiconductive roller, brush, film, and a rubber blade, and a non-contact type charing device using corona discharging such as corotron, and scorotron.

The charger may employ any form other than the roller, for example, a magnetic brush and a fur brush and can be selected according to the specification or form of an image forming apparatus. When a magnetic brush is used, ferrite particles such as Zn—Cu ferrite is used as the charging member to form the magnetic brush together with a non-magnetic electroconductive sleeve to support the charging member, and a magnet roll provided inside the electroconductive sleeve. When a brush is used, a fur brush electroconductively treated with carbon, copper sulfide, metal or metal oxide is rolled on or attached to metal or electroconductively treated metal core to function as the charger.

The charger is not limited to the contact type charger described above, but using such a contact type charger is preferable because an image forming apparatus obtained produces a reduced amount of ozone.

It is preferable to apply a direct current or a voltage obtained by overlapping an alternate alternate current voltage to a direct current voltage to the surface of the latent image bearing member by the charger arranged in contact with or in the vicinity of the latent image bearing member. It is preferable to apply a direct current or a voltage obtained by overlapping an alternate alternate current voltage to a direct current voltage to the surface of the latent image bearing member by the charger arranged in contact with or in the vicinity of the latent image bearing member.

Irradiation is conducted by irradiating the surface of the latent image bearing member according to data information using the irradiation device.

There is no specific limit to the selection of the irradiating device as long as the irradiation device irradiates the surface of the latent image bearing member charged by an charger according to data information. Specific examples thereof include, but are not limited to, various kinds of irradiation devices such as photocopying optical systems, rod-lens array systems, laser optical systems, and liquid crystal shutter optical systems.

Embodiments of the present invention can employ a dorsal irradiation system in which the latent image bearing member is irradiated according to data information from the rear side thereof.

Development Process and Development Device

The development process mentioned above is a process of developing and visualizing the latent electrostatic image mentioned above with a toner or a development agent to obtain a visual (toner) image.

The visual image is formed by, for example, developing the latent electrostatic image with the toner or the development agent by the development device.

The development device preferably has a supplying device to supply carriers or a two-component development agent to the inside of the development device and a discharger to discharge the carriers or the two-component development agent accommodated in the development device to the outside thereof.

Any development device that develops the latent electrostatic image with the toner or the development agent can be suitably selected for used. For example, a development device is suitable which includes a development unit that accommodates the toner or the development agent and provides the toner or the development agent to the latent electrostatic image in a contact or non-contact manner.

The development unit employs a dry or wet development system, and a monochrome development unit or a full color development unit. For example, a development unit including a stirrer that abrasively stirs the toner or the development agent and the rotary magnet roller is suitable.

In the development unit, for example, the toner and the carrier are mixed and stirred to frictionally charge the toner. The charged toner is held in a filament manner on the surface of the magnet roller in rotation to form a magnet brush. Since the magnet roller is provided in the vicinity of the latent image bearing member, part of the toner forming the magnet brush formed on the surface of the magnet roller is electrically attracted to the surface of the latent image bearing member. AS a result, the latent electrostatic image formed in the irradiation process is developed with the toner so that the visual image by the toner is formed on the surface of the latent image bearing member.

The development agent accommodated in the development unit includes the toner. The two-component development agent containing the toner and the carrier is preferably used.

Toner Used to Form Toner Image

Any toner can be used to form the toner image. That is, the toner contains a binder resin, a coloring agent, and an externally additive, and optional agents such as a releasing agent and a charge control agent.

Transfer Process and Transfer Device

The transfer process is a process of transferring the visual image to a transfer medium (recording medium). Preferably, the toner image is primarily transferred to an intermediate transfer body followed by a secondary transfer of the visual image to a recording medium. It is more preferable that the transfer process includes a primary transfer process in which an overlapped complex transfer toner image is formed from multiple color toner images on an intermediate transfer body and a secondary transfer process that transfers the complex transfer image to a recording medium at once.

The visual image is transferred by, for example, charging the latent image bearing member using a transfer charging unit in the transfer device. The transfer device preferably includes a primary transfer device to form the complex transfer image onto the intermediate transfer body by transferring the visual image and a secondary transfer device to transfer the complex transfer image to the recording medium.

There is no specific limit to the selection of the intermediate transfer body. Any known transfer body such as an intermediate transfer belt can be suitably selected and used.

The transfer device (the primary transfer device and the secondary transfer device) preferably has a transfer unit that peels off and charges the visual image formed on the latent image bearing member onto the side of the recording medium. One or more transfer devices can be provided. Specific examples of the transfer device include, but are not limited to, a corona transfer device using corona discharging, a transfer belt, a transfer belt, a transfer roller, a pressure transfer roller and an adhesive transfer device.

A typical example of the recording medium is plain paper but any paper to which a non-fixed image after development is transferred can be suitably used. PET base for an overhead projector can be also used.

Fixing Process and Fixing Device

The fixing process is a process in which the visual image transferred to the recording medium is fixed by a fixing device. Fixing can be performed every time each color toner image is transferred or at once for a multi-color overlapped image.

Any fixing device can be suitably selected and a device having a fixing member and a heating source to heat the fixing member is used.

The fixing member preferably has a combination of an endless belt and a roller and a roller and a roller. The combination of a belt and a roller is preferable because it is of a small thermal heat capacity, a short warm-up time, energy saving, and a wide fixing area.

Lubricant Supply Process and Lubricant Supply Device

In the lubricant supply process (lubricant providing process), the lubricant supply device (lubricant providing device) supplies and applies a lubricant to the latent image bearing member to reduce the friction coefficient between the cleaning blade and the surface of the latent image bearing member for an extended period of time. Due to the lubricant of the present disclosure being applied to the surface of the latent image bearing member, removing spherical toner which is difficult to remove is facilitated and problems such as squeaky noise of a blade and abrasion of a blade edge that tend to occur when the latent image bearing member frictionally slides with the cleaning blade can be dissolved. Furthermore, the releasing property of the toner is improved, thereby reducing the production of deficient images having hollow portions.

The lubricant for use in the present disclosure contains the lubricant material and at least one of the diamine compounds represented by the Chemical structures 1, 2, and 3.

Discharging Process and Discharger

The discharging process mentioned above is a process in which the latent image bearing member mentioned above is discharged by application of a discharging bias or irradiation of discharging light beams and is suitably conducted by a discharger.

There is no specific limit to the discharger as long as the surface charge on the latent image bearing member can be removed. For example, a discharger that applies a discharging bias or a discharging lamp is suitably used.

Cleaning Process and Cleaning Device

The cleaning process is a process of removing toner remaining on the surface of the latent image bearing member and can be suitably conducted by a cleaning device.

Any known cleaning device that can remove the toner remaining on the surface of the latent image bearing member can be suitably selected and used. For example, a magnetic brush cleaner, an electrostatic brush cleaner, a blade cleaner, a brush cleaner, and a web cleaner can be preferably used.

Recycling Process and Recycling Device

The recycling process is a process in which the color toner removed in the cleaning process mentioned above is returned to the development device for recycle use. This recycling can be suitably conducted by a recycling device. There is no specific limit to the recycling device and any known transfer device, etc., can be used.

Control Process and Control Device

The control process mentioned above is a process of controlling each process and the control can be suitably performed by a control device.

There is no specific limit to the control device as long as the device can control the behavior of each device. Any control device can be suitably selected and used. For example, devices such as a sequencer and a computer can be used.

The image forming apparatus of the present invention is described with reference to accompanying drawings.

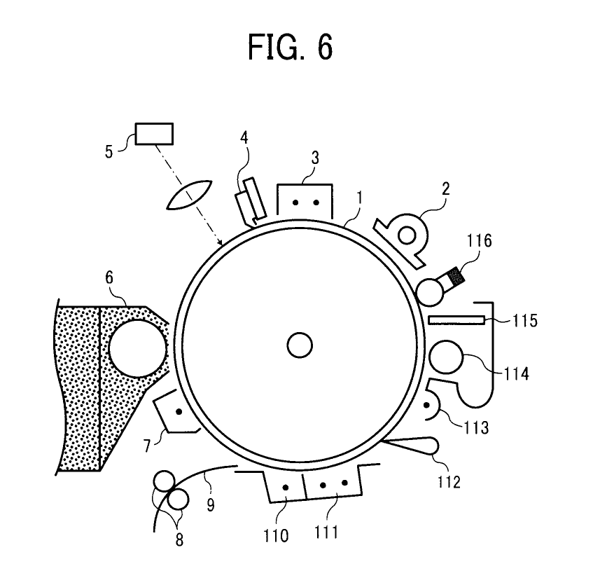

FIG. 6 is a schematic diagram illustrating an example of the image forming apparatus of the present invention. The image forming apparatus of FIG. 6 is an image forming apparatus having a latent image bearing member 1 having a drum form, a charger 3, a pre-transfer charger 7, a transfer charger 11, a separation charger 110, and a pre-cleaning charger 113.

The form of the latent image bearing member 1 is not limited to a drum. For example, a latent image bearing member having a sheet form or an endless belt form is suitably used. In addition, as the charger, a corotoron, scorotoron, a solid state charger, can be used. A known charging roller can be used provided in contact with or in the vicinity of the latent image bearing member by providing a gap tape or a step at the end of the latent image bearing member.

As the transfer device, the charger described above can be suitably used. A combinational use of a transfer charger and a separation charger as illustrated in FIG. 6 is suitable.

In addition, any known luminescent material such as a fluorescent lamp, a tungsten lamp, a halogen lamp, a mercury lamp, a sodium lamp, a luminescent diode (LED), a semiconductor diode (TED), and electroluminescence (EL) can be suitably used as the light source for an image irradiation portion 5 and a discharging lamp 2. Various kinds of optical filters, for example, a sharp cut filter, a band-pass filter, a near infrared filter, a dichroic filter, a coherent filter and a color conversion filter, can be used in combination with these light sources to irradiate the latent image bearing member with light having only a desired wavelength.

These light sources can be used in processes such as a transfer process using optical irradiation in combination, a discharging process, a cleaning process, or a pre-irradiation to irradiate the latent image bearing member 10 in addition to the processes illustrated in FIG. 6.

The toner image developed on the latent image bearing member 1 by a development unit 6 is transferred to a recording medium (transfer paper) 9. However, some toner is un-transferred and remains on the latent image bearing member 1. If the next image forming process starts without removing such residual toner, poor cleaning performance and trouble occurs when a latent image is formed. Therefore, a cleaning device is typically used to remove the residual toner. At least one of a cleaning brush 114 and a cleaning blade 115 is used as the cleaning device. Any known cleaning brush such as a fur brush, and a magfur brush can be used. The numbers “4”, “8”, and “112” represent an eraser, a registration roller, and a separation claw, respectively.

The cleaning blade 115 is formed by an elastic material having a low friction index such as urethane resin, silicone resin, fluorine resin, urethane elastomer, silicone elastomer, and fluorine elastomer. For the cleaning blade 115, thermocuring urethane resin is preferable and urethane elastomer is particularly preferable in terms of abrasion resistance, ozone resistance and contamination resistance. Elastomer includes rubber. The cleaning blade 115 having a hardness (JIS-A) of from 65 to 85 degree is preferable. In addition, the cleaning blade 115 preferably has a thickness of from 0.8 to 3.0 mm and a protrusion amount of from 3 to 15 mm. Furthermore, other conditions such as contact pressure, contact angle and the amount of dent can be suitably determined.

The cleaning device in contact with such a latent image bearing member has a high toner removing property but naturally provides mechanical hazard to the latent image bearing member, thereby causing abrasion of the surface layer thereof. The latent image bearing member preferably used in the present disclosure has a cross-liked surface layer having an extremely high abrasion resistance. Therefore, quality images are stably produced even when a cleaning device directly in contact with the surface is used.

The image forming apparatus of the present disclosure includes a lubricant supplying unit 116 that supplies and applies lubricant to the surface of the latent image bearing member. Particularly, spherical toner has been widely used in recent years because it is advantageous for improvement of the quality of images. However, such removing spherical toner on the latent image bearing member is known to be relatively difficult in comparison with the typical pulverization toner. Therefore, measures are taken such as increasing the contact pressure of the cleaning blade or using a urethane rubber blade having a high hardness.

However, such measures increase the hazard to the surface of the latent image bearing member with which the blade contacts. In fact, it is found that the abrasion amount of the surface of the latent image bearing member tends to increase when the spherical toner is used. The latent image bearing member preferably used in the present disclosure has an extremely high abrasion resistance, the cross-linked surface layer is hardly abraded even under the condition of a great hazard. However, problems such as squeaky noise of the blade and abrasion of the edge of the blade tend to occur due to the high friction index between the blade and the surface.

Since the image forming apparatus of the present disclosure includes the lubricant supplying device that supplies and applies a lubricant to the surface of the latent image bearing member, the friction coefficient of the surface against the cleaning blade is reduced for an extended period of time and thus the problems described above are dissolved.

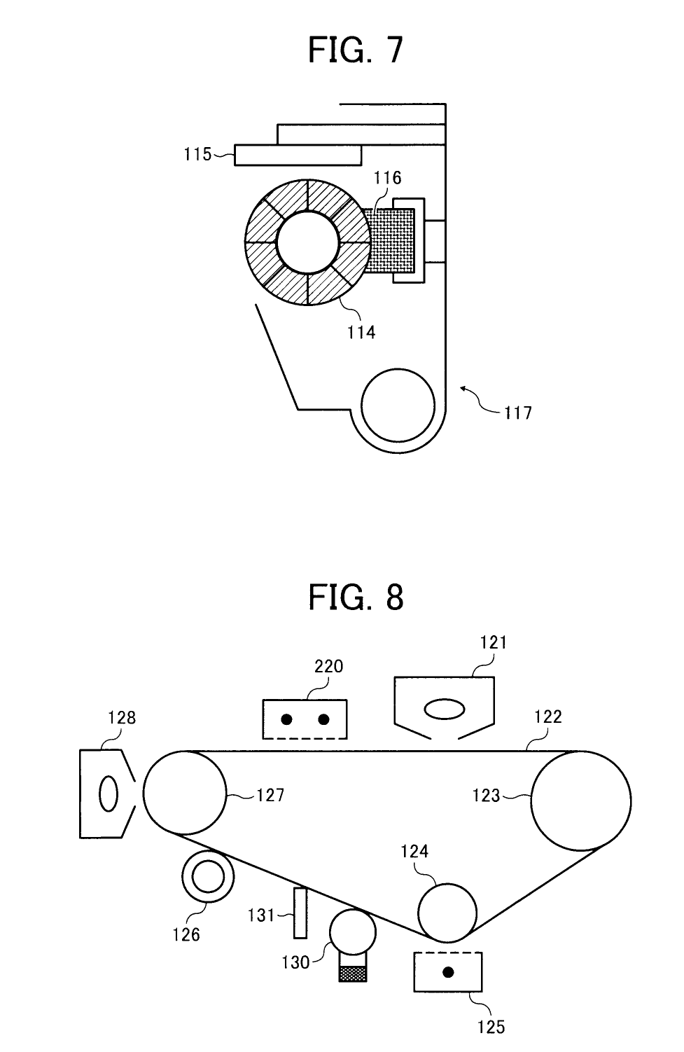

FIG. 7 is a diagram illustrating another example of the lubricant supplying device.

In FIG. 7, the lubricant supplying device has a structure formed of a cleaning brush 114 against which a solidified bar-like lubricant 116 is pressed. When the cleaning brush 114 rotates, the lubricant described above is scraped by the cleaning brush 114 and the lubricant attached to the brush 114 is applied to the surface of the latent image bearing member. In FIG. 7, the number “115” represents a cleaning blade.

As illustrated in FIG. 7, by providing the lubricant to a cleaning unit 117, the layout designing around the drum becomes easy and the mechanism is simplified. However, this mechanism has problems such that a great amount of the lubricant is mixed with the toner so that recycling the toner is difficult or the cleaning efficiency of the brush deteriorates. An application unit (not shown) having a lubricant supplying device can be provided separately from the cleaning unit to dissolve the problems. The application unit is preferably provided on the downstream side of the cleaning unit. Furthermore, the application units can be provided at multiple places and operated sequentially or at the same time. Therefore, the application efficiency of the lubricant is improved and the amount of consumption is controlled.

FIG. 8 is a schematic diagram illustrating another process example of the image forming apparatus of the present disclosure. In FIG. 8, a latent image bearing member 122 is driven by a driving roller 123 to repeatedly conduct charging by a charger 129, irradiation by an image irradiation light source 121, development (not shown), transfer by a transfer charger 125, lubricant application by a lubricant application unit 130, uniform application of the lubricant by a lubricant uniforming blade 131, cleaning by a cleaning brush 126, and discharging by a discharging light source 127. In FIG. 8, the numbers “124” and “127” represent a transfer roller and a driven roller, respectively.

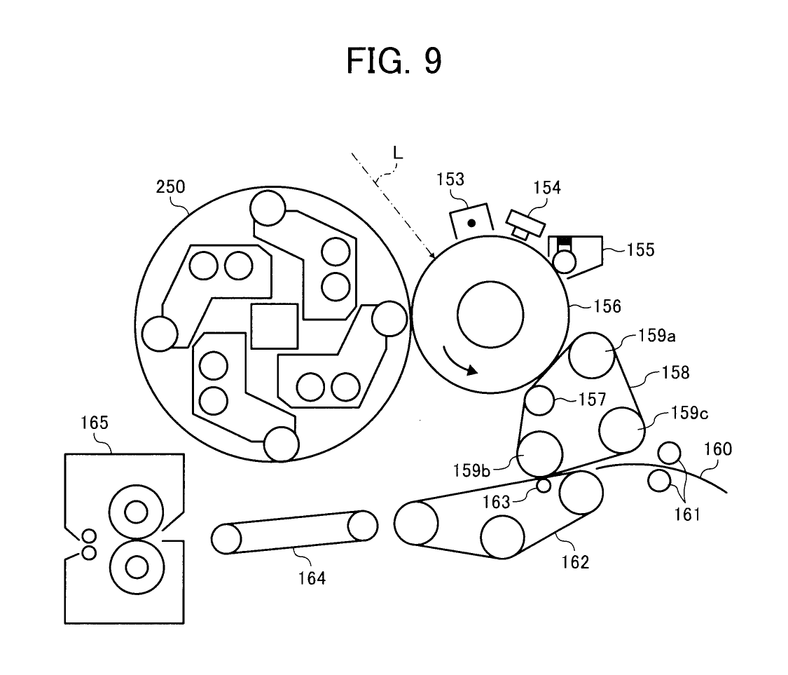

FIG. 9 is a schematic diagram illustrating an example of the full color image forming apparatus of the present disclosure. In FIG. 9, while a latent image bearing member drum 156 is rotary driven counterclockwise, the surface is uniformly charged by a charger 153 such as a corotron, or a scrotron, and then bears a latent electrostatic image upon scanning of a laser beam L emitted from a laser optical device (not shown). This scanning is conducted according to image information dissembled into single color information of yellow, magenta, cyan and black. Therefore, latent electrostatic images of yellow, magenta, cyan and black are formed on the latent image bearing member drum 156.

On the left side of the latent image bearing member drum 156 in FIG. 9, a revolver development unit 250 is provided. This unit has a yellow development unit, a magenta development unit, a cyan development unit, and a black development unit in the drum-like housing that rotates, and moves each development unit to the development position opposing the latent image bearing member drum 156 sequentially by rotation. The yellow development unit, the magenta development unit, the cyan development unit, and the black development unit preform development by attachment of the yellow toner, the magenta toner, the cyan toner, and the black toner. Latent electrostatic images of yellow, magenta, cyan and black are sequentially formed on the latent image bearing member drum 156. These images are sequentially developed by each development unit in the revolver development unit 250 to form a yellow toner image, a magenta toner image, a cyan toner image, and a black toner image.

An intermediate transfer unit is provided on the downstream side of the latent image bearing member drum 156 relative to the development position mentioned above. In this intermediate transfer unit, rotational driving of a belt driving roller 159c moves an intermediate transfer belt 158 suspended over a suspension roller 159a, an intermediate transfer bias roller 157 functioning as a transfer device, a secondary transfer backup roller 159b, and a belt driving roller 159c. The yellow toner image, the magenta toner image, the cyan toner image, and the black toner image developed on the latent image bearing member drum 156 enter an intermediate transfer nip where the latent image bearing member drum 156 meets with the intermediate transfer belt 158. Then, while affected by a bias from the intermediate transfer bias roller 157, these toner images are primarily transferred and overlapped on the intermediate transfer belt 158 to form a toner image obtained by overlapping of the four color toner images. The intermediate transfer system in which toner images are overlapped by using an intermediate transfer belt is relatively easy and accurate to determine the relative position of a photoreceptor and an intermediate transfer body. Therefore, the system is advantageous in terms of color misalignment (shift) and thus suitable to produce quality full color images.

The surface of the latent image bearing member drum 156 that has passed through the intermediate transfer nip according to the rotation is cleaned by a drum cleaning unit 155 to remove the un-transferred residual toner. Although this drum cleaning unit 155 cleans the surface of the latent image bearing member drum 156 by a cleaning brush such as a fur brush and a magfur brush, a cleaning roller or a blade that applies a cleaning bias brush can be also used singly or in combination. In addition, in FIG. 9, the drum cleaning unit 155 is also used as the lubricant application member (applicator).

The surface of the latent image bearing member drum 156 from which the un-transferred residual toner has been removed is discharged by a discharging lamp 154. A fluorescent lamp, a tungsten lamp, a halogen lamp, a mercury lamp, a sodium lamp, a luminescent diode (TED), a semiconductor diode (LED), electroluminescence (EL), etc. is used as the discharging lamp 154. A semi-conductor laser is used as the light source of the optical laser device described above. Various kinds of optical filters, for example, a sharp cut filter, a band-pass filter, a near infrared filter, a dichroic filter, a coherent filter and a color conversion filter, can be used in combination with these light sources to irradiate the latent image bearing member with light having only a desired wavelength.

A transfer unit formed of a transfer conveyor belt 162 and various kinds of rollers such as a transfer bias roller 163, a driving roller, etc. is arranged below the intermediate transfer unit in FIG. 9. A paper conveyor belt 164 and a fixing unit 165 are arranged on the left side of FIG. 9. The transfer belt that moves endlessly may move upward and downward in FIG. 9 by a moving device (not shown). When a single color toner (yellow toner image), or two or three color overlapped toner image on the intermediate transfer belt 158 passes through the opposition position of the secondary transfer bias roller 163, the transfer unit retreats at least to a position where the transfer unit is not in contact with the intermediate transfer belt 158. Then, the transfer unit moves to the contact position with the intermediate transfer belt 158 to form a secondary transfer nip before the front end of four color overlapped toner image advances into the opposition position of the secondary transfer bias roller 163.

A pair of registration rollers 161 that pinches a recording medium 160 which is fed from a paper feeder cassette (not shown) between the two rollers feeds the recording medium 160 to the secondary transfer nip at the timing of transferring the four color overlapped toner image on the intermediate transfer belt 158 to the recording medium 160. The four color overlapped toner image on the intermediate transfer belt 158 is secondarily transferred to the recording medium 160 at one time by the secondary transfer bias from a paper transfer bias roller 163 in the secondary transfer nip. By this secondary transfer, a full color toner image is formed on the recording medium 160.

The recording medium 160 on which the full color image is formed is sent to the paper conveyor belt 164 by the transfer conveyor belt 162.

The paper conveyor belt 164 sends the recording medium received from the transfer unit to the fixing unit 165.

The fixing unit 165 conveys the fed recording medium 160 to the fixing nip formed by a contact between a heating roller and a backup roller.

The full color image on the recording medium 160 is caused to fix on the recording medium 150 from heat by the heating roller and pressure in the fixing nip.

A bias may be applied to the transfer conveyor belt 162 and the paper conveyor belt 164 to attach the recording medium 160. In addition, there are provided a recording medium discharger to discharge the recording medium 160 and three belt dischargers to discharge each belt (intermediate transfer belt 158, the transfer conveyor belt 162, and the transfer belt 164). In addition, the intermediate transfer unit may have a belt cleaning unit having the same structure as that of the drum cleaning unit 155, thereby removing the un-transferred residual toner on the intermediate transfer belt 158.

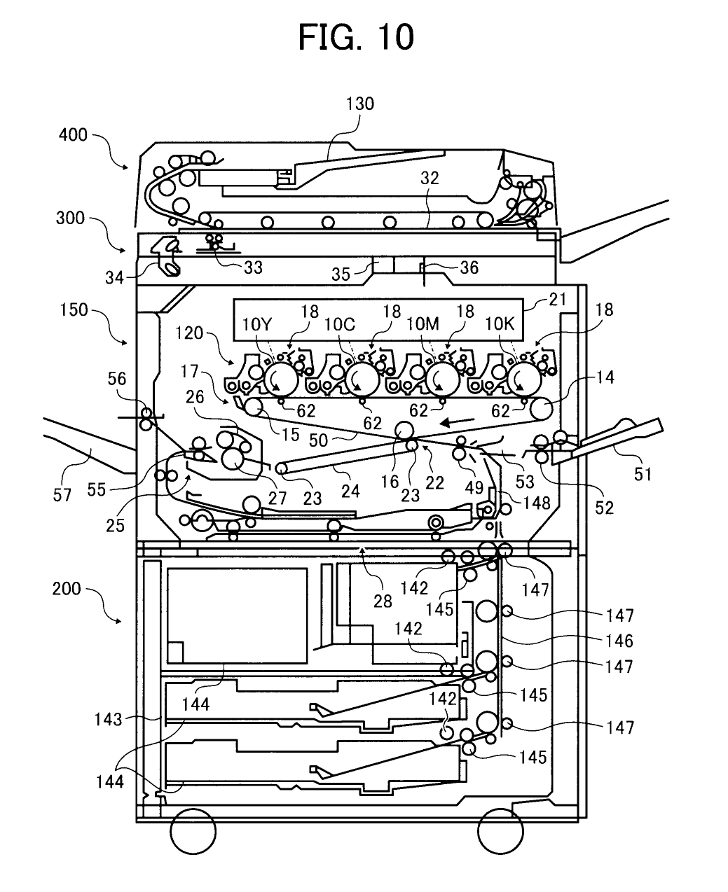

FIG. 10 is a diagram illustrating a color image forming apparatus employing a tandem system. The illustrated t image forming apparatus employing a tandem system includes a housing 150 of the image forming apparatus, a paper feeder table 200, a scanner 300, and an automatic document feeder (ADF) 400.

The housing 150 of the image forming apparatus has an intermediate transfer body 50 having an endless form at the center. The intermediate transfer 50 is suspended over a support rollers a(14), b(15), and c(16) and rotary clockwise in FIG. 10. An intermediate transfer cleaning device 17 to remove the un-transferred residual toner on the intermediate transfer body 50 is arranged around the support roller b(15). A tandem development device 120 having four development units 18 of yellow, cyan, magenta and black is arranged serially along the intermediate transfer body 50 suspended over the support rollers 14 and 15. An irradiation device 21 is arranged close to the tandem development device 120. A secondary transfer device 22 is arranged opposite to the tandem development device 120 with the intermediate transfer body 50 therebetween. In the secondary transfer device 22, a secondary transfer belt 24 having an endless form is suspended over a pair of rollers 23 and a recording medium transferred on the secondary transfer belt 24 is contactable with the intermediate transfer body 50. A fixing device 25 is arranged near the secondary transfer device 22.

In addition, in the tandem image forming apparatus of FIG. 10, a sheet reverse device 28 to form images on both sides of the recording medium by reversing the recording medium is arranged close to the secondary transfer device 22 and the fixing device 25.

Next, the formation of a full color image using the tandem development device 120 is described. First, set a document (original) on a document table 130 or open the automatic document feeder 400, set a document on a contact glass 32 on the scanner 300, and close the automatic document feeder 400.

By pressing a start button (not shown), after the document is moved to the contact glass 32 when the document is set on the automatic document feeder 400, or immediately when the document is set on the contact glass 32, the scanner 300 is driven to scan the document on the contact glass 32 with a first scanning unit 33 and a second scanning unit 34. Then, the document is irradiated with light from the first scanning unit 33, reflection light from the document is redirected at the first scanning unit 33 to the second scanning unit 34. The redirected light is reflected at the mirror of the second scanning unit 34 to a reading sensor 36 through an image focusing lens 35 to read the color document (color image) to obtain black, yellow, magenta and cyan image data information.

Each data information for black, yellow, magenta, and cyan is conveyed to each image formation unit 18 (image formation units for black, yellow, magenta and cyan) to form each color toner image by each image forming unit.

In FIG. 10, the numbers “26”, “27”, “51”, and “52” represent a fixing belt, a pressure roller, a manual tray, and a separation roller, respectively.

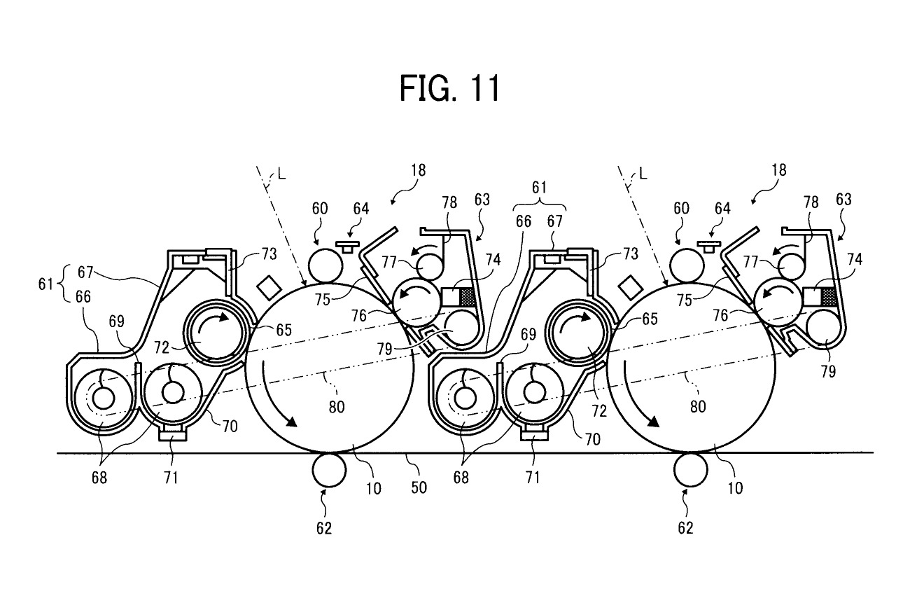

Each image formation unit 18 (image formation units for black, yellow, magenta and cyan) in the tandem development device 120 includes a latent image bearing member 10 (a latent image bearing member 10K for black, a latent image bearing member 10Y for yellow, a latent image bearing member 10M for magenta and a latent image bearing member 100 for cyan), a charger 60 that uniformly charges the latent image bearing member 10, an irradiation device that irradiates the latent image bearing member 10 according to each color image data information with beams of light L, a development unit 61 that forms a toner image with each color toner by developing each latent electrostatic image with each color toner (black toner, yellow toner, magenta toner, and cyan toner), a transfer charger (primary transfer charger) 62 that transfer the toner image to the intermediate transfer body 50, a cleaning device 63, and a discharger 64 as illustrated in FIGS. 10 and 11. Therefore, each single color image (black image, yellow image, magenta image, and cyan image) can be formed based on each color image informing.

The thus formed black color image, yellow color image, magenta color image, and cyan color image on the latent image bearing member 10K for black, the latent image bearing member 10Y for yellow, the latent image bearing member 10M for magenta and the latent image bearing member 100 for cyan, respectively, are primarily transferred to the intermediate transfer body 50 rotated by the support rollers a(14), b(15), and c(16) sequentially.

Then, the black color image, yellow color image, magenta color image, and cyan color image are overlapped on the intermediate transfer body 50 to form a synthesized color image (complex transfer image).

In the paper feeder table 200, one of the paper feeder rollers 142 is selectively rotated to feed a recording medium (sheet) from a paper bank 143 having multiple banks by separating the recording medium one by one to a paper feeding path 146 by a separation roller 145. Then, the recording medium is guided by transfer rollers 147 to a paper path 148 in the housing 150 of the image forming apparatus, and stopped at a registration roller 49. Alternatively, the recording medium (sheet) on a manual tray 51 is fed by rotating a feeder roller and separated by a separation roller 52 one by one to feed it to a manual sheet feeding path 53 and then the recording medium is stopped at the registration roller 49. The registration roller 49 is typically grounded but a bias can be applied to remove paper dust on the recording medium.

The registration roller 49 is rotated in synchronization with the synthesized color image (complex transfer image) on the intermediate transfer body 50 to feed the recording medium (sheet) between the intermediate transfer body 50 and the secondary transfer device 22. The synthesized color image (complex transfer image) is secondarily transferred to the recording medium (sheet) to obtain a color image thereon. The residual toner remaining on the intermediate transfer body 50 after image transfer is removed by a cleaning device 17 for the intermediate transfer body.

In FIG. 10, the numbers “26” and “27” represent a fixing belt and a pressure roller, respectively.

The recording medium to which the color image is transferred is sent to the fixing device 25 by the secondary transfer device 22 and the synthesized color image is fixed on the recording medium by heat and pressure at the fixing device 25. Thereafter, the recording medium is discharged outside by a discharging roller 56 by a switching claw 55 and stacked on a discharging tray 57. Alternatively, the recording medium is guided again to the transfer position by the switching claw 55 and the sheet reverse device 28 and then an image is formed on the reverse side. Thereafter, the recording medium is discharged by the discharging roller 56 and stacked on the discharging tray 57.

In FIG. 11, the numbers “65” represents a development sleeve, “66” represents a stirring portion, “67” represents a development unit, “68” represents a stirring screw, “69” represents a separation board, “70” represents a development case, “71” represents a toner concentration density, “72” represents a development roller, “73” represents a doctor blade, “74” represents a lubricant, “75” represents a cleaning blade, “76” represents a cleaning brush, “77” represents an electric field roller, “78” represents a scraper, “79” represents a collection screw, and “80” represents a toner recycling device.

In the tandem system, each color latent image is formed and developed in parallel so that the image formation speed is faster than the revolver system. Furthermore, the printer (image forming apparatus) as illustrated in FIG. 10 employs an intermediate transfer system so that when the latent image bearing member of the present invention is installed, full color quality images are stably produced at an extremely high speed without color shift for an extended period of time.

Process Cartridge

The process cartridge of the present disclosure includes a latent image bearing member, a lubricant applicator to supply the lubricant of the present disclosure to the surface of the latent image bearing member, and optional devices such as a charger and a development device. These elements are integrally united. The process cartridge is detachably attachable to the image forming apparatus of the present disclosure.

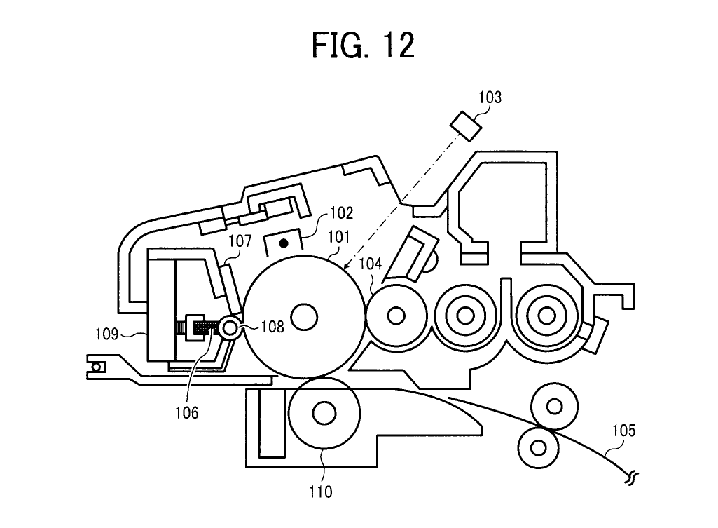

For example, the process cartridge illustrated in FIG. 12 includes a latent image bearing member (photoreceptor) 101, a charger 102, a development device 104, and a cleaning device 109 with other optional devices. The numbers “103”, “105”, and “110” represent an irradiation device (latent image forming device), a recording medium, and a transfer roller, respectively. In FIG. 12, a cleaning unit having the lubricant applicator is used so that the cleaning brush 108 of the cleaning device 109 is pressed against the lubricant 106 to supply the lubricant by the cleaning brush. The cleaning blade 107 also serves as a lubricant uniforming blade.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

To manufacture a latent image bearing member of Examples, a lubricant material containing a diamine compound is prepared in addition to a radical polymerizable compound having a charge transport structure (charge transport material having a hydroxy group).

Synthesis examples are the charge transport polyol shown as the illustrated compound D2-4, the charge transport polyol CTP-1 and CTP-2 as the charge transport material having a hydroxyl group and the triaryl amino group substituted acrylate compound shown as Illustrated compound No. 54 as the radical polymerizable compound having a charge transport structure. Moreover, a lubricant (lubricant material) having a diamine compound having the structure of the Illustrated compound A-17 is manufactured.

Lubricant using other diamine compounds (No. 6, No. 1, No. 16, No. 23, No. 25, No. 29, No. 35, and Illustrated compound 1-1) in Examples are manufactured in the same manner.

Synthesis Example of Polymerizble Compound Having Charge Transport Structure

Synthesis Example of Charge Transport Polyol (D2-4)

(a) Synthesis Example of Charge Transport Polyol (D2-3)

Derivatives required for the structure of the target compound are used to synthesize hydroxyl α-phenylstilbene derivative ({4-[2,2-bis-(4-hydroxyphenyl)-vinyl)-phenyl}-di-p-tolyl-amine) represented by the Illustrated compound D2-3 shown in Table 7 by the same reaction route.

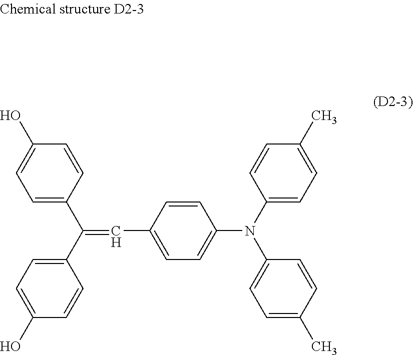

(b) Synthesis Example of Charge Transport Polyol (D2-4)

33.9 g of the amine specified above and 35 g of potassium carbonate are placed in a reaction container equipped with a stirrer and 120 ml of DMAc and 3 ml of nitrobenzene are added for dissolution. Then, 70.5 g of 2-bromoethanol is dropped to the reaction container to conduct reaction at 100° C. for 18 hours. Thereafter, the resultant is cooled down to the room temperature and then, impurities are removed followed by dilution by toluene. Then, the toluene solution is washed with water and salt solution followed by addition of magnesium sulphate for dehydration. Thereafter, the resultant is filtered and the toluene is diluted away to obtain 39.6 g of a coarse product of the target product. Then, the coarse product is refined by a column chromatography using a column filled with silica gel with a developing solvent of a solvent mixture of dichloromethane and ethyl acetate (20/1 to 3/1). Thereafter, the refined product is recrystallized twice using a solvent mixture of toluene and cyclohexane (2/1) to obtain the target product represented by the following chemical structure D2-4 shown in Table 7, i.e., (2-(4-{2-[4-di-p-toluoyl-amino)-phenyl-]-1-[4-(2-hydroxy-ethoxy)-phenyl]-vinyl}-phenoxy)-ethanol) (OH equivalent: 285.86) (Yield: 22.3 g, yellow crystal, melting point: 178.5° C. to 179.0° C.)

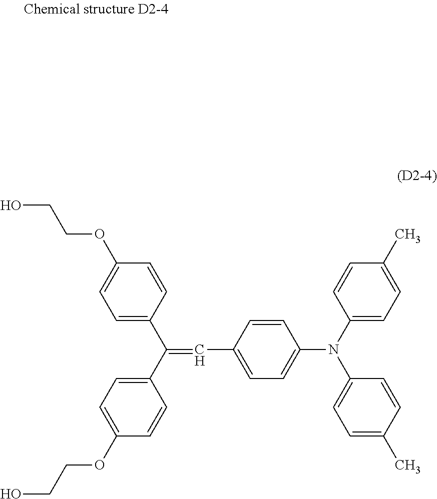

Such charge transport materials can form, for example, a cross-linked layer having a urethane bonding by cross-linking with an isocyanate compound or a cross-linked layer having a siloxane bonding by cross-linking with a silanol compound.

### Synthesis Example of Polymerizble Compound Having Charge Transport Structure

A preferred specific example of the polymerizable compounds having a charge transport structure for use in the present invention is a charge transport material having a hydroxyl group, which can be manufactured by, for example, a synthesis method described in Japanese patent No. 3540056.

Synthesis examples of the charge transport material having a hydroxyl group are as follows:

### Synthesis Example of Charge Transport Polyol (CTP-2)

Synthesis of [4-methoxy benzil diethylphosphonate]

4-methoxy benzil chloride and triethyl phosphite are reacted at 150° C. for 5 hours.

Thereafter, excess triethyl phosphite and a by-product of ethyl chloride are removed by distillation with a reduced pressure to obtain 4-methoxy benzyl diethylphosphonate.

Synthesis of [4-methoxy-4′-(di-p-tolyl amino)stilbene]

Equimolar of 4-methoxt benzil diethylphosphonate and 4-(di-p-tolylamino)benzaldehyde are dissolved in N,N-dimethyl formamide and tert-butoxy potassium is added little by little while stirring in water-cooling condition. After a 5 hour stirring at room temperature, water is added to obtain a coarse product of the target compound precipitates by acidation. Furthermore, the coarse product is fined by column chromatography using silica gel to obtain the target product of 4-methoxy-4′-(di-p-tolyl amino)stilbene.

Synthesis of [4-hydroxy-4′-(di-p-tolyl amino)stilbene]

The thus obtained 4-methoxy-4′-(di-p-tolyl amino)stilbene and its twice equivalent of sodium ethane thiolate are dissolved in N,N-dimethyl formamide followed by reaction at 130° C. for five hours. Thereafter, the solution is cooled down and poured to water followed by neutralization with hydrochloric acid to extract the target object with ethyl acetate. The liquid extraction is washed with water followed by drying and thereafter the solvent is removed to obtain a coarse product. Furthermore, the coarse product is fined by column chromatography using silica gel to obtain the target product of 4-mhydroxy-4′-(di-p-tolyl amino)stilbene (CTP-1).

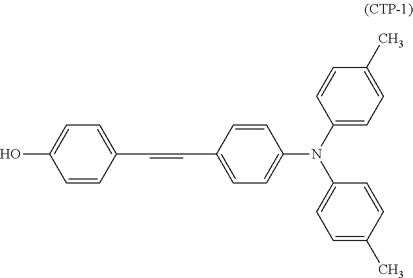

Synthesis of [1,2-dihydroxy-3-[4′-(di-p-tolyl amino)stilbene-4-yloxy]propane

11.75 g of [4-hydroxy-4′-(di-p-tolyl amino)stilbene], 4.35 g of glycidyl methacryalte, and 8 ml of toluene are placed in a reaction container equipped with a stirrer, a thermometer, a condenser, and a dripping funnel and the system is heated to 90° C. followed by addition of 0.16 g of triethylamine. The resultant is heated and stirred at 95° C. for eight hours. Thereafter, 16 ml of toluene and 20 ml of 10% sodium hydroxide are added and the resultant is heated and stirred at 95° C. for eight hours again.

After completion of the reaction, the resultant is diluted with ethyl acetate. Subsequent to acid-washing followed by water-washing, the solvent is distilled away to obtain 19 g of a coarse product. Furthermore, according to column chromatography (solvent: ethylacetate) using a column filled with silica gel, the target object of [1,2-dihydroxy-3-[4′-(di-p-tolyl amino)stilbene-4-yloxy]propane represented by the following chemical structure (CTP-2) (OH equivalent: 232.80) is obtained (yield: 9.85 g, yellow crystal, melting point: 127° C. to 128.7° C.).

IR measurement data are illustrated in FIG. 5 (IR data No. 1).

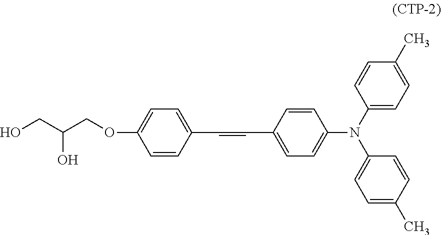

Synthesis Example of Radical Polymerizable Compound Having Charge Transport Structure

The radical polymerizable compound having a charge transport structure for use in the present invention can be synthesized by, for example, the method described in Japanese patent No. 3164426. An example thereof is as follows.

### (1) Synthesis of Hydroxy Group Substituted Triaryl Amine Compound Represented by Following Chemical Structure B)

240 ml of sulfolane are added to 113.85 g (0.3 mol) of methoxy group substituted triaryl amine compound represented by the following Chemical structure A and 138 g (0.92 mol) of sodium iodide. The mixture is heated to 60° C. in nitrogen air stream. 99 g (0.91 mol) of trimethylchlorosilane is dropped to the resultant solution in one hour. Thereafter, the solution is stirred for 4.5 hours at around 60° C. and the reaction is terminated. About one and a half litters of toluene is added to the reaction liquid. Subsequent to cooling down to room temperature, the liquid is repeatedly washed with water and sodium carbide aqueous solution. Thereafter, the solvent is removed from the toluene solution. The toluene solution is purified with column chromatography treatment {absorption medium (silica gel), developing solvent (toluene:ethyl acetate=20:1)}. Cyclohexane is added to the obtained light yellow oil to precipitate crystal. 88.1 g (yield ratio=80.4%) of the white crystal represented by the following Chemical structure B is thus obtained.

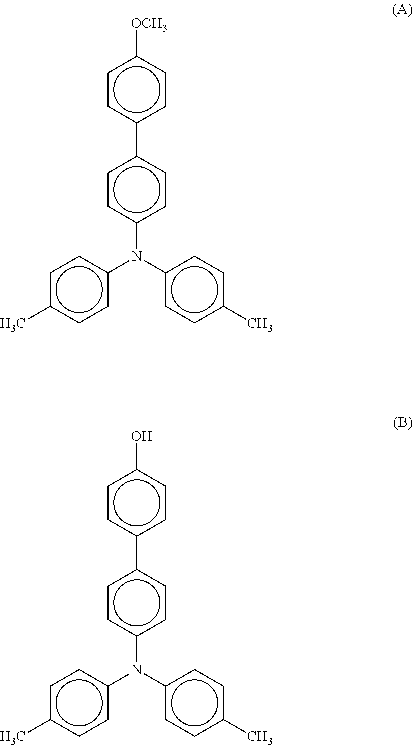

The element analysis of the obtained white crystal represented by the Chemical structure B is shown in Table 41 together with the calculation value.

TABLE 41
Element Analysis Value (%)

| | C | H | N |
|---|---|---|---|
| Measured value | 85.06 | 6.41 | 3.73 |
| Calculated value | 85.44 | 6.34 | 3.83 |

(2) Triaryl Amino Group Substituted Acrylate Compound (Illustrated Chemical Compound No. 54)

82.9 g (0.227 mol) of the hydroxyl group substituted triaryl amine compound (represented by Chemical structure B) obtained in (1) is dissolved in 400 ml of tetrahydrofuran and sodium hydroxide aqueous solution (NaOH: 12.4 g, water: 100 ml) is dropped thereto. The solution is cooled down to 5° C. and 25.2 g (0.272 mol) of chloride acrylate is dropped thereto in 40 minutes. Thereafter, the solution is stirred for three hours at 5° C., and the reaction is terminated. The resultant reaction liquid is poured to water and extracted by toluene. The extracted liquid is repeatedly washed with sodium acid carbonate and water. Thereafter, the solvent is removed from the toluene aqueous solution and purified by column chromatography treatment (absorption medium: silica gel, development solvent: toluene). n-hexane is added to the obtained colorless oil to precipitate crystal. Thus, 80.73 g (yield ratio=84.8%) (melting point: 117.5° C. to 119.0° C.) of white crystal of triaryl amino group substituted acrylate compound (Illustrated Chemical Compound No. 54 in Table 18) is obtained.

Element analysis of the thus obtained white crystal of Illustrated compound No. 54 is shown in Table 42 together with the calculation value.

TABLE 42
Element Analysis Value (%)

| | C | H | N |
|---|---|---|---|
| Measured value | 83.13 | 6.01 | 3.16 |
| Calculated value | 83.02 | 6.00 | 3.33 |

Manufacturing Example of Lubricant Material Containing Diamine Compound

10 parts of dimaine compound (white powder) having the structure of the Illustrated Compound A-17 in Table 2 is blended with 90 parts of zinc stearate and the mixtures is stirred and melted at 140° C.

The melted liquid is poured into the cavity of a preliminarily heated aluminum die having a width of 8 mm, a depth of 8 mm, and a length of 500 mm having a cavity. After pouring, a thermally-insulated lid is provided on the top of the die. Next, the die is placed in a room temperature environment and cooled down to 50° C. After two hours, the solidified molded product is taken out from the due. The molded product is processed to have a form having a width of 8 mm, a thickness of 11 mm, and a length of 380 mm to obtain a lubricant containing the illustrated compound A-17, which can be installed in an image forming apparatus (Ricoh Pro C900). The thus us obtained lubricant is attached to the metal support for the lubricant contained in Ricoh Pro C900 with a pressure-sensitive adhesive double coated tape in place of the lubricant attached to the metal support.

The heating temperature to melt the aliphatic acid metal is set to be 15° C. to 30° C. higher than the melting point thereof.

### Example 1

### Manufacturing of Latent Image Bearing Member 1

Undercoating Layer

Liquid application having the following recipe is applied to an aluminum substrate (outer diameter: 100 mm Φ) by a dip coating method to form an undercoating layer having a thickness of 3.5 μm after drying at 130° C. for 20 minutes.

Liquid Application for Undercoating Layer

| | |
|---|---|
| Alkyd resin | 6 parts |
| (Beckozole 1307-60-EL, manufactured by Dainippon Ink | |
| and Chemicals, Inc.) | |
| Melamine resin | 4 parts |
| (Super-beckamine G-821-60, manufactured by Dainippon | |
| Ink and Chemicals, Inc.) | |
| Titanium oxide (CR-EL, manufactured by Ishihara | 40 parts |
| Sangyo Kaisha, Ltd.) | |
| Methylethyl ketone | 50 parts |

Charge Generation Layer

Liquid application for charge generation layer having the following recipe is applied to the thus formed undercoating layer by dip coating followed by heating and drying at 90° C. for 20 minutes to form a charge generation layer having a thickness of 0.2 μm.

Liquid Application for Charge Generation Layer

| | |
|---|---|
| Υ type titanyl phthalocyanine | 6 parts |
| Butyral resin (BX-1, manufactured | 4 parts |
| by SEKISUI CHEMICAL CO., LTD.) | |
| 2-butanone | 200 parts |

Charge Transport Layer

Liquid application for charge transport layer containing the charge transport material represented by the following chemical structure is applied to this charge generation layer by dip coating followed by heating and drying at 135° C. for 20 minutes to form a charge transport layer having a thickness of 22 μm.

Liquid Application for Charge Transport Layer

| | |
|---|---|
| Bisphenol Z type polycarbonate | 10 parts |
| Charge transport material having a | 10 parts |
| small molecular weight represented by | |
| the following chemical formula VI | |
| Tetrahydrofuran | 80 parts |
| 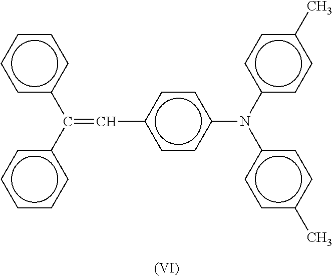 | chemical formula VI |

Cross-Linked Surface Layer

The liquid application 1 for cross-linked surface layer having the following recipe is spray-applied to the charge transfer layer and left in a nitrogen atmosphere for ten minutes followed by drying by finger touch. Thereafter, the resultant is placed in a UV irradiation booth in which air is replaced with nitrogen air such that the oxygen density is 2% or less and irradiated with light beams under the following conditions (metal halide lamp: 160 W/cm, Irradiation distance: 120 mm, Irradiation intensity: 700 mW/cm², Irradiation time: 60 seconds) followed by drying at 130° C. for 20 minutes to form a cross-linked surface layer having a layer thickness of 8 μm. Thus, the latent image bearing member of the present disclosure is manufactured.

Liquid Application 1 for Cross-Linked Surface Layer

| | |
|---|---|
| Radical polymerizable monomer having three or more functional | 10 parts |
| groups with no charge transport structure: Trimethylol propane | |
| triacrylate (KAYARAD TMPTA, manufactured by Nippon | |
| Kayaku Co., Ltd., molecular weight of 296, three functional | |
| groups, molecular weight/the number of functional groups = 99)] | |
| Radical polymerizable compound having one functional group | |
| with a charge transport structure | |
| (Illustrated Compound No. 54 shown in Table 18) | 10 parts |
| 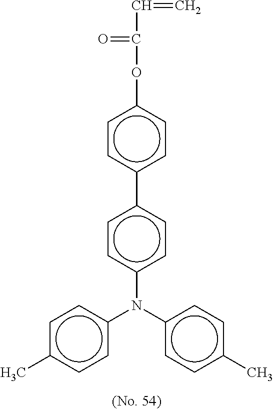 | |
| Photo polymerization initiator 1-hydroxy-cyclohexyl-phenyl-ketone | 1 part |
| (IRGACURE 184, manufactured by Chiba Specialty Chemicals)} | |
| Tetrahydrofuran solution of 1% UV curing type leveling agent | 5 parts |
| (mixture of a polyester modified polydimethyl siloxane having an | |
| acrylic group and a propoxy-modified-2-neopentyl glycol | |
| diacrylate: Product name: BYK-UV 3570, manufactured by | |
| BYK Chemie) | |
| Tetrahydrofuran | 100 parts |

The thus obtained latent image bearing member 1 is installed in the black station of a machine remodeled based on a full color printer (Ricoh Pro C900, manufactured by Ricoh) to make evaluations for image blur, abrasion resistance, and damage under the following conditions. The results are shown in Table 43.

Evaluation on Image Blur

A test chart of black color having an image area ratio of 5% is continuously printed on 5,000 sheets in the environment of 27° C. and 85% RH and thereafter, the image forming apparatus is powered off. After 24 hours, the image forming apparatus is powered on and a solid half tone image of black color of 1,200 dpi and 2 by 2 is output to evaluate image blur (thinned or missing image).

The evaluation criteria are as follows:

E (Excellent): No image blur occurs

G (Good): Slight image blur observed just below charger with no practical problem

F (Fair): Slight image blur observed just below and around charger with no intolerable problem

P (Poor): Image blur observed not only just below charger but also almost entirely in the circumference direction on the rear side of the image forming apparatus, which is intolerable.

Evaluation on Abrasion Resistance

A test chart of black color having an image area ratio of 15% is continuously printed on 100,000 sheets in the environment of 25° C. and 85% RH. The thickness of the photosensitive layer before and after this machine running test is measured by an eddy current film thickness meter (Fischer Scope MMS, manufactured by Fisher Instrument Company) to obtain the abrasion resistance amount of the photosensitive layer of a run length of 100,000 sheets. The thickness of the photosensitive layer is an average of the values measured at places with a gap therebetween of 10 mm from 50 mm to 330 mm from the top end of the image bearing member drum along arbitrary primary scanning direction (along with the axis of the drum).

The less the abrasion amount, the better the applicability of the lubricant. Thus, such lubricant is suitable to protect the surface of the latent image bearing member.

Evaluation on Damage

Whether there is a scar on the surface of the latent image bearing member along the sub-scanning direction (circumference direction of the drum) is observed by naked eyes after the evaluation on the abrasion resistance.

The more the scars, the worse the applicability of the lubricant. Thus, such lubricant is not suitable to protect the surface of the latent image bearing member.

### Examples 2 to 20

In Example 1, the lubricants (including lubricant materials) are manufactured in the same manner as in Example 1 except that the lubricant material, the diamine compound for the lubricant material (Illustrated compound No. 6), and the content ratio thereof in the lubricant are changed as shown in Table 43 and the image blur, the abrasion resistance, and the damage are evaluated.

The results are shown in Table 43 together with the diamine compounds by Illustrated compound No. and the content ratio thereof in the lubricant material.

### Comparative Example 1

The lubricant of Comparative Example 1 is manufactured in the same manner as in Example 1 except that the diamine compound is not contained and the image blur, the abrasion resistance, and the damage are evaluated.

The results are shown in Table 43.

### Comparative Example 2

The lubricant of Comparative Example 2 is manufactured in the same manner as in Example 1 except that the diamine compound is changed to an anti-oxidant 1 (Sanol LS-2626, manufactured by Dai-ichi Sancyo Co., Ltd.) shown in Table 44 and the image blur, the abrasion resistance, and the damage are evaluated. The results are shown in Table 43.

### Comparative Example 3

The lubricant of Comparative Example 3 is manufactured in the same manner as in Example 1 except that the diamine compound is changed to an anti-oxidant 2 (Sanol LS-744, manufactured by Dai-ichi Sancyo Co., Ltd.) shown in Table 44 and the image blur, the abrasion resistance, and the damage are evaluated. The results are shown in Table 43.

### Comparative Example 4

The lubricant of Comparative Example 4 is manufactured in the same manner as in Example 1 except that the diamine compound is changed to an anti-oxidant 3 (IRGANOX-MD1024, manufactured by Ciba Specialty Chemicals Inc.) shown in Table 44 and the image blur, the abrasion resistance, and the damage are evaluated. The results are shown in Table 43.

TABLE 43

| | Lubricant | Diamine | | | |
|---|---|---|---|---|---|
| | Material | compound | | | |
| Example/ | (Mixing | No. | | Abrasion | Anti- |
| Comparative | ratio for | (Content | Image | resistanve | damage |
| Example | mixtures) | ratio) | blur | (μm) | (scar) |
| Example 1 | Zinc | No. 6 | E | 2.6 | Good |
| | stearate | (10% by | | | |
| | | weight) | | | |
| Example 2 | Zinc | No. 1 | E | 2.7 | Slightly |
| | stearate | (10% by | | | scarred |
| | | weight) | | | |
| Example 3 | Zinc | No. 16 | E | 2.8 | Slightly |
| | stearate | (10% by | | | scarred |
| | | weight) | | | |
| Example 4 | Zinc | No. 17 | E | 2.6 | Good |
| | stearate | (10% by | | | |
| | | weight) | | | |
| Example 5 | Zinc | No. 23 | E | 2.9 | Slightly |
| | stearate | (10% by | | | scarred |
| | | weight) | | | |
| Example 6 | Zinc | No. 25 | E | 2.8 | Slightly |
| | stearate | (10% by | | | scarred |
| | | weight) | | | |
| Example 7 | Zinc | No. 29 | E | 2.9 | Slightly |
| | stearate | (10% by | | | scarred |
| | | weight) | | | |
| Example 8 | Zinc | No. 35 | E | 2.9 | Slightly |
| | stearate | (10% by | | | scarred |
| | | weight) | | | |
| Example 9 | Zinc | No. 6 | F | 2.5 | Good |
| | stearate | (10% by | | | |
| | | weight) | | | |
| Example 10 | Zinc | No. 6 | E | 2.7 | Slightly |
| | stearate | (10% by | | | scarred |
| | | weight) | | | |
| Example 11 | Zinc | No. 6 | G | 2.8 | Slightly |
| | stearate | (10% by | | | scarred |
| | | weight) | | | |
| Example 12 | Calcium | No. 6 | E | 2.7 | Slightly |
| | stearate | (10% by | | | scarred |
| | | weight) | | | |
| Example 13 | Aluminum | No. 6 | E | 2.6 | Good |
| | stearate | (10% by | | | |
| | | weight) | | | |
| Example 14 | Lithium | No. 6 | E | 2.3 | Slightly |
| | stearate | (10% by | | | scarred |
| | | weight) | | | |
| Example 15 | Magnesium | No. 6 | E | 2.6 | Slightly |
| | stearate | (10% by | | | scarred |
| | | weight) | | | |
| Example 16 | Zinc | No. 6 | E | 2.7 | Good |
| | palmitate | (10% by | | | |
| | | weight) | | | |
| Example 17 | Zinc | No. 6 | E | 2.6 | Slightly |
| | stearate/ | (10% by | | | scarred |
| | Iron | weight) | | | |
| | stearate | | | | |
| | (8/2) | | | | |
| Example 18 | Zinc | No. 6 | E | 2.5 | Good |
| | stearate/ | (10% by | | | |
| | Zinc | weight) | | | |
| | palmitate | | | | |
| | (5/5) | | | | |
| Example 19 | Zinc | No. 6 | E | 2.6 | Slightly |
| | stearate/ | (10% by | | | scarred |
| | Zinc | weight) | | | |
| | myristate | | | | |
| | (6/4) | | | | |
| Example 20 | Zinc | No. 6 | E | 2.6 | Good |
| | stearate/ | (10% by | | | |
| | Zinc | weight) | | | |
| | Oleate | | | | |
| | (9/1) | | | | |
| Comparative | Zinc | None | P | 2.5 | Good |
| Example 1 | stearate | | | | |
| Comparative | Zinc | Anti- | P | 2.7 | Slightly |
| Example 2 | stearate | oxidant 1 | | | scarred |
| Comparative | Zinc | Anti- | P | 2.3 | Slightly |
| Example 3 | stearate | oxidant 2 | | | scarred |
| Comparative | Zinc | Anti- | P | 2.7 | Slightly |
| Example 4 | stearate | oxidant 3 | | | scarred |

TABLE 44
(Anti-oxidants for use in Comparative Examples) Anti-oxidants for Use in Comparative Example

| | | |
|---|---|---|
| Comparative Example 2 | Antioxidant 1 | Sanol LS-2626, manufactured by Dai-ichi Sancyo Co., Ltd. 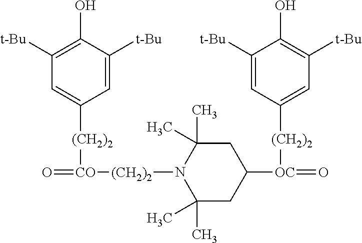 |
| Comparative Example 3 | Antioxidant 2 | (Sanol LS-744, manufactured by Dai-ichi Sancyo Co., Ltd. 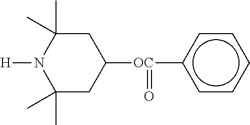 |
| Comparative Example 4 | Antioxidant 3 | IRGANOX-MD1024, manufactured by Ciba Specialty Chemicals Inc. 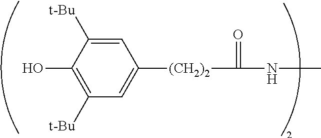 |
| Comparative Example 5 | Antioxidant 4 | Sumulizer BP101, manufactured by Sumitomo Chemical Co., Ltd.) 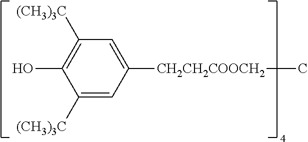 |

### Examples 21 to 40

The lubricants of Examples 21 to 40 are manufactured in the same manner as in Example 1 except that the lubricant material, the diamine compound (Illustrated compound No. 6), and the content ratio thereof in the lubricant are changed as shown in Table 45 and the image blur, the abrasion resistance, and the damage are evaluated. The results are shown in Table 45.

### Comparative Example 5

The lubricant material of Comparative Example 5 is manufactured in the same manner as in Example 1 except that the diamine compound is changed to anti-oxidant 4 shown in Table 44 and the image blur, the abrasion resistance, and the damage are evaluated. The results are shown in Table 45.

TABLE 45

| | Lubricant | Diamine | | | |
|---|---|---|---|---|---|
| | Material | compound | | | |
| Example/ | (Mixing | No. | | Abrasion | Anti- |
| Comparative | ratio for | (Content | Image | resistanve | damage |
| Example | mixtures) | ratio) | blur | (μm) | (scar) |
| Example 1 | Zinc | No. 1-1 | G | 2.3 | Good |
| | stearate | (10% by | | | |
| | | weight) | | | |
| Example 2 | Zinc | No. 1-2 | G | 2.5 | Good |
| | stearate | (10% by | | | |
| | | weight) | | | |
| Example 3 | Zinc | No. 1-5 | E | 2.8 | Slightly |
| | stearate | (10% by | | | scarred |
| | | weight) | | | |
| Example 4 | Zinc | No. 1-9 | G | 2.4 | Good |
| | stearate | (10% by | | | |
| | | weight) | | | |
| Example 5 | Zinc | No. 1-10 | G | 2.5 | Good |
| | stearate | (10% by | | | |
| | | weight) | | | |
| Example 6 | Zinc | No. 1-14 | G | 2.4 | Good |
| | stearate | (10% by | | | |
| | | weight) | | | |
| Example 7 | Zinc | No. 2-4 | G | 2.3 | Slightly |
| | stearate | (10% by | | | scarred |
| | | weight) | | | |
| Example 8 | Zinc | No. 2-9 | G | 2.7 | Good |
| | stearate | (10% by | | | |
| | | weight) | | | |
| Example 9 | Zinc | No. 1-1 | F | 2.2 | Good |
| | stearate | (2% by | | | |
| | | weight) | | | |
| Example 10 | Zinc | No. 1-1 | E | 2.6 | Slightly |
| | stearate | (25% by | | | scarred |
| | | weight) | | | |
| Example 11 | Zinc | No. 1-1 | E | 2.8 | Slightly |
| | stearate | (40% by | | | scarred |
| | | weight) | | | |
| Example 12 | Calcium | No. 1-1 | G | 2.4 | Slightly |
| | stearate | (10% by | | | scarred |
| | | weight) | | | |
| Example 13 | Aluminum | No. 1-1 | G | 2.6 | Good |
| | stearate | (10% by | | | |
| | | weight) | | | |
| Example 14 | Lithium | No. 1-1 | G | 2.6 | Good |
| | stearate | (10% by | | | |
| | | weight) | | | |
| Example 15 | Magnesium | No. 1-1 | G | 2.4 | Good |
| | stearate | (10% by | | | |
| | | weight) | | | |
| Example 16 | Zinc | No. 1-1 | G | 2.5 | Good |
| | palmitate | (10% by | | | |
| | | weight) | | | |
| Example 17 | Zinc | No. 1-1 | G | 2.4 | Slightly |
| | stearate/ | (10% by | | | scarred |
| | Iron | weight) | | | |
| | stearate | | | | |
| | (8/2) | | | | |
| Example 18 | Zinc | No. 1-1 | G | 2.5 | Good |
| | stearate/ | (10% by | | | |
| | Zinc | weight) | | | |
| | palmitate | | | | |
| | (5/5) | | | | |
| Example 19 | Zinc | No. 1-1 | G | 2.4 | Slightly |
| | stearate/ | (10% by | | | scarred |
| | Zinc | weight) | | | |
| | myristate | | | | |
| | (6/4) | | | | |
| Example 20 | Zinc | No. 1-1 | G | 2.4 | Good |
| | stearate/ | (10% by | | | |
| | Zinc | weight) | | | |
| | Oleate | | | | |
| | (9/1) | | | | |
| Comparative | Zinc | None | P | 2.5 | Good |
| Example 1 | stearate | | | | |
| Comparative | Zinc | Anti- | P | 2.7 | Slightly |
| Example 2 | stearate | oxidant 1 | | | scarred |
| Comparative | Zinc | Anti- | P | 2.8 | Slightly |
| Example 3 | stearate | oxidant 2 | | | scarred |
| Comparative | Zinc | Anti- | P | 2.7 | Slightly |
| Example 4 | stearate | oxidant 3 | | | scarred |
| Comparative | Zinc | Anti- | P | 2.8 | Slightly |
| Example 5 | stearate | oxidant 4 | | | scarred |

The image forming apparatuses in Examples 1 to 40 even left in a high temperature and a high humidity environment for 24 hours after they produced 5,000 images while applying the lubricants as described above are found to rarely produce images with image blur.

In addition, in comparison with Examples 1, 9 to 11, 21, and 29 to 31, prevention of image blur and the content of the diamine compound are found to have a close relation.

It is also found that the abrasion resistance and the anti-damage are maintained at a level with no practical problem and the side effect for the lubricity by containing the diamine compound is little.

By contrast, Comparative Example 1 in which no diamine compound is contained and Comparative Examples 2 to 5 that contain the anti-oxidants 1 to 4 instead of the diamine compound are found to produce deficit images with image blur as in the same evaluations. The considerable reason is that deterioration of the lubricant due to the corona products is not restrained or the anti-oxidants themselves deteriorate, which leads to production of images with image blur. In both cases, the effect of reducing production of images with image blur is not seen unlike the image forming apparatus of the present disclosure,

### Example 41

The latent image bearing member 2 is manufactured in the same manner as in Example 1 except that the radical polymerizable monomer having three or more functional groups without a charge transport structure contained in the liquid application for cross-linked surface layer is replaced with the following monomer and the image blur, the abrasion resistance, and the damage are evaluated using the same lubricant as in Example 1. The results are shown in Table 46 together with the lubricant material, the diamine compound, and the content ratio thereof in the lubricant material.

Radical polymerizable monomer having three or more functional groups with no charge transport structure: 10 parts (dipentaerythritol caprolactone modified hexaacrylate (KAYARAD DPCA-60, manufactured by Nippon Kayaku Co., Ltd., molecular weight of 1,263, 6 functional groups, molecular weight/the number of functional groups=211)]

### Example 42

The latent image bearing member 3 is manufactured in the same manner as in Example 1 except that the radical polymerizable monomer having three or more functional groups without a charge transport structure contained in the liquid application for cross-linked surface layer is replaced with the following monomer and the image blur, the abrasion resistance, and the damage are evaluated using the same lubricant as in Example 1. The results are shown in Table 46 together with the lubricant material, the diamine compound, and the content ratio thereof in the lubricant material.

Radical polymerizable monomer having three or more functional groups with no charge transport structure: 10 parts

(dipentaerythritol caprolactone modified hexaacrylate (KAYARAD DPCA-120, manufactured by Nippon Kayaku Co., Ltd., molecular weight of 1,947, 6 functional groups, molecular weight/the number of functional groups=325)]

### Example 43

The latent image bearing member 4 is manufactured in the same manner as in Example 1 except that the radical polymerizable compound having one functional group with a charge transport structure contained in the liquid application for cross-linked surface layer is replaced with 10 parts of the illustrated compound No. 1 in Table 11 and the image blur, the abrasion resistance, and the damage are evaluated using the same lubricant as in Example 1. The results are shown in Table 46 together with the lubricant material, the diamine compound, and the content ratio thereof in the lubricant material.

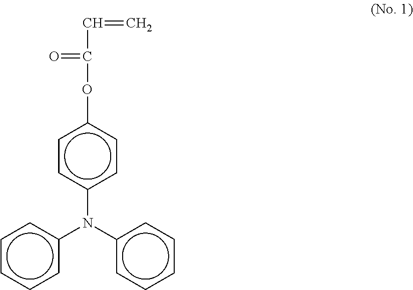

### Example 44

The latent image bearing member 5 is manufactured in the same manner as in Example 1 except that the radical polymerizable compound having one functional group with a charge transport structure contained in the liquid application for cross-linked surface layer is replaced with 10 parts of the illustrated compound No. 53 in Table 18 and the image blur, the abrasion resistance, and the damage are evaluated using the same lubricant as in Example 1. The results are shown in Table 46 together with the lubricant material, the diamine compound, and the content ratio thereof in the lubricant material.

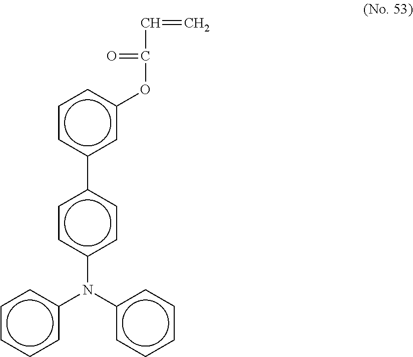

### Example 45

The latent image bearing member 6 is manufactured in the same manner as in Example 1 except that the radical polymerizable compound having one functional group with a charge transport structure contained in the liquid application for cross-linked surface layer is replaced with 10 parts of the illustrated compound No. 127 in Table 33 and the image blur, the abrasion resistance, and the damage are evaluated using the same lubricant as in Example 1. The results are shown in Table 46 together with the lubricant material, the diamine compound, and the content ratio thereof in the lubricant material.

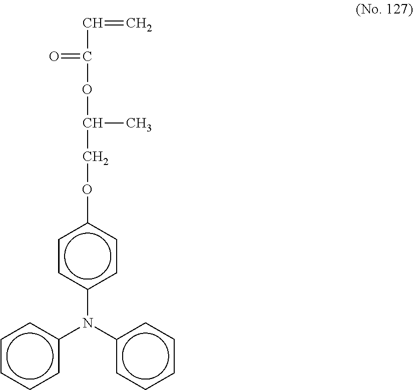

### Example 46

The latent image bearing member of Example 26 is manufactured in the same manner as in Example 1 to the charge transport layer.

Next, a liquid application 2 for cross-linked surface layer having the following recipe is spray-applied followed by natural drying for one minute and cured by irradiation with a metal halide lamp in the following conditions: Irradiation distance: 120 mm, Irradiation intensity: 500 mW/cm², Irradiation time: 45 seconds). Furthermore, subsequent to drying at 130° C. for 20 minutes, a cross-linked surface layer having a thickness of 4 μm is formed to manufacture the latent image bearing member 7 and the image blur, the abrasion resistance, and the damage are evaluated using the same lubricant as in Example 1. The results are shown in Table 46 together with the lubricant material, the diamine compound, and the content ratio thereof in the lubricant material.

Liquid Application 2 for Cross-Linked Surface Layer

| | | |
|---|---|---|
| Alumina (Primary particle diameter: 0.3 μm, | 3.0 | parts |
| manufactured by Sumitomo Chemical Co., Ltd.) | | |
| Insaturated polycarboxylic acid polymer (BYK-P104, | 0.06 | parts |
| manufactured by BYK Chemie) | | |
| Radical polymerizable monomer having three or more | 5 | parts |
| functional groups with no charge transport structure | | |
| Trimethylol propane triacrylate (SR-351, manufactured | | |
| by Sartomer Company Inc.) | | |
| Radical polymerizable monomer having three or more | 5 | parts |
| functional groups with no charge transport structure | | |
| (dipentaerythritol caprolactone modified hexaacrylate) | | |
| (KAYARAD DPCA-120, manufactured by Nippon Kayaku | | |
| Co., Ltd.) | | |
| Radical polymerizable compound having one functional | 10 | parts |
| group with a charge transport structure | | |
| (Illustrated Compound No. 54 in Table 18) | | |
| Photo polymerization initiator | 1 | part |
| (1-hydroxy-cyclohexyl-phenyl-ketone (IRGACURE 184, | | |
| manufactured by Chiba Specialty Chemicals, Ltd.)} | | |
| Tetrahydrofuran | 100 | parts |

### Example 47

The latent image bearing member 8 is manufactured in the same manner as in Example 26 except that the alumina particulates contained in the liquid application for cross-linked surface layer is replaced with silica particulates (KMPX100, manufactured by Shin-Etsu Chemical Co., Ltd.) and the image blur, the abrasion resistance, and the damage are evaluated using the same lubricant as in Example 26. The results are shown in Table 46 together with the lubricant material, the diamine compound, and the content ratio thereof in the lubricant material.

### Example 48

The latent image bearing member 9 is manufactured in the same manner as in Example 26 except that the alumina particulates contained in the liquid application for cross-linked surface layer is replaced with titanium oxide particulates (CR-97, manufactured by Ishihara Sangyo Kabushiki Kaisha) and the image blur, the abrasion resistance, and the damage are evaluated using the same lubricant as in Example 26. The results are shown in Table 46 together with the lubricant material, the diamine compound, and the content ratio thereof in the lubricant material.

### Example 49

The latent image bearing member of Example 49 is manufactured in the same manner as in Example 1 to the charge transport layer.

Then, the liquid application 3 for cross-linked surface layer having the following recipe is spray-applied to the charge transport layer. Subsequent to drying at 150° C. for 20 minutes, a cross-linked surface layer having a thickness of 5 μm is formed to manufacture the latent image bearing member 10 and the image blur, the abrasion resistance, and the damage are evaluated using the same lubricant as in Example 1. The results are shown in Table 46 together with the lubricant material, the diamine compound, and the content ratio thereof in the lubricant material.

Liquid Application 3 for Cross-Linked Surface Layer

| | | |
|---|---|---|
| Alumina (Primary particle diameter: 0.3 μm, | 3.0 | parts |
| manufactured by Sumitomo Chemical Co., Ltd.) | | |
| Insaturated polycarboxylic acid polymer (BYK-P104, | 0.06 | parts |
| manufactured by BYK Chemie) | | |
| Polycarbonate (Z Polika, manufactured by | 10 | parts |
| TEIJIN CHEMICALS LTD.) | | |
| Dibutyl hydroxy toluene (BHT) | 0.06 | parts |
| Anti-oxidant (Sanol LS-2626, Dai-ichi | 0.20 | parts |
| Sankyo Co., ltd.) | | |
| Tetrahydrofuran | 230 | parts |
| Cyclohexanone | 70 | parts |

### Example 50

The latent image bearing member of Example 50 is manufactured in the same manner as in Example 1 to the charge transport layer.

Then, the liquid application 4 for cross-linked surface layer having the following recipe is spray-applied to the charge transport layer followed by natural drying for one minute. Subsequent to drying at 150° C. for 30 minutes, a cross-linked surface layer having a thickness of 5 μm is formed to manufacture the latent image bearing member 11 and the image blur, the abrasion resistance, and the damage are evaluated using the same lubricant as in Example 1. The results are shown in Table 46 together with the lubricant material, the diamine compound, and the content ratio thereof in the lubricant material.

Liquid Application 4 for Cross-linked Surface Layer

| | |
|---|---|
| Polyol (copolymer of styrene - acrylic | 20 parts |
| formed of styrene, methylmethacrylate, | |
| and hydroxyethylmethacrylate) (polyol = | |
| LZR-170, solid portion 41% by | |
| weight, manufactured by Fujikura Kasei Co., Ltd.) | |
| Charge transport material having a hydroxyl group (D2-4) | 20 parts |
| Isocyanate (adduct of polyol with trilene diisocyanate) | 38 parts |
| (isocyanate = Coronate L, solid portion 75%, | |
| manufactured by Nippon Polyurethane Industry Co., Ltd.) | |
| Tetrahydrofuran solution of 1% silicone oil | 5 parts |
| (KF-50-100CS, manufactured by Shin-Etsu Chemical | |
| Co., Ltd.) | |
| Cyclohexanone | 50 parts |
| Tetrahydrofuran | 200 parts |

TABLE 45

| | Lubricant | Diamine | | | | |
|---|---|---|---|---|---|---|
| | Material | compound | Latent | | | |
| | (Mixing | No. | image | | Abrasion | Anti- |
| | ratio for | (Content | bearing | Image | resistanve | damage |
| Example | mixtures) | ratio) | member | blur | (μm) | (scar) |
| Example | Zinc | No. 6 | 2 | E | 2.8 | Slightly |
| 41 | stearate | (10% by | | | | scarred |
| | | weight) | | | | |
| Example | Zinc | No. 6 | 3 | E | 2.9 | Slightly |
| 42 | stearate | (10% by | | | | scarred |
| | | weight) | | | | |
| Example | Zinc | No. 6 | 4 | E | 2.6 | Slightly |
| 43 | stearate | (10% by | | | | scarred |
| | | weight) | | | | |
| Example | Zinc | No. 6 | 5 | E | 2.7 | Slightly |
| 44 | stearate | (10% by | | | | scarred |
| | | weight) | | | | |
| Example | Zinc | No. 6 | 6 | E | 2.6 | Slightly |
| 45 | stearate | (10% by | | | | scarred |
| | | weight) | | | | |
| Example | Zinc | No. 6 | 7 | G | 1.1 | Good |
| 46 | stearate | (10% by | | | | |
| | | weight) | | | | |
| Example | Zinc | No. 6 | 8 | G | 1.0 | Good |
| 47 | stearate | (10% by | | | | |
| | | weight) | | | | |
| Example | Zinc | No. 6 | 9 | G | 1.1 | Good |
| 48 | stearate | (10% by | | | | |
| | | weight) | | | | |
| Example | Zinc | No. 6 | 10 | G | 1.8 | Good |
| 49 | stearate | (10% by | | | | |
| | | weight) | | | | |
| Example | Zinc | No. 6 | 11 | E | 2.8 | Slightly |
| 50 | stearate | (10% by | | | | scarred |
| | | weight) | | | | |

### Examples 51 to 60

The lubricants of Examples 51 to 60 are manufactured in the same manner as in Example 21 except that the latent image bearing member, the diamine compound (Illustrated compound No. 6) and the content ratio thereof in the lubricant are changed as shown in Table 47 and the image blur, the abrasion resistance, and the damage are evaluated in the same manner as in Example 1. The results are shown in Table 47.

TABLE 47

| | Lubricant | Diamine | | | | |
|---|---|---|---|---|---|---|
| | Material | compound | Latent | | | |
| | (Mixing | No. | image | | Abrasion | Anti- |
| | ratio for | (Content | bearing | Image | resistanve | damage |
| Example | mixtures) | ratio) | member | blur | (μm) | (scar) |
| Example | Zinc | No. 1-1 | 2 | E | 2.6 | Slightly |
| 51 | stearate | (10% by | | | | scarred |
| | | weight) | | | | |
| Example | Zinc | No. 1-1 | 3 | E | 2.6 | Slightly |
| 52 | stearate | (10% by | | | | scarred |
| | | weight) | | | | |
| Example | Zinc | No. 1-1 | 4 | E | 2.4 | Slightly |
| 53 | stearate | (10% by | | | | scarred |
| | | weight) | | | | |
| Example | Zinc | No. 1-1 | 5 | E | 2.4 | Slightly |
| 54 | stearate | (10% by | | | | scarred |
| | | weight) | | | | |
| Example | Zinc | No. 1-1 | 6 | E | 2.3 | Slightly |
| 55 | stearate | (10% by | | | | scarred |
| | | weight) | | | | |
| Example | Zinc | No. 1-1 | 7 | G | 1.0 | Good |
| 56 | stearate | (10% by | | | | |
| | | weight) | | | | |
| Example | Zinc | No. 1-1 | 8 | G | 1.0 | Good |
| 57 | stearate | (10% by | | | | |
| | | weight) | | | | |
| Example | Zinc | No. 1-1 | 9 | G | 1.1 | Good |
| 58 | stearate | (10% by | | | | |
| | | weight) | | | | |
| Example | Zinc | No. 1-1 | 10 | G | 1.5 | Good |
| 59 | stearate | (10% by | | | | |
| | | weight) | | | | |
| Example | Zinc | No. 1-1 | 11 | E | 2.4 | Slightly |
| 60 | stearate | (10% by | | | | scarred |
| | | weight) | | | | |

The image forming apparatuses in Examples 41 to 45 and 50 are found to rarely produce images with image blur even when the material forming the surface layer of the latent image bearing members. In addition, the side effect of image blur is restrained as much as possible and excellent abrasion resistance and anti-damage property are demonstrated even when particulates are contained in the surface layer to improve the applicability of the lubricant and the abrasion resistance as in Examples 46 to 49. The image forming apparatuses in Examples 51 to 55 are found to rarely produce images with image blur even when the materials forming the surface layer of the latent image bearing members are changed. In addition, the side effect of image blur is restrained as much as possible and excellent abrasion resistance and anti-damage property are demonstrated even when particulates are contained in the surface layer to improve the applicability of the lubricant and the abrasion resistance as in Examples 56 to 59.

As described above, the image forming apparatus of the present disclosure is structured to have a latent image bearing member to bear a latent electrostatic image, a charger to charge the surface of the latent image bearing member, a development device to develop the latent electrostatic image with toner to obtain a toner image, a transfer device to transfer the toner image formed on the latent image bearing member to a transfer body, and a lubricant applicator to apply the lubricant to the surface of the latent image bearing member. The lubricant contains a lubricant material and at least one of diamine compounds represented by the chemical structures 1, 2, and 3. By applying the lubricant to the surface of the latent image bearing member, the image forming apparatus stably produces quality images without image blur for an extended period of time even in a high temperature and a high humidity environment while extremely improving the durability of the latent image bearing member.

That is, since the image forming apparatus stably produces quality images without image blur for an extended period of time even in a high temperature and a high humidity environment while extremely improving the durability of the latent image bearing member, it can be suitably used as an image forming apparatus employing electrophotography such as a photocopier, a printer, a facsimile machine, or a multi-functional machine equipped with a latent image bearing member.

This document claims priority and contains subject matter related to Japanese Patent Applications Nos. 2010-115529 and 2010-167533, filed on May 19, 2010 and Jul. 26, 2010, respectively, the entire contents of which are hereby incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A lubricant comprising:
a lubricant material; and
at least one of diamine compounds represented by chemical structure 1, 2, and 3,
wherein the lubricant is used in an image forming apparatus comprising a latent image bearing member to bear a latent electrostatic image, a charger to charge the surface of the latent image bearing member, a development device to develop the latent electrostatic image with toner to form a toner image, a transfer device to transfer the toner image formed on the latent image bearing member to a transfer body, and a lubricant applicator to apply the lubricant to the surface of the latent image bearing member, 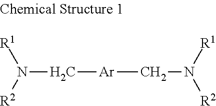
where R¹ and R² independently represent an alkyl group optionally having a substitution group and an aromatic hydrocarbon group optionally having a substitution group, one of R¹ and R² is an aromatic hydrocarbon group optionally having a substitution group, R¹ and R² optionally share bond connectivity to form a heterocyclic ring containing a nitrogen atom, and Ar represents an aromatic hydrocarbon group optionally having a substitution group, 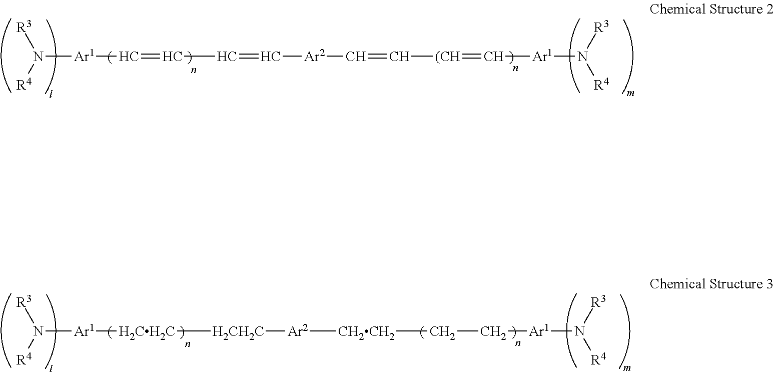
where R³ and R⁴ independently represent an alkyl group having one to four carbon atoms optionally substituted by an aromatic hydrocarbon group, R³ and R⁴ optionally share bond connectivity to form a heterocyclic ring containing a nitrogen atom, Ar¹ and Ar² independently represent a substituted or a non-substituted aromatic ring group, l and m each, independently, represent an integer of from 0 to 3 except that both l and m are zero at the same time, and n represents 1 or 2.

2. The lubricant according to claim 1, wherein the lubricant material comprises an aliphatic acid metal salt.

3. The lubricant according to claim 2, wherein the aliphatic acid metal salt is formed of at least one aliphatic acid selected from the group consisting of stearic acid, palmitic acid, myristic acid, and oleic acid and at least one metal selected from the group consisting of zinc, aluminum, calcium, magnesium, iron, and lithium.

4. The lubricant according to claim 1, wherein a content ratio of the diamine compound is from 0.1% by weight to 40% by weight.

5. An image forming apparatus comprising:
a latent image bearing member to bear a latent electrostatic image;
a charger to charge the surface of the latent image bearing member;
a development device to develop the latent electrostatic image with toner to form a toner image;
a transfer device to transfer the toner image formed on the latent image bearing member to a transfer body; and
a lubricant applicator to accommodate and apply the lubricant of claim 1 to the surface of the latent image bearing member.

6. The image forming apparatus according to claim 5, wherein the lubricant is in a solid state.

7. The image forming apparatus according to claim 5, wherein the latent image bearing member comprises an electroconductive substrate, a photosensitive layer overlying the electroconductive substrate, and a cross-linked surface layer formed by curing a polymerizable compound having a charge transport structure.

8. The image forming apparatus according to claim 7, wherein the cross-linked surface layer is formed by curing a radical polymerizable compound having one functional group with a charge transport structure and a radical polymerizable monomer having three functional groups without a charge transport structure.

9. The image forming apparatus according to claim 8, wherein a ratio (molecular weight/number of functional groups) of a molecular weight to a number of functional groups of the radical polymerizable monomer having three functional groups without a charge transport structure is 250 or less.

10. The image forming apparatus according to claim 8, wherein the radical polymerizable compound having one functional group with a charge transport structure comprises a triaryl amine structure.

11. The image forming apparatus according to claim 10, wherein the radical polymerizable compound having one functional group with a charge transport structure comprises a compound represented by a chemical structure I or II, 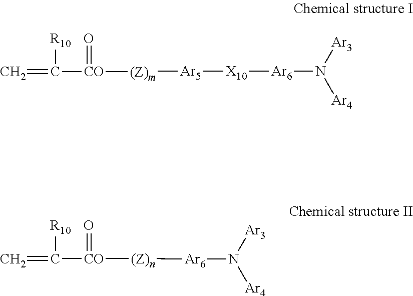
where R¹⁰ represents a hydrogen atom, a halogen atom, an alkyl group optionally having a substitution group, an aralkyl group optionally having a substitution group, an aryl group optionally having a substitution group, a cyano group, a nitro group, an alkoxy group, and —COOR¹¹ group, where R¹¹ represents a hydrogen atom, an alkyl group optionally having a substitution group, an aralkyl group optionally having a substitution group, an aryl group optionally having a substitution group, and —CONR¹²R¹³, where R¹² and R¹³ independently represent a hydrogen atom, a halogen atom, an alkyl group optionally having a substitution group, an aralkyl group optionally having a substitution group, and an aryl group optionally having a substitution group, Ar⁵ and Ar⁶ independently represent an arylene group optionally having a substitution group, Ar³ and Ar⁴ independently represent an aryl group optionally having a substitution group, X¹⁰ represents a single bond, an alkylene group optionally having a substitution group, a cycloalkylene group optionally having a substitution group, an alkylene ether group optionally having a substitution group, an oxygen atom, a sulfur atom, and a vinylene group, Z represents an alkylene group optionally having a substitution group, an alkylene ether group optionally having a substitution group, and an alkyleneoxy carbonyl group, and m and n independently represent an integer of from 0 to 3.

12. The image forming apparatus according to claim 10, wherein the radical polymerizable compound having one functional group with a charge transport structure comprises a compound represented by a chemical structure III, 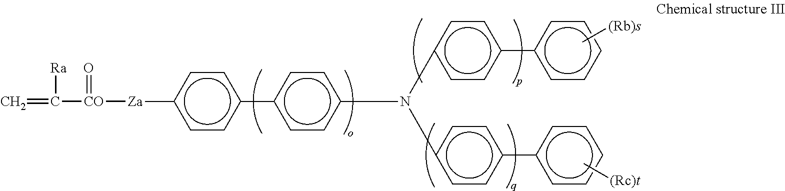
wherein o, p, q, each, independently, represent 0 or 1, Ra represents a hydrogen atom or a methyl group, and Rb and Rc, each, independently, represent an alkyl group (excluding hydrogen atom) having one to six carbon atoms, s and t independently represent 0 or an integer of from 1 to 3, and Za represents a single bond, a methylene group, an ethylene group, or a divalent group represented by the following Chemical structures a, b, and c.

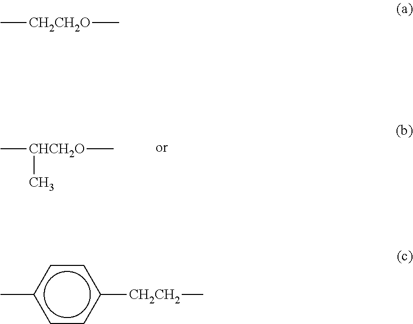

13. The image forming apparatus according to claim 7, wherein the cross-linked surface layer comprises filler particulates.

14. The image forming apparatus according to claim 13, wherein the filler particulates are inorganic particulates.

15. The image forming apparatus according to claim 5, wherein the charger is a corona charger.

16. The image forming apparatus according to claim 5 that forms color images by sequentially overlapping multiple color toner images.

17. The image forming apparatus according to claim 5, wherein the transfer body comprises an intermediate transfer body to which multiple color toner images are primarily and sequentially transferred from the latent image bearing member to form an overlapped color toner image and from which the overlapped color toner image is secondarily transferred to a recording medium at once.

18. A process cartridge comprising:
a latent image bearing member to bear a latent electrostatic image;
at least one of a charger to charge the surface of the latent image bearing member and a development device to develop the latent electrostatic image with toner to form a toner image; and
a lubricant applicator to accommodate and apply the lubricant of claim 1 to the surface of the latent image bearing member.
